(19) United States
(12) Patent Application Publication
(10) Pub. No.: US 2025/0126237 A1
(43) Pub. Date: Apr. 17, 2025

(54) ELECTRONIC DEVICE AND CONTROL METHOD THEREOF

(71) Applicant: SAMSUNG ELECTRONICS CO.,LTD., Suwon-si (KR)

(72) Inventors: Kisung LEE, Suwon-si (KR); Bonseuk GOO, Suwon-si (KR); Youngtae KIM, Suwon-si (KR); Byungseok SOH, Suwon-si (KR); Sangki YOON, Suwon-si (KR); Youngchol LEE, Suwon-si (KR); Weonhee LEE, Suwon-si (KR)

(73) Assignee: SAMSUNG ELECTRONICS CO., LTD., Suwon-si (KR)

(21) Appl. No.: 18/999,455

(22) Filed: Dec. 23, 2024

Related U.S. Application Data
(63) Continuation of application No. PCT/KR2023/005606, filed on Apr. 25, 2023.

(30) Foreign Application Priority Data
Jun. 23, 2022 (KR) 10-2022-0076972
Sep. 7, 2022 (KR) 10-2022-0113712

(51) Int. Cl. H04N 9/31

(52) U.S. Cl. CPC H04N 9/3194; H04N 9/317; H04N 9/3185

(57) ABSTRACT

Provided is an electronic device including a projector, a communication interface configured to communicate with an external device, and at least one processor configured to, based on receiving a user input for projecting a first content from the electronic device and projecting a second content from the external device, obtain a difference value between a first luminance value corresponding to the first content and a second luminance value corresponding to the second content, obtain a projection interval of the first content and the second content based on the difference value, control the projector to project the first content based on the projection interval, and transmit the second content and a control signal for projecting the second content to the external device through the communication interface.

### CROSS-REFERENCE TO RELATED APPLICATIONS

This application is a bypass continuation of International Application No. PCT/KR2023/005606, filed on Apr. 25, 2023, which is based on and claims priority to Korean Patent Application No. 10-2022-0076972, filed on Jun. 23, 2022 and Korean Patent Application No. 10-2022-0113712, filed on Sep. 7, 2022, in the Korean Intellectual Property Office, the disclosures of which are incorporated by reference herein in their entireties.

### BACKGROUND

### 1. Field

Embodiments of the present disclosure relate to an electronic device and a control method thereof, and more particularly, to an electronic device that performs a multi-view function of projecting a plurality of contents, and a control method thereof.

### 2. Description of Related Art

A multi-view function of projecting a plurality of contents simultaneously may be provided to a user. The multi-view function may be implemented in a form wherein one electronic device (e.g., a projector) projects a plurality of contents, or in a form wherein a plurality of devices respectively project a content.

A user may simultaneously view a plurality of contents projected on a projection surface. In each of the plurality of contents, the brightness of the projected content may appear different according to pixel values included in projection image data or output performance of the electronic device.

When brightness of different contents is different to a substantial degree in using a multi-view function, there may be a problem that visibility of a content itself rather deteriorates, or it is impossible to concentrate on one content.

Also, when contents are respectively output from different electronic devices, there may be a problem that lights overlap in some projection areas.

### SUMMARY

One or more embodiments provide an electronic device and a control method thereof, and more particularly, to an electronic device that performs a multi-view function of projecting a plurality of contents, and a control method thereof.

According to an aspect of one or more embodiments, there is provided an electronic device including a projector, a communication interface configured to communicate with an external device, and at least one processor configured to, based on receiving a user input for projecting a first content from the electronic device and projecting a second content from the external device, obtain a difference value between a first luminance value corresponding to the first content and a second luminance value corresponding to the second content, obtain a projection interval of the first content and the second content based on the difference value, control the projector to project the first content based on the projection interval, and transmit the second content and a control signal for projecting the second content to the external device through the communication interface.

The at least one processor may be further configured to obtain information on a first position based on the first content being projected based on the projection interval, and control the projector to project the first content based on the first position information, and wherein the projection interval may increase as the difference value increases.

The at least one processor may be further configured to obtain first metadata corresponding to the first content and second metadata corresponding to the second content, obtain the first luminance value based on the first metadata, and obtain the second luminance value based on the second metadata.

The at least one processor may be further configured to obtain the first luminance value based on an average pixel value of a plurality of frames included in the first content based on the first luminance value not being obtained based on the first metadata, and obtain the second luminance value based on an average pixel value of a plurality of frames included in the second content based on the second luminance value not being obtained based on the second metadata.

The electronic device may further include a camera, wherein the at least one processor may be further configured to obtain an image including the first content projected on a projection surface through the camera, and obtain the first luminance value based on the obtained image, and based on the second luminance value not being obtained based on the second metadata, obtain an image including the second content projected on a projection surface through the camera, and obtain the second luminance value based on the obtained image.

The at least one processor may be further configured to control the projector to project the first content on a first area corresponding to the first position information by controlling a projection angle based on the projection interval.

The electronic device may further include a moving element, wherein the at least one processor may be further configured to, based on identifying that the first content is not projected on the first area corresponding to the first position information by controlling the projection angle, control the moving element to project the first content on an area corresponding to the first position information.

The at least one processor may be further configured to, based on identifying that the first content is not projected on the first area corresponding to the first position information by controlling the projection angle, change the size of the first content, and control the projector to project the changed first content on the first area corresponding to the first position information.

The at least one processor may be further configured to, based on the difference value being greater than or equal to a threshold luminance value, change at least one of the first luminance value or the second luminance value, based on the first luminance value being changed, control the projector to project the first content based on the changed first luminance value, and based on the second luminance value being changed, transmit a control signal for projecting the second content based on the changed second luminance value to the external device through the communication interface.

The at least one processor may be further configured to obtain first power information corresponding to a battery included in the electronic device, obtain second power information corresponding to a battery included in the external device and information on a second position based on second content being projected through the communication interface, based on the first power information being smaller than a threshold power value, and the second power information being greater than or equal to the threshold power value, compare the first luminance value and the second luminance value, based on the first luminance value being greater than the second luminance value, project a guide user interface (UI) to project the first content from the external device and to project the second content from the electronic device, based on receiving a user input through the guide UI, control the projector to project the second content based on the second position information, and transmit a control signal for projecting the first content based on the first position information to the external device through the communication interface.

According to another aspect of one or more embodiments, there is provided a control method of an electronic device configured to communicate with an external device, the method including, based on receiving a user input for projecting a first content from the electronic device and projecting a second content from the external device, obtaining a difference value between a first luminance value corresponding to the first content and a second luminance value corresponding to the second content, based on the difference value, obtaining a projection interval of the first content and the second content, projecting the first content based on the projection interval, and transmitting the second content and a control signal for projecting the second content to the external device.

The control method may further include obtaining information on a first position based on the first content being projected and information on a second position based on the second content being projected based on the projection interval, wherein the projecting the first content includes projecting the first content based on the first position information, and wherein the projection interval increases as the difference value increases.

The control method may further include obtaining first metadata corresponding to the first content and second metadata corresponding to the second content, obtaining the first luminance value based on the first metadata, and obtaining the second luminance value based on the second metadata.

The obtaining the first luminance value may include, based on the first luminance value not being obtained based on the first metadata, obtaining the first luminance value based on an average pixel value of a plurality of frames included in the first content, and wherein the obtaining the second luminance value may include, based on the second luminance value not being obtained based on the second metadata, obtaining the second luminance value based on an average pixel value of a plurality of frames included in the second content.

The obtaining the first luminance value may include, based on the first luminance value not being obtained based on the first metadata, obtaining an image including the first content projected on a projection surface, and obtaining the first luminance value based on the obtained image, and wherein the obtaining the second luminance value may include, based on the second luminance value not being obtained based on the second metadata, obtaining an image including the second content projected on a projection surface, and obtaining the second luminance value based on the obtained image.

The control method may further include projecting the first content on a first area corresponding to the first position information by controlling a projection angle based on the projection interval.

The control method may further include, based on identifying that the first content is not projected on the first area corresponding to the first position information by controlling the projection angle, controlling a moving element to project the first content on an area corresponding to the first position information.

The control method may further include, based on identifying that the first content is not projected on the first area corresponding to the first position information by controlling the projection angle, changing the size of the first content, and projecting the changed first content on the first area corresponding to the first position information.

The control method may further include, based on the difference value being greater than or equal to a threshold luminance value, changing at least one of the first luminance value or the second luminance value, based on the first luminance value being changed, projecting the first content based on the changed first luminance value, and based on the second luminance value being changed, transmitting a control signal for projecting the second content based on the changed second luminance value to the external device through the communication interface.

The control method may further include obtaining first power information corresponding to a battery included in the electronic device, obtaining second power information corresponding to a battery included in the external device and information on a second position based on second content being projected through the communication interface, based on the first power information being smaller than a threshold power value, and the second power information being greater than or equal to the threshold power value, comparing the first luminance value and the second luminance value, based on the first luminance value being greater than the second luminance value, projecting a guide user interface (UI) to project the first content from the external device and to project the second content from the electronic device, based on receiving a user input through the guide UI, projecting the second content based on the second position information, and transmitting a control signal for projecting the first content based on the first position information to the external device through the communication interface.

### BRIEF DESCRIPTION OF DRAWINGS

The above or other aspects, configurations, and/or advantages of an embodiment of the disclosure will be more apparent from the following description taken in conjunction with the accompanying drawings in which:

FIG. 1 is a perspective view illustrating an exterior of an electronic device according to one or more embodiments;

FIG. 2 is a block diagram illustrating a configuration of an electronic device according to one or more embodiments;

FIG. 3 is a block diagram illustrating in detail a configuration of the electronic device in FIG. 2;

FIG. 4 is a perspective view illustrating an exterior of an electronic device according to one or more embodiments;

FIG. 5 is a perspective view illustrating an exterior of an electronic device according to one or more embodiments;

FIG. 6 is a perspective view illustrating an exterior of an electronic device according to one or more embodiments;

FIG. 7 is a perspective view illustrating an exterior of an electronic device according to one or more embodiments;

FIG. 8 is a perspective view illustrating an exterior of an electronic device according to one or more embodiments;

FIG. 9 is a perspective view illustrating an exterior of an electronic device according to one or more embodiments;

FIG. 10 is a diagram for illustrating rotation information of an electronic device;

FIG. 11 is a diagram for illustrating rotation information of a projection surface;

FIG. 12 is a diagram for illustrating an operation of controlling a horizontal projection interval between a first content and a second content;

FIG. 13 is a diagram for illustrating an operation of controlling a vertical projection interval between a first content and a second content;

FIG. 14 is a flow chart for illustrating an operation of providing a multi-view function based on a luminance difference value according to one or more embodiments;

FIG. 15 is a flow chart for illustrating an operation of providing a multi-view function based on a luminance difference value according to one or more embodiments;

FIG. 16 is a flow chart for illustrating an operation of providing a multi-view function by using an electronic device and an external device;

FIG. 17 is a diagram for illustrating an operation of providing a multi-view function by using an electronic device, an external device, and a server according to one or more embodiments;

FIG. 18 is a flow chart for illustrating an operation of generating a control command in a server for providing a multi-view function;

FIG. 19 is a flow chart for illustrating an operation of obtaining position information by using a projection interval;

FIG. 20 is a diagram for illustrating an operation of obtaining a luminance value based on metadata;

FIG. 21 is a diagram for illustrating an operation of obtaining a luminance value based on metadata;

FIG. 22 is a diagram for illustrating an operation of obtaining a luminance value based on an average pixel value of frames;

FIG. 23 is a flow chart for illustrating an operation of obtaining a luminance value based on an average pixel value of frames;

FIG. 24 is a diagram for illustrating an operation of obtaining a luminance value based on a captured image;

FIG. 25 is a flow chart for illustrating an operation of obtaining a luminance value based on a captured image;

FIG. 26 is a diagram for illustrating an operation of controlling a projection angle;

FIG. 27 is a diagram for illustrating an operation of calculating a projection angle;

FIG. 28 is a flow chart for illustrating an operation of controlling a projection angle;

FIG. 29 is a diagram for illustrating an operation wherein an electronic device and an external device move;

FIG. 30 is a flow chart for illustrating an operation wherein an electronic device and an external device move;

FIG. 31 is a diagram for illustrating an operation of changing a size of a content;

FIG. 32 is a flow chart for illustrating an operation of changing a size of a content;

FIG. 33 is a diagram for illustrating an operation of changing a luminance value corresponding to a content;

FIG. 34 is a flow chart for illustrating an operation of changing a luminance value corresponding to a content;

FIG. 35 is a flow chart for illustrating an operation of changing a set luminance value for projecting a content;

FIG. 36 is a diagram for illustrating an operation of changing a content projection device based on power information;

FIG. 37 is a flow chart for illustrating an operation of changing a content projection device based on power information in case a first content is a high luminance content and a second content is a low luminance content;

FIG. 38 is a flow chart for illustrating an operation of changing a content projection device based on power information in case a first content is a high luminance content and a second content is a low luminance content.

FIG. 39 is a table for illustrating a projection method corresponding to power information according to one or more embodiments;

FIG. 40 is a diagram for illustrating an operation of changing a luminance value based on power information according to one or more embodiments;

FIG. 41 is a diagram for illustrating an operation of changing a luminance value based on power information according to one or more embodiments;

FIG. 42 is a flow chart for illustrating an operation of changing a luminance value based on power information according to one or more embodiments;

FIG. 43 is a flow chart for illustrating an operation of changing a luminance value based on power information according to one or more embodiments;

FIG. 44 is a diagram for illustrating a content projection method in case power of a specific device is insufficient according to one or more embodiments;

FIG. 45 is a diagram for illustrating a content projection method in case power of a specific device is insufficient according to one or more embodiments;

FIG. 46 is a diagram for illustrating a content projection method in case power of a specific device is insufficient according to one or more embodiments;

FIG. 47 is a flow chart for illustrating a content projection method in case power of a specific device is insufficient according to one or more embodiments;

FIG. 48 is a diagram for illustrating an operation of changing a projection interval between a first content and a second content in real time;

FIG. 49 is a flow chart for illustrating an operation of changing a projection interval between a first content and a second content in real time; and

FIG. 50 is a flow chart for illustrating a control method of an electronic device according to one or more embodiments.

### DETAILED DESCRIPTION

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

The description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

Also, singular expressions include plural expressions, unless defined obviously differently in the context. Also, in the disclosure, terms such as “include” or “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in the disclosure, “a module” or “a part” performs at least one function or operation, and may be implemented as hardware or software, or as a combination of hardware and software. Also, a plurality of “modules” or “parts” may be integrated into at least one module and implemented as at least one processor, except “a module” or “a part” that needs to be implemented as specific hardware.

Further, in this specification, the term “user” may refer to a person who uses an electronic device or a device using an electronic device (e.g.: an artificial intelligence electronic device).

Hereinafter, an embodiment of the disclosure will be described in more detail with reference to the accompanying drawings.

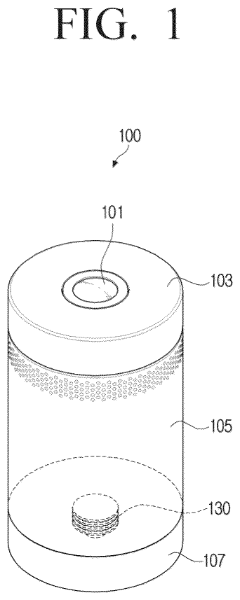

FIG. 1 is a perspective view illustrating an exterior of an electronic device 100 according to one or more embodiments.

Referring to FIG. 1, an electronic device 100 may include a projection lens 101, a head 103, a main body 105, a cover 107, or a connector 130.

The electronic device 100 may be devices in various forms. In particular, the electronic device 100 may be a projector device that enlarges and projects an image to a wall or a screen, and the projector device may be, for example, a liquid crystal display (LCD) projector or a digital light processing (DLP) type projector that uses a digital micromirror device (DMD).

In addition, the electronic device 100 may be a home or industrial display device, or an illumination device used in daily life, or an audio device including an audio module. The electronic device 100 may be implemented as a portable communication device (e.g.: a smartphone), a computer device, a portable multimedia device, a wearable device, or a home appliance device, and the like. The electronic device 100 according to one or more embodiments of the disclosure is not limited to the above-described device, and may be implemented as an electronic device 100 equipped with two or more functions of the above-described devices. For example, the electronic device 100 may be utilized as a display device, an illumination device, or an audio device as its projector function is turned off and its illumination function or a speaker function is turned on according to a manipulation of a processor, or may be utilized as an artificial intelligence (AI) speaker as it includes a microphone or a communication device.

The projection lens 101 may be formed on one surface of the main body 105, and project a light that passed through a lens array to the outside of the main body 105. The projection lens 101 according to the one or more embodiments of the disclosure may be an optical lens that was low-dispersion coated for reducing chromatic aberration. The projection lens 101 may be a convex lens or a condensing lens, and the projection lens 101 according to the one or more embodiments of the disclosure may adjust a focus by adjusting positions of a plurality of sub lenses.

The head 103 may be provided to be coupled to one surface of the main body 105 and support and protect the projection lens 101. The head 103 may be coupled to the main body 105 to be swiveled within a predetermined angle range based on one surface of the main body 105.

The head 103 may be automatically or manually swiveled by the user or the processor and freely adjust a projection angle of the projection lens 101. However, embodiments are not limited thereto, and for example, the head 103 may include a neck that is coupled to the main body 105 and extends from the main body 105, and the head 103 may thus adjust the projection angle of the projection lens 101 by being tilted backward or forward.

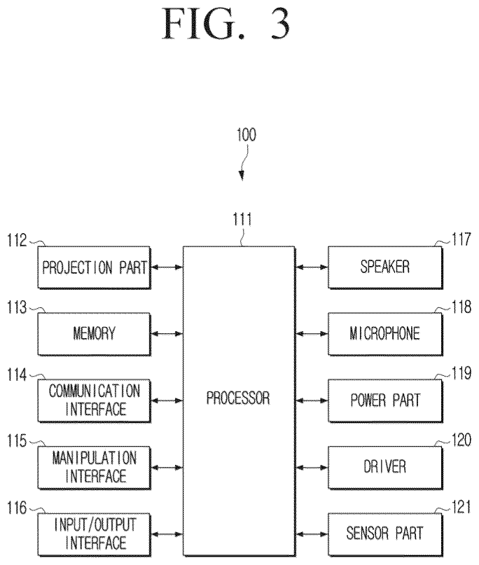

The main body 105 is a housing constituting the exterior, and may support or protect components of the electronic device 100 (e.g., components illustrated in FIG. 3) that are arranged inside the main body 105. The shape of the main body 105 may be a structure close to a cylindrical shape as illustrated in FIG. 1. However, the shape of the main body 105 is not limited thereto, and according to one or more embodiments of the disclosure, the main body 105 may be implemented in various geometrical shapes such as a column having polygonal cross sections, a cone, or a sphere.

The main body 105 may have a size enabling the main body 105 to be gripped or moved by a user with his/her one hand, or may be implemented in a micro size enabling the main body 105 to be more easily carried by the user or implemented in a size enabling the main body 105 to be held on a table or coupled to the illumination device.

The material of the main body 105 may be implemented as matt metal or a synthetic resin such that the user's fingerprint or dust is not smeared. However, embodiments are not limited thereto, and for example, the exterior of the main body 105 may consist of a slick glossy material.

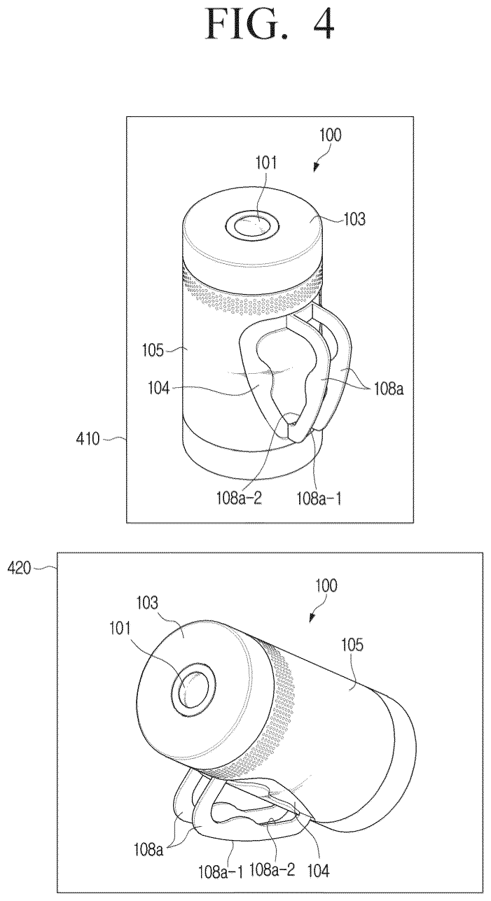

In a partial area of the exterior of the main body 105, a friction area may be formed for the user to grip and move the main body 105. However, embodiments are not limited thereto, and for example, in at least a partial area of the main body 105, a bent gripping part or a support 108a (refer to FIG. 4) that the user can grip may be provided.

The electronic device 100 may project a light or an image to a desired position by adjusting a projection angle of the projection lens 101 while adjusting a direction of the head 103 in a state where the position and angle of the main body 105 are fixed. In addition, the head 103 may include a handle that the user may grip after rotating the head in a desired direction.

A plurality of openings may be formed in an outer circumferential surface of the main body 105. Through the plurality of openings, audio output from an audio output interface may be output to the outside of the main body 105 of the electronic device 100. The audio output interface may include a speaker, and the speaker may be used for general uses such as reproduction of multimedia or reproduction of recording, and output of a voice, etc.

According to the one or more embodiments of the disclosure, the main body 105 may include a radiation fan provided therein, and when the radiation fan is operated, air or heat inside the main body 105 may be discharged through the plurality of openings. Accordingly, the electronic device 100 may discharge heat generated by driving of the electronic device 100 to the outside, and prevent overheating of the electronic device 100.

The connector 130 may connect the electronic device 100 with an external device to transmit or receive electric signals, or receive power from the external device. The connector 130 according to the one or more embodiments of the disclosure may be physically connected with the external device. Here, the connector 130 may include an input/output interface, and connect its communication with the external device in a wired or wireless manner or receive power from the external device. For example, the connector 130 may include a high definition multimedia interface (HDMI) connection terminal, a universal serial bus (USB) connection terminal, a secure digital (SD) card accommodating groove, an audio connection terminal, or a power consent. However, embodiments are not limited thereto, and for example, the connector 130 may include a Bluetooth, wireless-fidelity (Wi-Fi), or a wireless charge connection module, which are connected with the external device in a wireless manner.

In addition, the connector 130 may have a socket structure connected to an external illumination device, and may be connected to a socket accommodating groove of the external illumination device to receive power. The size and specification of the connector 130 having the socket structure may be implemented in various ways in consideration of an accommodating structure of an external device that may be coupled thereto. For example, a diameter of a joining portion of the connector 130 may be 26 mm, and in this case, the electronic device 100 may be coupled to an external illumination device such as a stand in place of a light bulb that is generally used. When being fastened to a conventional socket positioned on a ceiling, the electronic device 100 may be projected from the upper side to the lower side, and in case the electronic device 100 does not rotate due to socket coupling, the screen may not be rotated, either. Accordingly, in order that the electronic device 100 may rotate even when it is socket-coupled and receives power, the head 103 of the electronic device 100 may adjust a projection angle by being swiveled on one surface of the main body 105 while the electronic device 100 is socket-coupled to a stand on the ceiling, allowing the electronic device 100 to project a screen or rotate a screen to a desired position.

The connector 130 may include a coupling sensor, and the coupling sensor may detect whether the connector 130 and an external device are coupled, the coupling state, or a coupling target, and transmit the same to the processor, and the processor may control the driving of the electronic device 100 based on the transmitted detection values.

The cover 107 may be coupled to or separated from the main body 105, and protect the connector 130 such that it is not exposed to the outside at all times. The shape of the cover 107 may be a shape continued from the main body 105 as illustrated in FIG. 1, or may be implemented to correspond to the shape of the connector 130. The cover 107 may support the electronic device 100, and the electronic device 100 may be used by being coupled to or held on an external holder while being coupled to the cover 107.

In the electronic device 100 according to the one or more embodiments of the disclosure, a battery may be provided inside the cover 107. The battery may include, for example, a primary cell that may not be recharged, a secondary cell that may be recharged, or a fuel cell.

The electronic device 100 may include a camera module, and the camera module may capture a still image or a video. According to the one or more embodiments of the disclosure, the camera module may include at least one lens, an image sensor, an image signal processor, or a flash.

Also, the electronic device 100 may include a protection case for the electronic device 100 to be easily carried while being protected. However, embodiments are not limited thereto, and for example, the electronic device 100 may include a stand that supports or fixes the main body 105, and a bracket that may be coupled to a wall surface or a partition.

In addition, the electronic device 100 may be connected with various external devices by using its socket structure, and provide various functions. According to the one or more embodiments of the disclosure, the electronic device 100 may be connected to an external camera device by using the socket structure. The electronic device 100 may provide an image stored in the connected camera device or an image that is currently being captured using a projecting part 112. As another example, the electronic device 100 may be connected to a battery module by using its socket structure to receive power. The electronic device 100 may be connected to an external device by using its socket structure, but this is merely one of various examples, and the electronic device 100 may be connected an external device by using another interface (e.g., a USB, etc.).

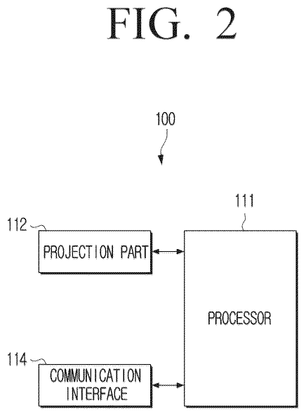

FIG. 2 is a block diagram illustrating a configuration of the electronic device 100 according to one or more embodiments.

Referring to FIG. 2, the electronic device 100 may include at least one processor 111, a projection part 112, and a communication interface 114.

The at least one processor 111 may perform overall control operations of the electronic device 100. Specifically, the processor 111 performs a function of controlling the overall operations of the electronic device 100. Detailed explanation related to the at least one processor 111 will be described in FIG. 3.

The projection part 112 is a component that projects an image (a projection image, a content, etc.) to the outside. Detailed explanation related to the projection part 112 will be described in FIG. 3.

The communication interface 114 may perform communication with an external device 200, a server 300, or a router 400. For example, the electronic device 100 may transmit information to the external device 200 or receive information from the external device 200 through the communication interface 114. The electronic device 100 may be connected with the external device 200 by using a wireless communication method or a wired communication method. Detailed explanation related to the communication interface 114 will be described in FIG. 3.

When a user input for projecting a first content 11 from the electronic device 100 and projecting a second content 12 from the external device 200 is received, the at least one processor 111 may obtain a difference value between a first luminance value corresponding to the first content 11 and a second luminance value corresponding to the second content 12, and based on the difference value, obtain a projection interval of the first content 11 and the second content 12, control the projection part 112 to project the first content 11 based on the projection interval, and transmit the second content 12 and a control signal for projecting the second content 12 to the external device 200 through the communication interface 114.

Here, the user input may be a user instruction for using a multi-view function. Here, the multi-view function may be a function for projecting at least two contents. According to one or more embodiments, with the multi-view function, one projector may project two or more contents. Also, according to one or more embodiments, with the multi-view function, two or more projectors may respectively project allotted contents.

There may be various methods for receiving the first content 11 and the second content 12.

According to one or more embodiments, the electronic device 100 may receive the first content 11 or the second content 12 through a user's terminal device (e.g., a smartphone, a tablet, etc.).

According to one or more embodiments, the electronic device 100 may receive the first content 11 or the second content 12 through a server (or an external server).

According to one or more embodiments, the electronic device 100 may receive the first content 11 or the second content 12 from a source device through a universal serial bus (USB) or an interface such as a high definition multimedia interface (HDMI), etc.

According to one or more embodiments, the electronic device 100 may receive the first content 11 or the second content 12 through an over the top (OTT) device.

In the one or more embodiments described below, the electronic device 100 and the external device 200 may be projectors. Also, the first content 11 may be projected from the electronic device 100, and the second content 12 may be projected from the external device 200 according to a user input.

Here, when a user input is received, the at least one processor 111 may obtain a first luminance value corresponding to the first content 11 and a second luminance value corresponding to the second content 12. Here, a luminance value may be luminance information related to a light source for projecting a content. According to one or more embodiments, a luminance value may be determined based on at least one of pixel values included in a content or a projection brightness set value of the projection part 112. Accordingly, when pixels included in a content are brighter or a projection brightness set value increases, a luminance value may become higher.

Here, the at least one processor 111 may identify projection areas for the first content 11 and the second content 12 to be projected. A projection area may be an area wherein a subject for projection is projected in a projection surface 10. The first position information may include information related to a first projection area wherein the first content 11 is projected among the entire projection areas. The second position information may include information related to a second projection area wherein the second content 12 is projected among the entire projection areas.

Here, the position information may include at least one of information on the projection surface 10, information on a projection area wherein a content is projected in the projection surface 10, or a central location of the projection area. Accordingly, the electronic device 100 or the external device 200 may determine in which location a content will be projected based on the position information. For example, the electronic device 100 or the external device 200 may determine a projection angle or a projection direction based on the position information.

The at least one processor 111 may obtain information on a first position wherein the first content 11 is projected based on the projection interval, and control the projection part 112 to project the first content 11 based on the first position information, and the projection interval may become bigger as the difference value increases. Here, the at least one processor 111 may determine locations wherein the first content 11 and the second content 12 are projected based on a difference value between the first luminance value and the second luminance value. The at least one processor 111 may control the projection part 112 and the projection part of the external device 200 such that the first content 11 and the second content 12 are projected while being distanced from each other farther as the difference value is bigger.

When the difference value between the first luminance value and the second luminance value is greater than or equal to a threshold luminance value, the user may feel inconvenience due to the difference in the luminance. Accordingly, the at least one processor 111 may control the projection part 112 and the projection part of the external device 200 such that the first content 11 and the second content 12 are output while being distanced from each other by a projection interval based on a difference value. Here, the projection interval may be different according to the difference value. When the difference value increases, the projection interval may also become bigger. When the difference value becomes smaller, the projection interval may also become smaller.

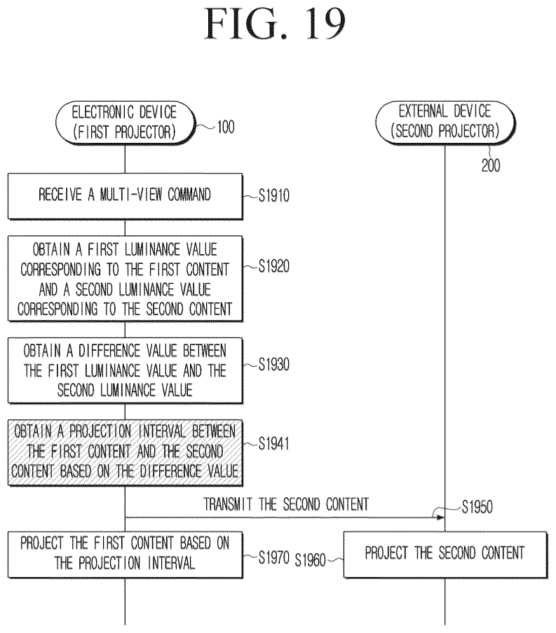

A specific operation related to a projection interval will be described in FIG. 19.

The at least one processor 111 may obtain a luminance value corresponding to a content by using at least one method among a method of using metadata, a method of using an average pixel value, or a method of using a captured image.

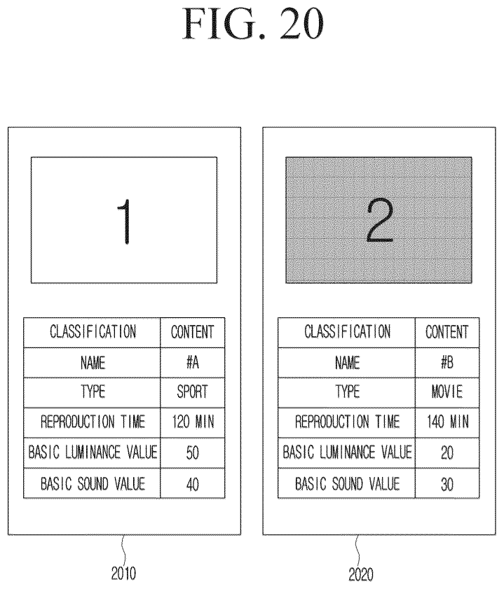

According to one or more embodiments, the at least one processor 111 may obtain a luminance value of a content based on metadata. In the metadata, information related to luminance may be included. The at least one processor 111 may obtain a luminance value corresponding to a content based on metadata received along with the content. Here, the luminance value corresponding to the content may be an average luminance value. For example, in the case of a sport content, the average luminance value may be higher than a general content. Explanation related to metadata will be described in FIG. 20.

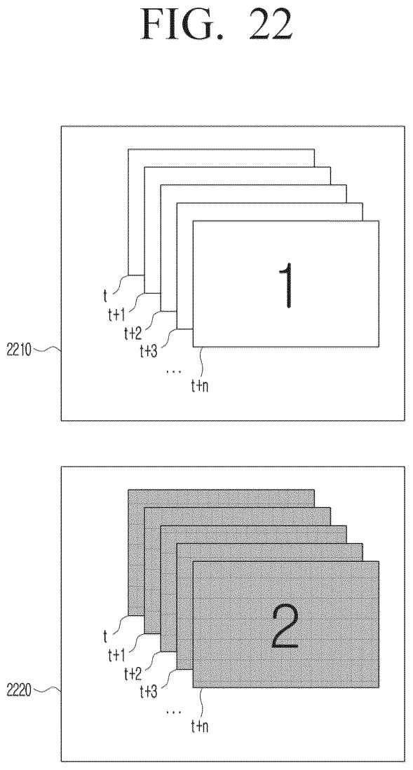

According to one or more embodiments, the at least one processor 111 may obtain a luminance value of a content based on an average pixel value of a plurality of frames included in the content. The at least one processor 111 may obtain an average pixel value by analyzing pixel values of frames within a predetermined period or each of the received frames. Then, the at least one processor 111 may obtain the luminance value corresponding to the content based on the average pixel value. Explanation related to an average pixel value will be described in FIG. 22.

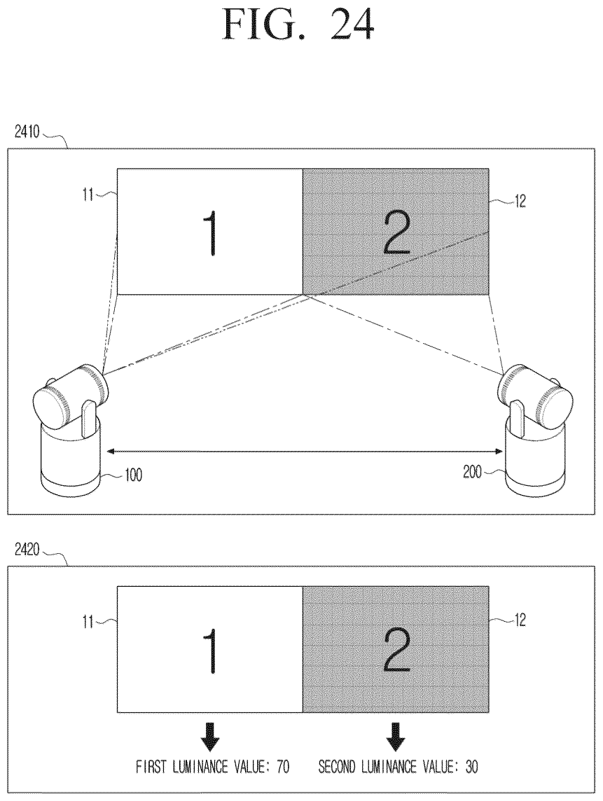

According to one or more embodiments, the at least one processor 111 may obtain a luminance value of a content based on an image captured through the camera. The at least one processor 111 may obtain an image including a content projected on the projection surface 10 through the camera. The at least one processor 111 may obtain the luminance value corresponding to the content by analyzing the captured image. Explanation related to a captured image will be described in FIG. 24.

The at least one processor 111 may obtain first metadata corresponding to the first content 11 and second metadata corresponding to the second content 12, obtain a first luminance value based on the first metadata, and obtain a second luminance value based on the second metadata.

Here, the at least one processor 111 may obtain the first content 11 and the first metadata corresponding to the first content 11. Also, the at least one processor 111 may obtain the second content 12 and the second metadata corresponding to the second content 12. Here, the at least one processor 111 may obtain at least one of the first content 11, the first metadata, the second content 12, or the second metadata by the server 300 or an external storage device connected by the user, etc.

The first metadata may include a basic luminance value representing the first content 11. The at least one processor 111 may obtain (or identify) the first luminance value corresponding to the first content 11 based on the basic luminance value included in the first metadata.

The second metadata may include a basic luminance value representing the second content 12. The at least one processor 111 may obtain (or identify) the second luminance value corresponding to the second content 12 based on the basic luminance value included in the second metadata.

When the first luminance value was not obtained based on the first metadata, the at least one processor 111 may obtain the first luminance value based on the average pixel value of the plurality of frames included in the first content 11, and when the second luminance value was not obtained based on the second metadata, the at least one processor 111 may obtain the second luminance value based on the average pixel value of the plurality of frames included in the second content 12.

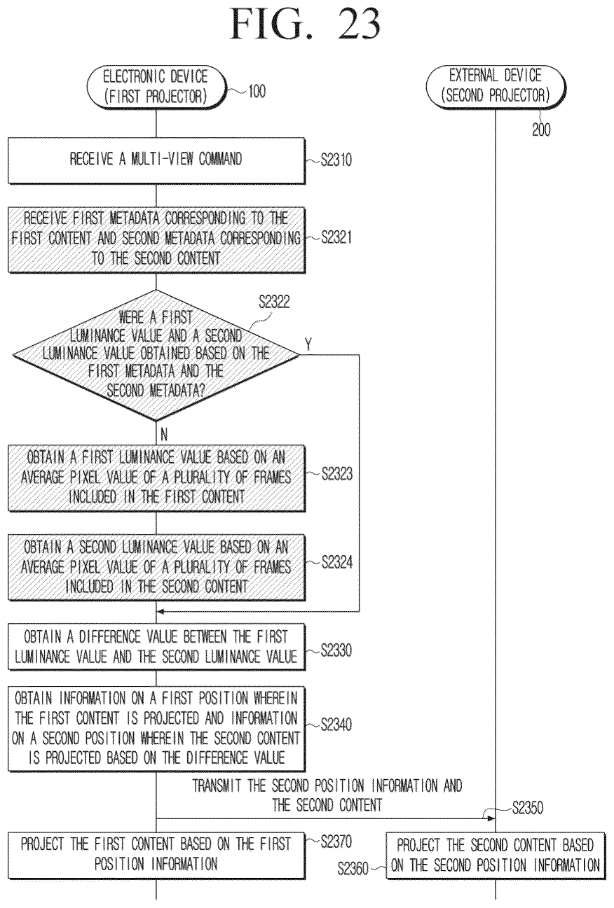

Here, the at least one processor 111 may obtain a luminance value by prioritizing the method of using metadata. However, when a luminance value is not obtained by the method of using metadata, the at least one processor 111 may obtain a luminance value by the method of using an average pixel value. Explanation in this regard will be described in FIG. 23.

The sensor part 121 may include an image sensor. Here, the image sensor may be a camera.

When the first luminance value is not obtained based on the first metadata, the at least one processor 111 may obtain an image including the first content 11 projected on the projection surface 10 through the camera, and obtain the first luminance value based on the obtained image, and when the second luminance value is not obtained based on the second metadata, the at least one processor 111 may obtain an image including the second content 12 projected on the projection surface 10 through the camera, and obtain the second luminance value based on the obtained image.

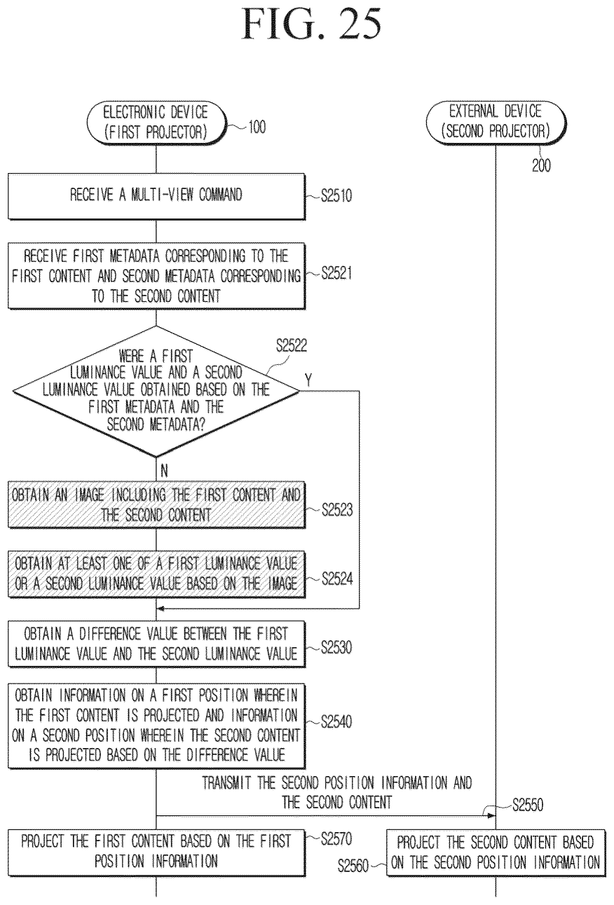

Here, the at least one processor 111 may obtain a luminance value by prioritizing the method of using metadata. However, when a luminance value is not obtained by the method of using metadata, the at least one processor 111 may obtain a luminance value by the method of using a captured image. Explanation in this regard will be described in FIG. 25.

The at least one processor 111 may control the projection part 112 to project the first content 11 on the first area corresponding to the first position information by controlling a projection angle based on a projection interval.

According to one or more embodiments, the at least one processor 111 may use a lens shift function for controlling a projection angle. The at least one processor 111 may project the first content 11 to be distanced from the second content 12 by a projection interval by adjusting an angle by which the projection part 112 projects a light.

According to one or more embodiments, the at least one processor 111 may rotate the main body 105 of the electronic device 100. The at least one processor 111 may adjust a projection angle by rotating the main body 105.

Here, the at least one processor 111 may identify the projection surface 10. The at least one processor 111 may identify projection areas wherein the first content 11 and the second content 12 will be output in the projection surface 10. The at least one processor 111 may identify a first projection area (a first area) wherein the first content 11 will be output and a second projection area (a second area) wherein the second content 12 will be output in the projection area. The at least one processor 111 may obtain the first position information including information related to the first projection area wherein the first content 11 will be output. Also, the at least one processor 111 may obtain the second position information including information related to the second projection area wherein the second content 12 will be output.

Here, the at least one processor 111 may obtain a first projection angle for the first content 11 to be output in the first area (the first projection area) included in the first position information. Then, the at least one processor 111 may control the projection part 112 such that the first content 11 is projected on the first area (the first projection area) based on the first projection angle.

Here, the at least one processor 111 may transmit the second position information to the external device 200. The external device 200 may obtain a second projection angle for the second content 12 to be output in the second area (the second projection area) included in the second position information based on the second position information received from the electronic device 100. Then, the at least one processor 111 may control the projection part of the external device 200 such that the second content 12 is projected on the second area (the second projection area) based on the second projection angle.

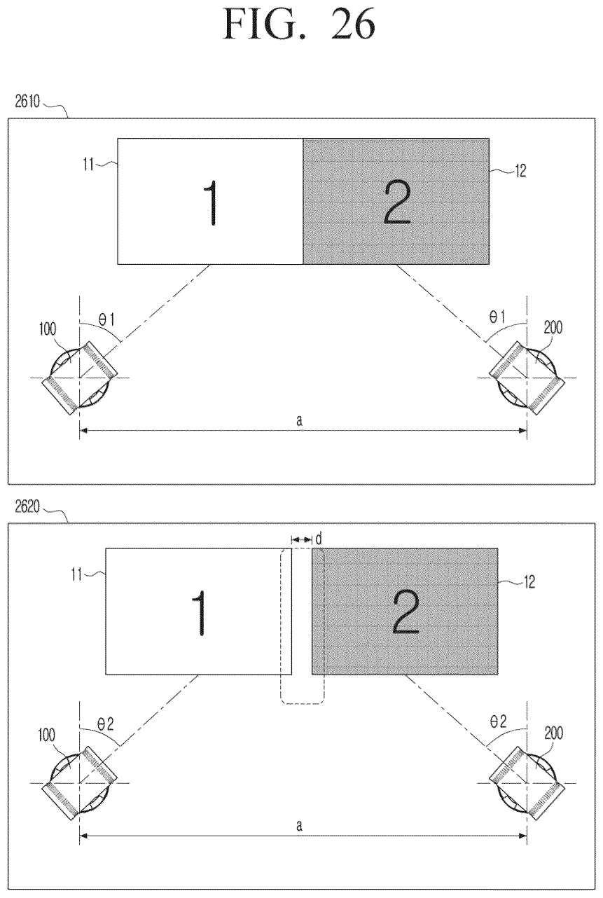

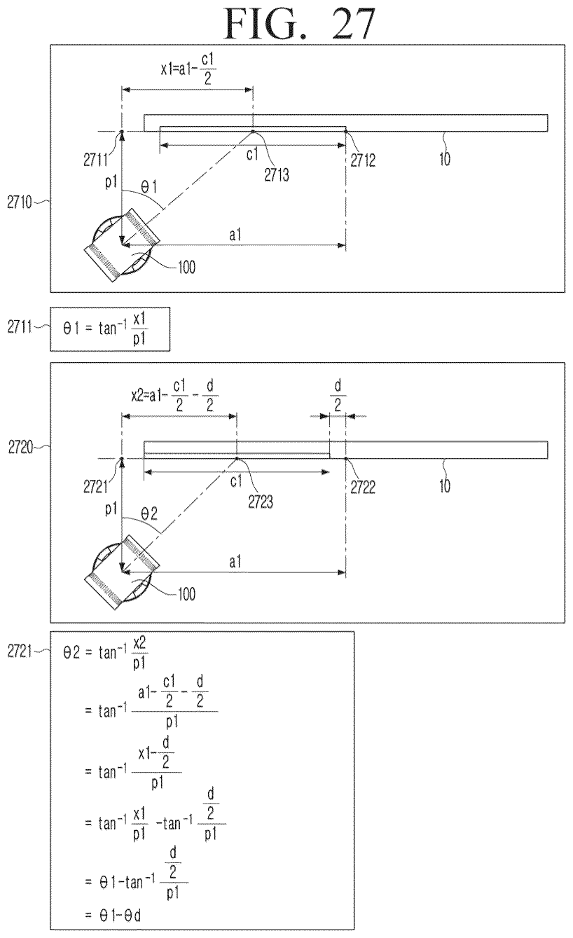

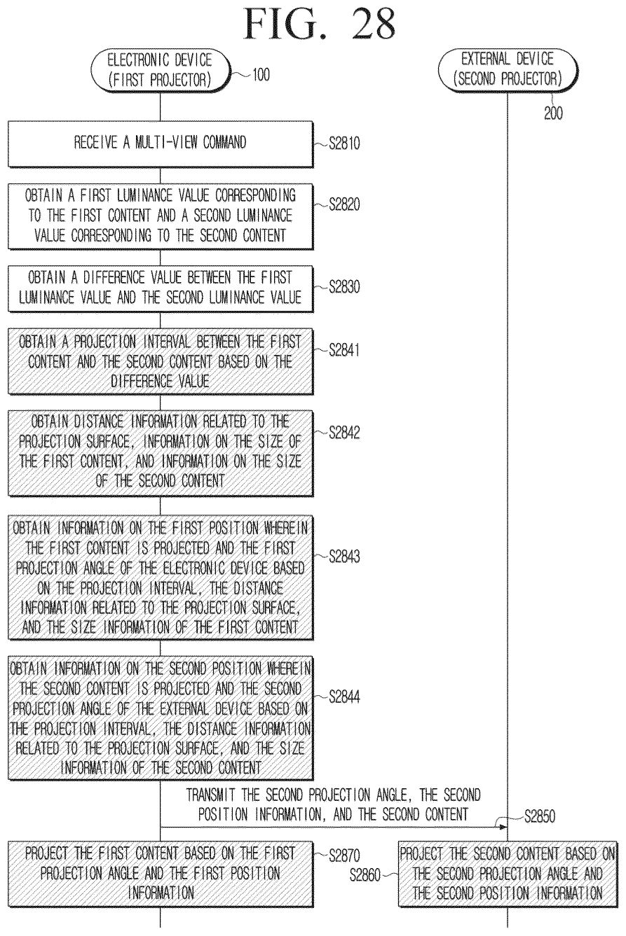

Detailed explanation related to a projection angle will be described in FIG. 26, FIG. 27, and FIG. 28.

When it is identified that the first content 11 may not be projected on the first area corresponding to the first position information by controlling a projection angle, the at least one processor 111 may control the moving element to project the first content 11 on an area corresponding to the first position information.

Here, an intrinsic physical viewing angle may exist for the projection part 112. Accordingly, there may be a limit angle to which the at least one processor 111 may adjust a projection angle. In case projection areas for projecting the first content 11 and the second content 12 are beyond the viewing angle of the projection part 112, the at least one processor 111 may control the moving element to directly move the electronic device 100. The at least one processor 111 may control the motor to control the moving element.

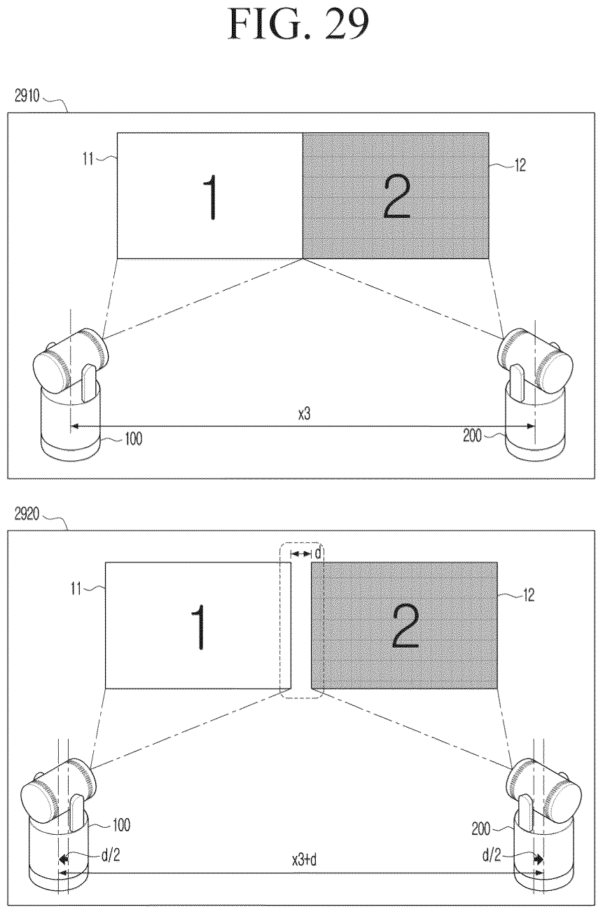

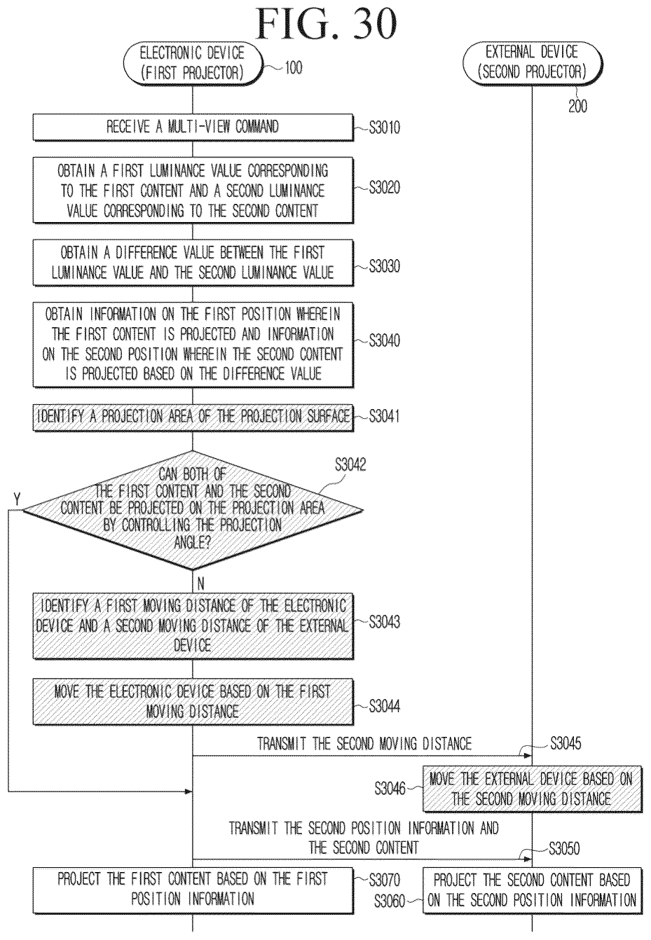

An operation wherein the electronic device 100 itself moves will be described in FIG. 29 and FIG. 30.

When it is identified that the first content 11 may not be projected on the first area corresponding to the first position information by controlling a projection angle, the at least one processor 111 may change the size of the first content 11, and control the projection part 112 to project the changed first content 11 on the first area corresponding to the first position information.

Here, in case the projection areas for projecting the first content 11 and the second content 12 are beyond the viewing angle of the projection part 112, the at least one processor 111 may maintain the projection angle or control the angle to the limit angle, and then change the size of the content. For example, the at least one processor 111 may control the projection part 112 and the projection part of the external device 200 such that the first content 11 and the second content 12 may be projected while being distanced from each other by a projection interval d by reducing the size of the content.

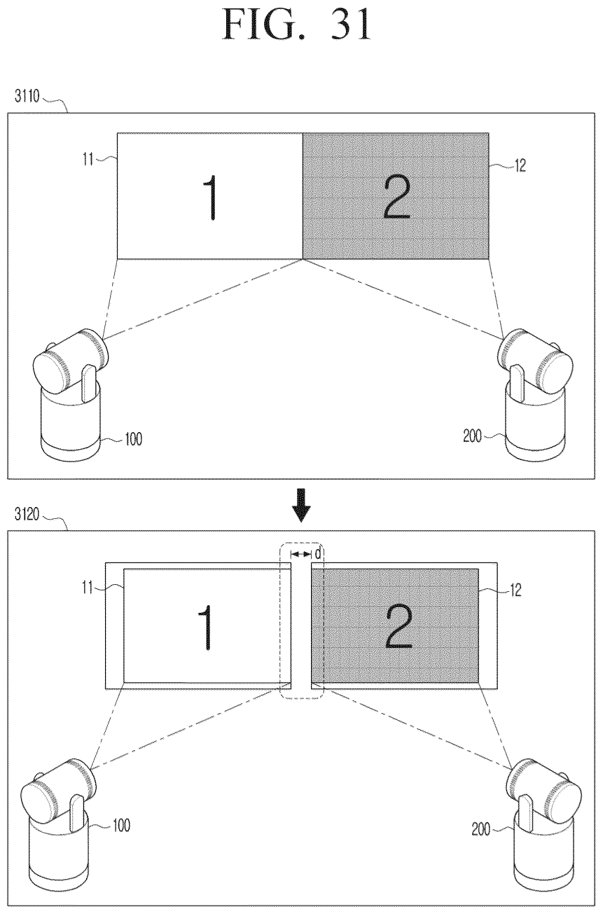

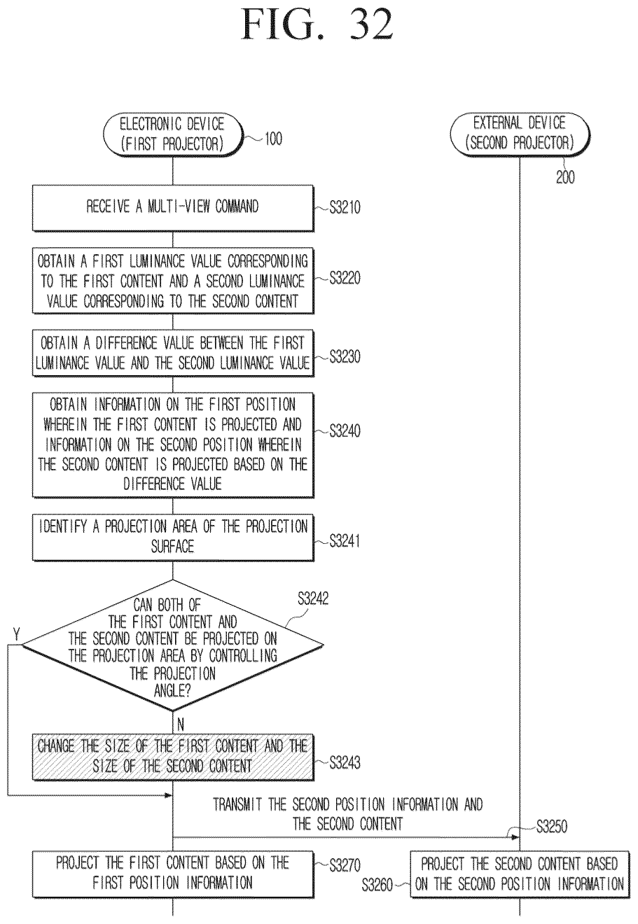

An operation of changing a size of a content will be described in FIG. 31 and FIG. 32.

When a difference value is greater than or equal to the threshold luminance value, the at least one processor 111 may change at least one of the first luminance value or the second luminance value, and when the first luminance value is changed, the at least one processor 111 may control the projection part 112 to project the first content 11 based on the changed first luminance value, and when the second luminance value is changed, the at least one processor 111 may transmit a control signal for projecting the second content 12 based on the changed second luminance value to the external device 200 through the input/output interface 116.

When the difference value between the first luminance value and the second luminance value is greater than or equal to the threshold luminance value, visibility for the user may not be improved due to the projection interval. Accordingly, the at least one processor 111 may change at least one of the first luminance value or the second luminance value.

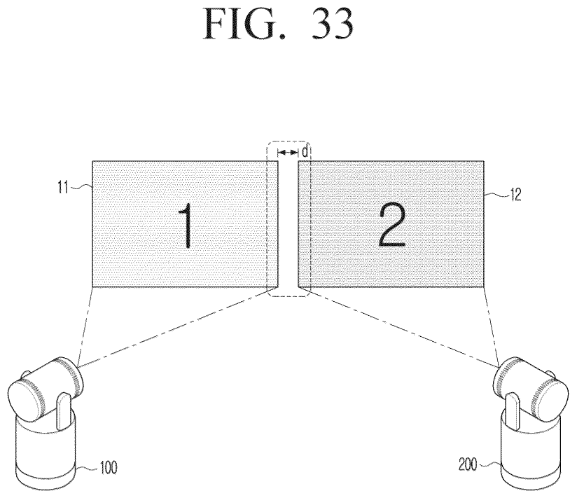

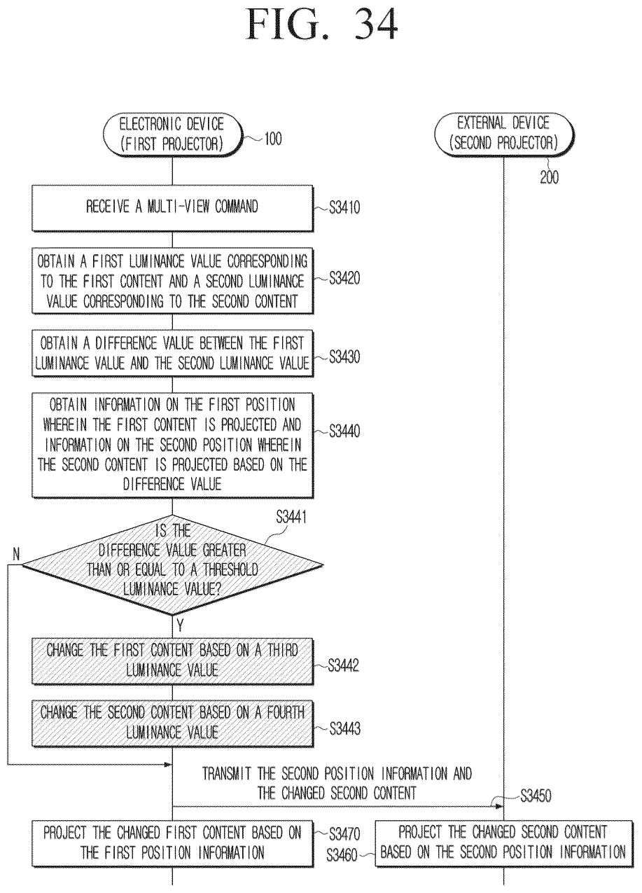

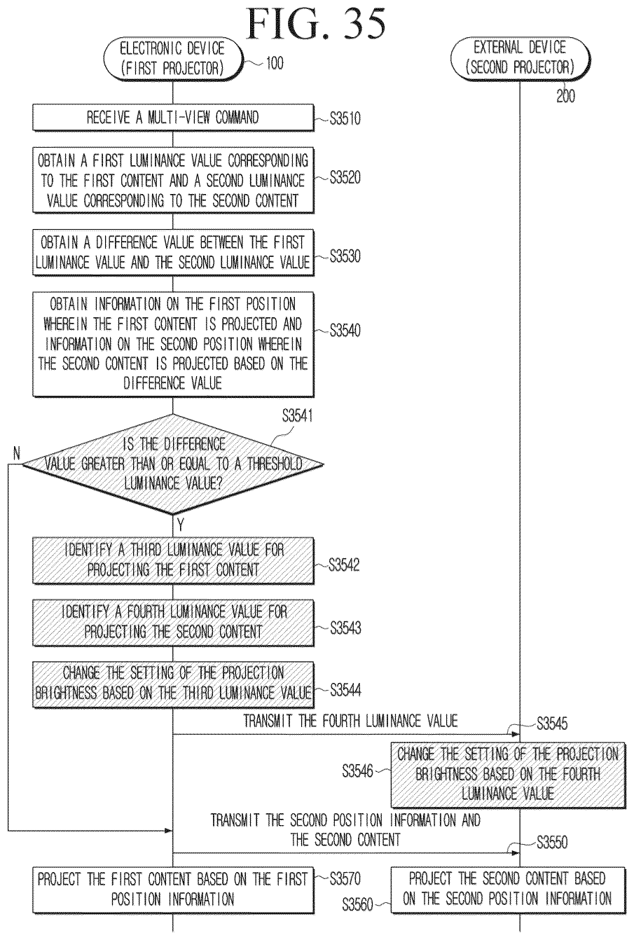

An operation of changing the luminance value will be described in FIG. 33, FIG. 34, and FIG. 35.

The at least one processor 111 may obtain first power information for the battery of the electronic device 100, and obtain second power information for the battery or the external device 200 and information on the second position wherein the second content is projected through the input/output interface 116, and when the first power information is smaller than a threshold power value, and the second power information is greater than or equal to the threshold power value, compare the first luminance value and the second luminance value, and when the first luminance value exceeds the second luminance value, project a guide UI for projecting the first content 11 from the external device 200 and projecting the second content 12 from the electronic device 100, and when a user input is received through the guide UI, control the projection part 112 to project the second content 12 based on the second position information, and transmit a control signal for projecting the first content 11 based on the first position information to the external device 200 through the input/output interface 116.

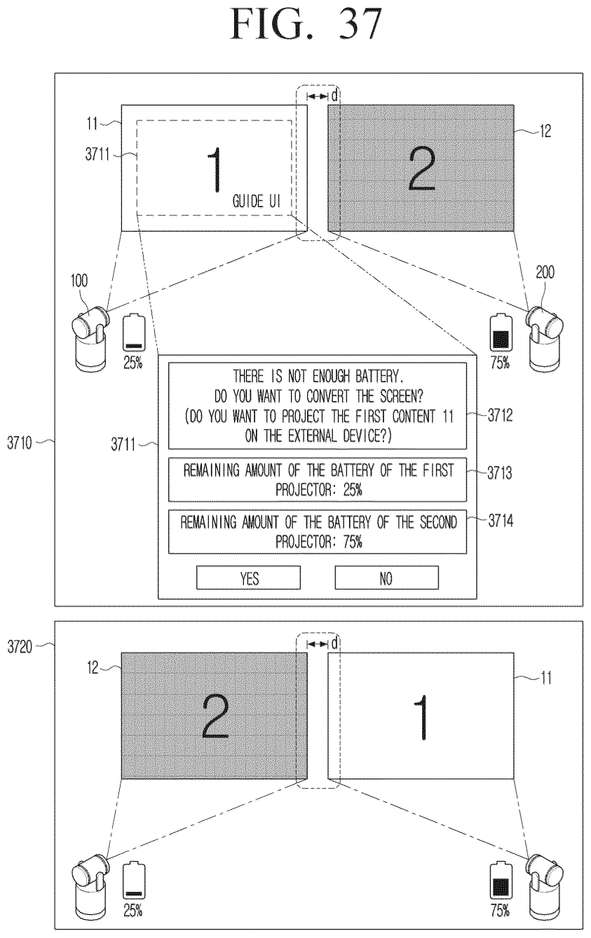

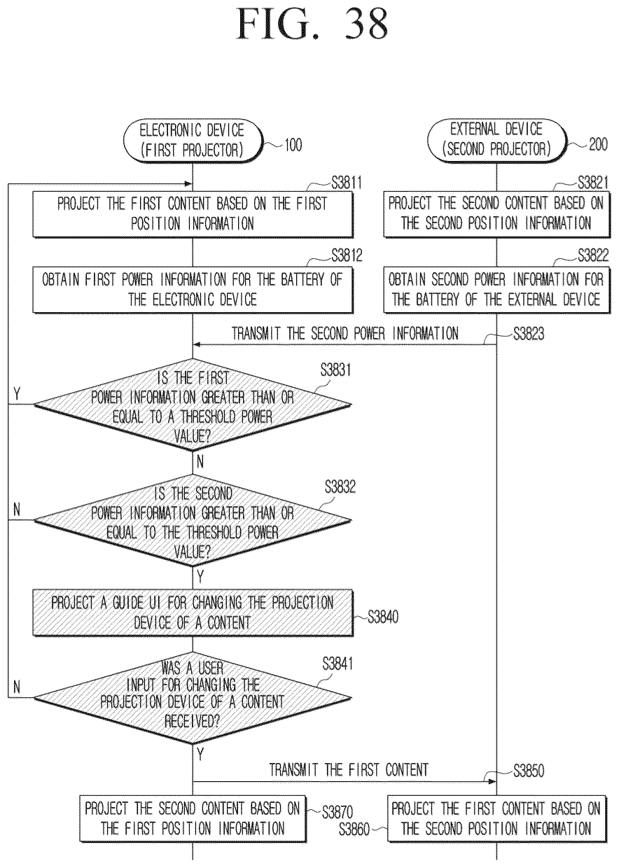

Explanation related to the guide UI will be described in FIG. 37 to FIG. 38.

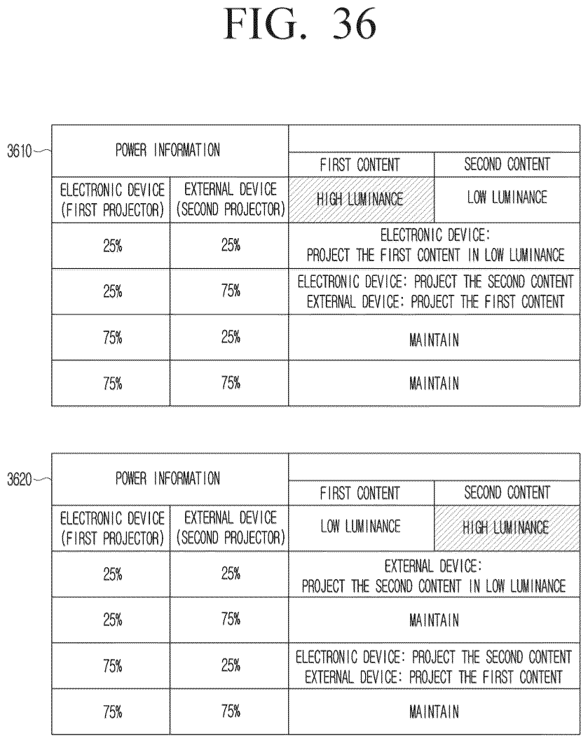

Various control operations that are determined according to the situation of the power information will be described in FIG. 36.

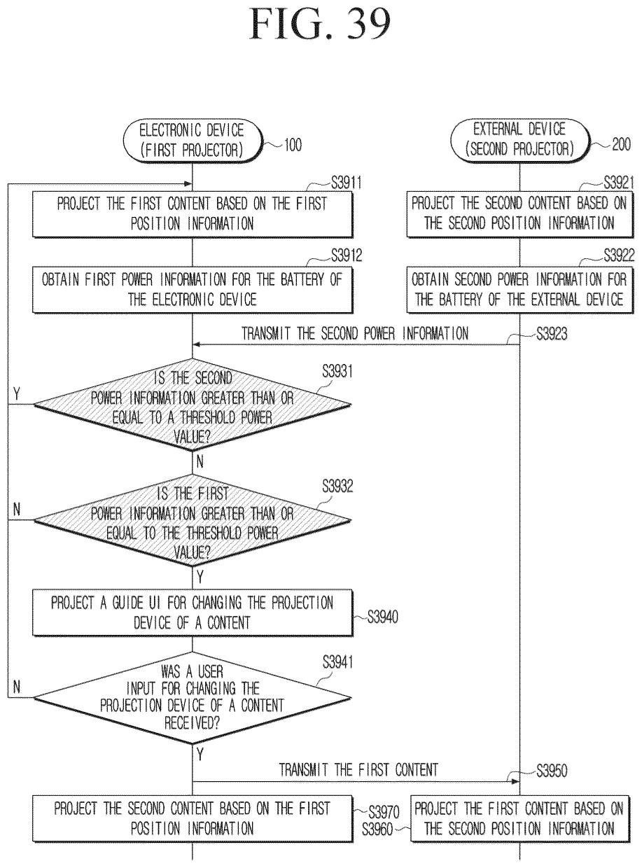

An operation of changing a device that projects a content based on the power information will be described in FIG. 37, FIG. 38, and FIG. 39.

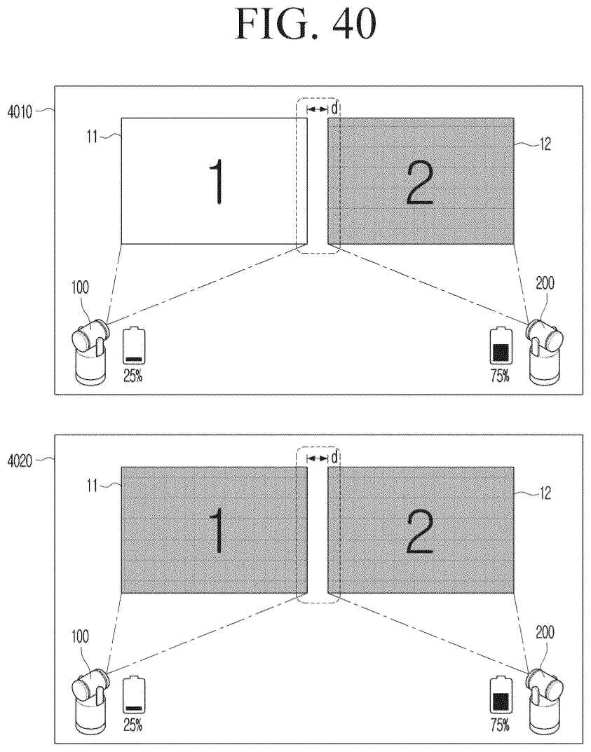

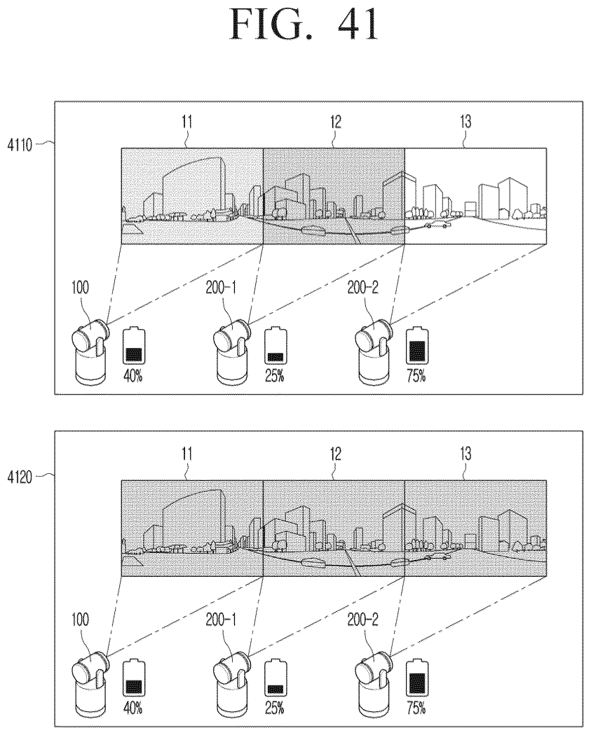

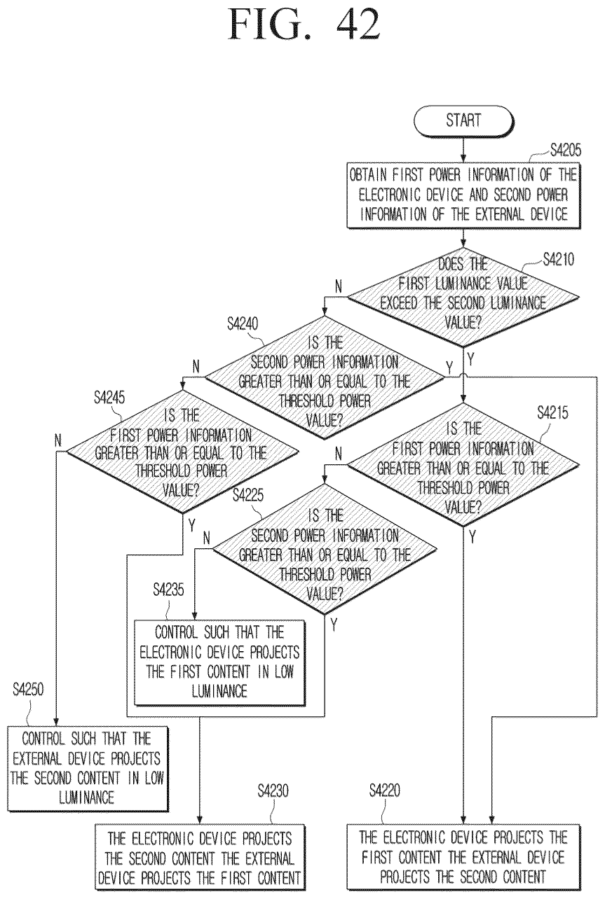

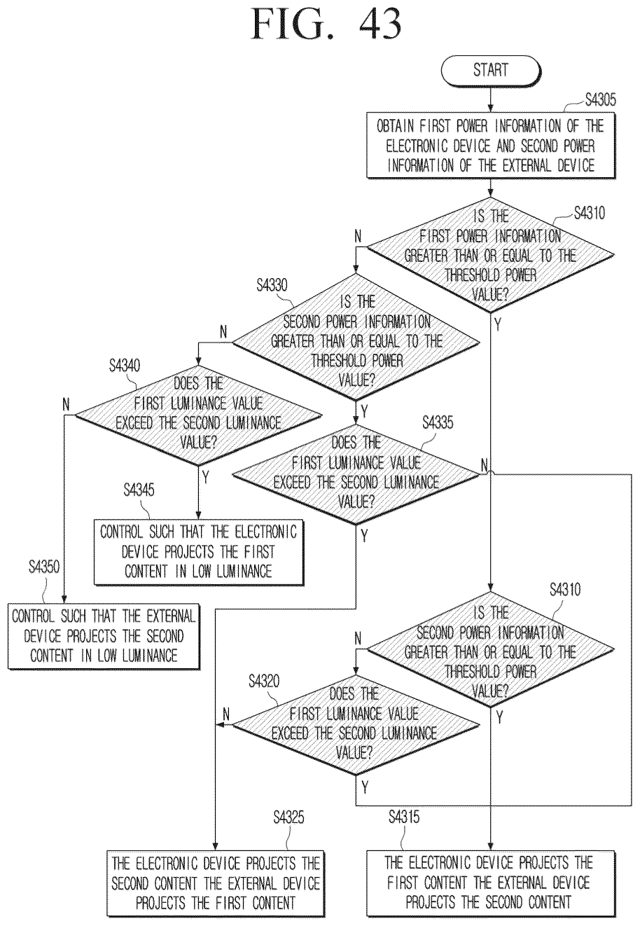

An operation of changing a luminance value of a content based on the power information will be described in FIG. 40, FIG. 41, FIG. 42, and FIG. 43.

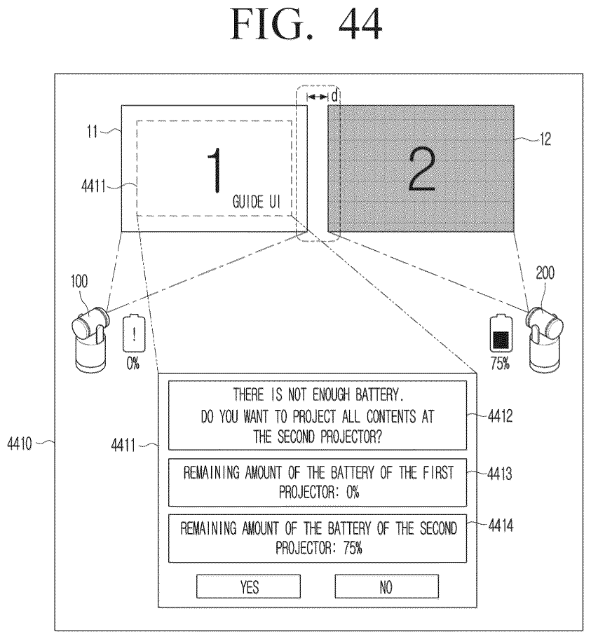

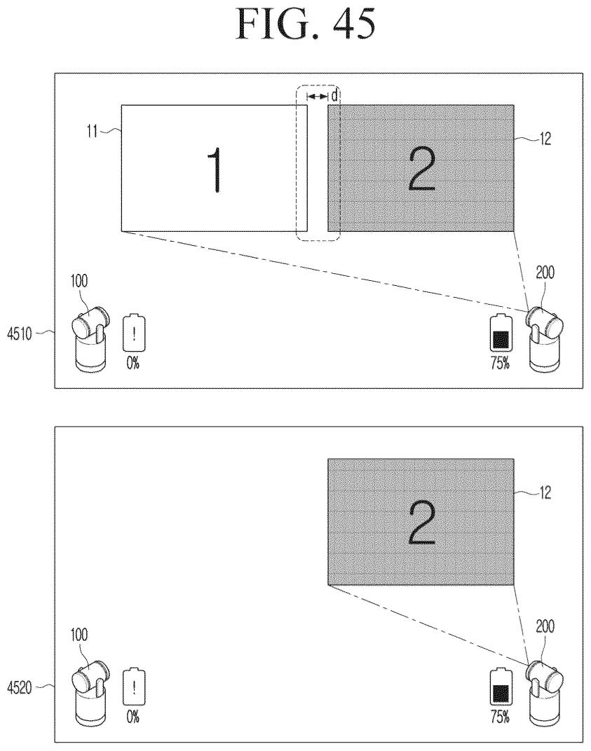

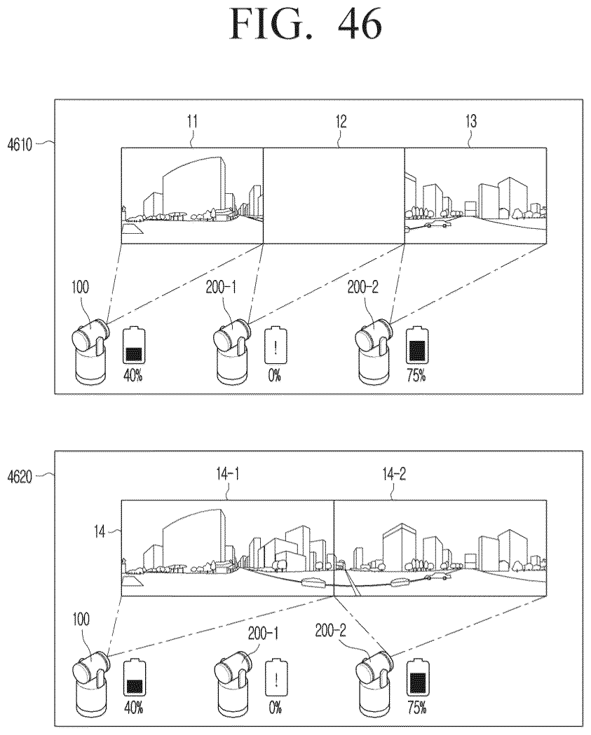

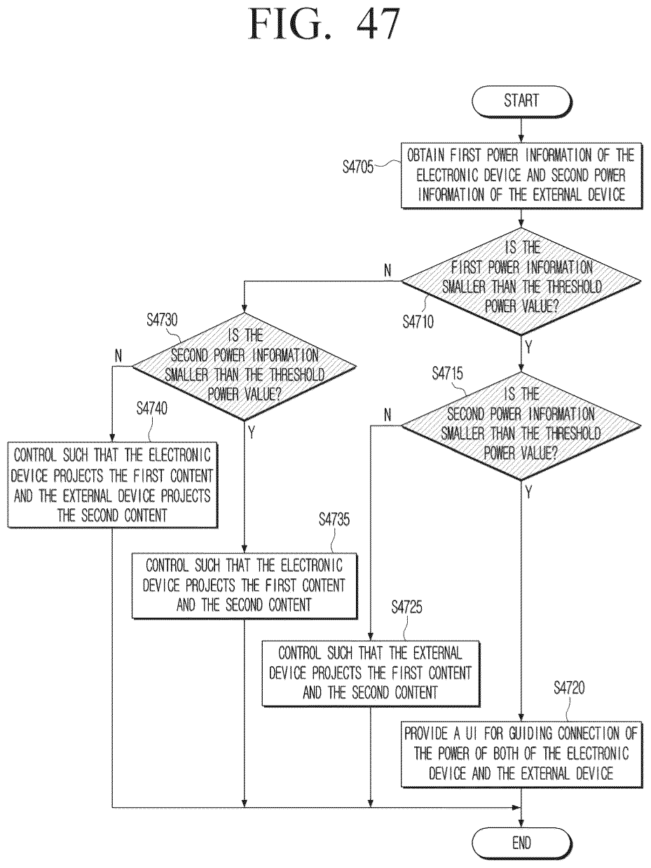

An operation wherein the remaining devices project a plurality of contents in case one device may not project a content based on the power information will be described in FIG. 44, FIG. 45, FIG. 46, and FIG. 47.

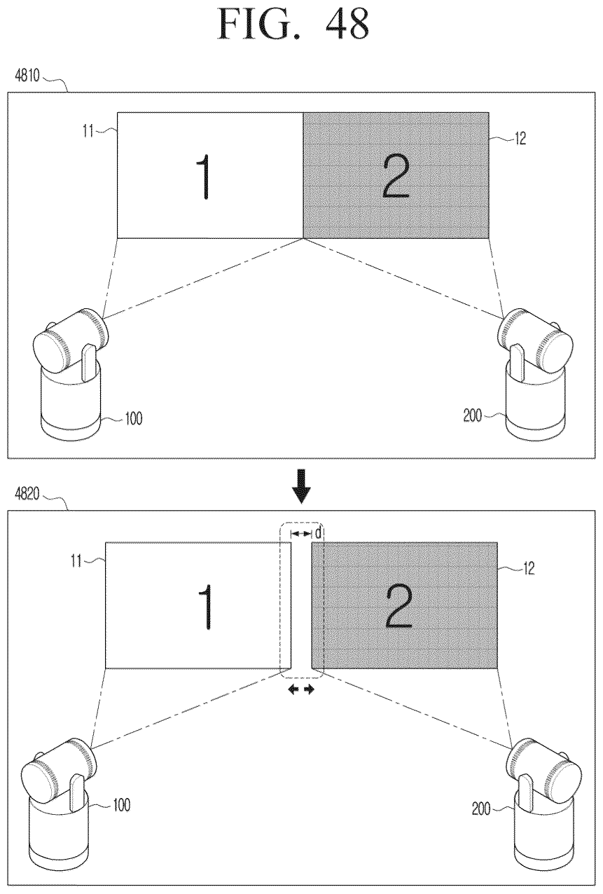

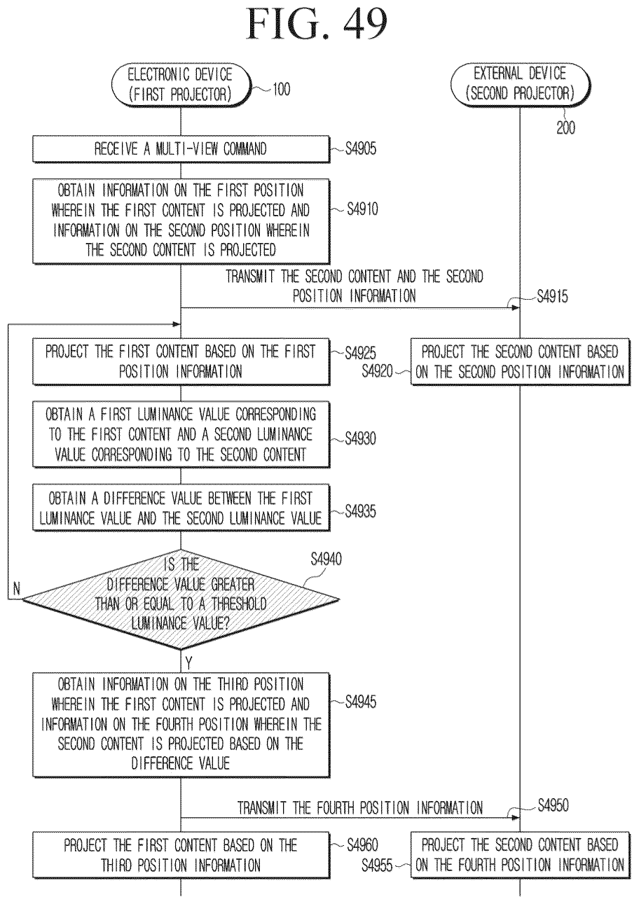

An operation of changing a projection interval in real time by analyzing luminance values in real time will be described in FIG. 48 and FIG. 49.

There may be various methods for projecting the first content 11 and the second content 12 while distancing them by a projection interval.

According to one or more embodiments, the electronic device 100 may perform control such that the first content 11 is projected to be distanced from the second content 12 by a projection interval by adjusting the projection position of the first content 11. Here, the electronic device 100 may be aware of the projection position of the second content 12 (the second position information) projected by the external device 200 in advance. The electronic device 100 may identify a position wherein the first content 11 may be projected (the first position information) to be distanced from the position wherein the second content 12 is projected (the second position information) by a projection interval, and control the projection part 112 based on the first position information.

According to one or more embodiments, the external device 200 may perform control such that the second content 12 is projected to be distanced from the first content 11 by a projection interval by adjusting the projection position of the second content 12. The electronic device 100 may identify a projection position wherein the first content 11 is projected (the first position information). Then, the electronic device 100 may identify a projection position wherein the second content 12 may be output (the second position information) to be distanced from the first content 11 by a projection interval, and transmit the second position information to the external device 200. The external device 200 may project the second content 12 based on the second position information.

According to one or more embodiments, both of the electronic device 100 and the external device 200 may perform control such that the first content 11 and the second content 12 are projected to be distanced from each other by a projection interval by adjusting the projection positions. For example, when the projection interval is d, the electronic device 100 may adjust the projection positions by d/2, and the external device 200 may adjust the projection positions by d/2. The electronic device 100 may identify the position wherein the first content 11 is projected (the first position information) and the position wherein the second content 12 is projected (the second position information). Then, the electronic device 100 may project the first content 11 based on the first position information. The electronic device 100 may transmit the second position information to the external device 200. The external device 200 may project the second content 12 based on the second position information.

In providing a multi-view function, when luminance values of a plurality of contents are different, the user may feel eye strain. The electronic device 100 may operate such that the plurality of contents are projected by a projection interval d. Accordingly, satisfaction of the user may be improved in using the multi-view function.

Also, the electronic device 100 may change the device that projects a content or change luminance values in consideration of the power information. Accordingly, the electronic device 100 can provide contents of the same quality to the user during the longest time possible, and save the power.

In the above, some components constituting the electronic device 100 were illustrated and explained, but in actual implementation, various components may be additionally included. Explanation in this regard will be described with reference to FIG. 3 below.

FIG. 3 is a block diagram illustrating in detail a configuration of the electronic device 100 in FIG. 2.

Referring to FIG. 3, the electronic device 100 may include at least one of a processor 111, a projection part 112, memory 113, a communication interface 114, a manipulation interface 115, an input/output interface 116, a speaker 117, a microphone 118, a power part 119, a driver 120, or a sensor part 121. The components illustrated in FIG. 3 are merely various examples, and some components may be omitted, or new components may be added.

Contents that were already explained in FIG. 2 will be omitted.

The processor 111 may be implemented as a digital signal processor (DSP) processing digital signals, a microprocessor, and a time controller (TCON). However, embodiments are not limited thereto, and the processor 111 may include one or more of a central processing unit (CPU), a micro controller unit (MCU), a micro processing unit (MPU), a controller, an application processor (AP), a graphics-processing unit (GPU) or a communication processor (CP), and an advanced reduced instruction set computer (RISC) machines (ARM) processor, or may be defined by the terms. Also, the processor 111 may be implemented as a system on chip (SoC) having a processing algorithm stored therein or large scale integration (LSI), or implemented in the form of a field programmable gate array (FPGA). In addition, the processor 111 may perform various functions by executing computer executable instructions stored in the memory 113.

The projection part 112 is a component that projects an image to the outside. The projection part 112 according to the one or more embodiments of the disclosure may be implemented in various projection types (e.g., a cathode-ray tube (CRT) type, a liquid crystal display (LCD) type, a digital light processing (DLP) type, a laser type, etc.). As an example, the CRT method has basically the same principle as a CRT monitor. In the CRT method, an image is enlarged to a lens in front of a cathode-ray tube (CRT), and the image is displayed on a screen. According to the number of cathode-ray tubes, the CRT method is divided into an one-tube method and a three-tube method, and in the case of the three-tube method, the method may be implemented while cathode-ray tubes of red, green, and blue colors are separated from one another.

As another example, the LCD method is a method of displaying an image by making a light output from a light source pass through a liquid crystal display. The LCD method is divided into a single-plate method and a three-plate method, and in the case of the three-plate method, a light output from a light source may be divided into red, green, and blue colors in a dichroic mirror (a mirror that reflects only lights of specific colors, and makes the rest pass through), and pass through a liquid crystal display, and then the lights may be gathered in one place.

As still another example, the DLP method is a method of displaying an image by using a digital micromirror device (DMD) chip. A projection part by the DLP method may include a light source, a color wheel, a DMD chip, a projection lens, etc. A light output from the light source may show a color as it passes through the rotating color wheel. The light that passed through the color wheel is input into the DMD chip. The DMD chip includes numerous micromirrors, and reflects the light input into the DMD chip. The projection lens may perform a role of enlarging the light reflected from the DMD chip to an image size.

As still another example, the laser method includes a diode pumped solid state (DPSS) laser and a galvanometer. As lasers outputting various colors, lasers wherein three DPSS lasers are installed for each of R, G, and B colors, and then their optical axes are overlapped by using a special mirror are used. The galvanometer includes a mirror and a motor of a high output, and moves the mirror at a fast speed. For example, the galvanometer may rotate the mirror at 40 KHz/sec at the maximum. The galvanometer is mounted according to a scanning direction, and in general, a projector performs plane scanning, and thus the galvanometer may also be arranged while being divided into x and y axes.

The projection part 112 may include light sources of various types. For example, the projection part 112 may include at least one light source among a lamp, light emitting diodes (LEDs), and a laser.

The projection part 112 may output an image in a screen ratio of 4:3, a screen ratio of 5:4, and a wide screen ratio of 16:9 according to the use of the electronic device 100 or the user's setting, etc., and output an image in various resolutions such as WVGA (854*480), SVGA (800*600), XGA (1024*768), WXGA (1280*720), WXGA (1280*800), SXGA (1280*1024), UXGA (1600*1200), Full HD (1920*1080), etc. according to screen ratios.

The projection part 112 may perform various functions for adjusting an output image by control by the processor 111. For example, the projection part 112 may perform functions such as zoom, keystone, quick corner (four corner) keystone, lens shift, etc.

For example, the projection part 112 may enlarge or reduce an image according to its distance (i.e., a projection distance) to the screen. That is, a zoom function may be performed according to the distance to the screen. Here, the zoom function may include a hardware method of adjusting a screen size by moving a lens, and a software method of adjusting the screen size by cropping an image, or the like. When the zoom function is performed, it is necessary to adjust a focus of an image. For example, a method of adjusting a focus includes a manual focusing method, an electric focusing method, etc. The manual focusing method may be a method of manually adjusting the focus, and the electric focusing method may be a method in which a projector automatically adjusts the focus by using a built-in motor when the zoom function is performed. When performing the zoom function, the projection part 112 may provide a digital zoom function through software, and may provide an optical zoom function in which the zoom function is performed by moving the lens through the driver 120.

In addition, the projection part 112 may perform a keystone correction function. When a height does not match a front projection, the screen may be distorted up or down. The keystone correction function may be a function of correcting a distorted screen. For example, when a distortion of an image occurs in a left-right direction of the screen, the screen may be corrected by using a horizontal keystone, and when a distortion of an image occurs in an up-down direction, the screen may be corrected by using a vertical keystone. The quick corner (four corner) keystone correction function is a function of correcting a screen in case the central area of the screen is normal but the corner areas are out of balance. The lens shift function is a function of moving a screen as it is in case the screen is outside a screen area.

The projection part 112 may provide the zoom/keystone/focusing functions by automatically analyzing a surrounding environment and a projection environment without a user input. For example, the projection part 112 may automatically provide the zoom/keystone/focusing functions based on the distance between the electronic device 100 and the screen, information about a space where the electronic device 100 is currently positioned, information about an amount of ambient light, etc. detected through a sensor (e.g., a depth camera, a distance sensor, an infrared sensor, an illumination sensor, etc.).

Also, the projection part 112 may provide an illumination function by using a light source. In particular, the projection part 112 may provide the illumination function by outputting a light source by using LEDs. According to one or more embodiments, the projection part 112 may include one LED. According to another embodiment, the electronic device 100 may include a plurality of LEDs. The projection part 112 may output a light source by using a surface emitting LED depending on implementation examples. Here, a surface emitting LED may be an LED having a structure wherein an optical sheet is arranged on the upper side of the LED such that a light source is evenly dispersed and output. For example, when a light source is output through an LED, the light source may be evenly dispersed through an optical sheet, and the light source dispersed through the optical sheet may be incident on a display panel.

The projection part 112 may provide a dimming function for adjusting the intensity of a light source to the user. For example, when a user input for adjusting the intensity of a light source is received from the user through the manipulation interface 115 (e.g., a touch display button or a dial), the projection part 112 may control the LED to output the intensity of the light source that corresponds to the received user input.

In addition, the projection part 112 may provide the dimming function based on a content analyzed by the processor 111 without a user input. In addition, the projection part 112 may control the LED to output the intensity of a light source based on information on a content that is currently provided (e.g., the content type, the content brightness, etc.).

The projection part 112 may control a color temperature by control by the processor 111. Here, the processor 111 may control a color temperature based on a content. For example, when it is identified that a content is to be output, the processor 111 may obtain color information for each frame of the content of which output has been determined. Then, the processor 111 may control the color temperature based on the obtained color information for each frame. Here, the processor 111 may obtain at least one main color of the frame based on the color information for each frame. Then, the processor 111 may adjust the color temperature based on the obtained at least one main color. For example, the color temperature that the processor 111 may adjust may be divided into a warm type or a cold type. Here, it is assumed that a frame to be output (referred to as an output frame hereinafter) includes a scene wherein fire broke out. The processor 111 may identify (or obtain) that the main color is red based on the color information included in the current output frame. Then, the processor 111 may identify the color temperature corresponding to the identified main color (red). Here, the color temperature corresponding to the red color may be the warm type. The processor 111 may use an artificial intelligence model to obtain the color information or the main color of a frame. According to one or more embodiments, the artificial intelligence model may be stored in the electronic device 100 (e.g., the memory 113). According to one or more other embodiments, the artificial intelligence model may be stored in an external server that can communicate with the electronic device 100.

The memory 113 may store at least one content (the first content 11, the second content 12, etc.), a control signal, a control command, or setting information related to the projection function of the projection part 112, etc.

The memory 113 may be implemented as internal memory such as ROM (e.g., electrically erasable programmable read-only memory (EEPROM)), RAM, etc., included in the processor 111, or implemented as separate memory from the processor 111. In this case, the memory 113 may be implemented in the form of memory embedded in the electronic device 100, or implemented in the form of memory that may be attached to or detached from the electronic device 100 according to the use of stored data. For example, in the case of data for driving the electronic device 100, the data may be stored in memory embedded in the electronic device 100, and in the case of data for an extended function of the electronic device 100, the data may be stored in memory that may be attached to or detached from the electronic device 100.

In the case of memory embedded in the electronic device 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that may be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that may be connected to a USB port (e.g., a USB memory), etc.

The memory 113 may store at least one instruction related to the electronic device 100. Also, the memory 113 may store an operating system (O/S) for driving the electronic device 100. In addition, the memory 113 may store various types of software programs or applications for the electronic device 100 to operate according to the one or more embodiments of the disclosure. Further, the memory 113 may include semiconductor memory such as flash memory, etc., or a magnetic storage medium such as a hard disk, etc.

For example, the memory 113 may store various types of software modules for the electronic device 100 to operate according to the one or more embodiments of the disclosure, and the processor 111 may control the operations of the electronic device 100 by executing the various types of software modules stored in the memory 113. That is, the memory 113 may be accessed by the processor 111, and reading/recording/correction/deletion/update, etc. of data by the processor 111 may be performed.

According to one or more embodiments, memory 113 may include a storage, ROM and RAM inside the processor 111, or a memory card (e.g., a micro SD card, a memory stick) mounted on the electronic device.

The communication interface 114 is a component that performs communication with various types of external devices according to various types of communication methods. The communication interface 114 may include a wireless communication module or a wired communication module. Here, each communication module may be implemented in a form of at least one hardware chip.

A wireless communication module may be a module that communicates with an external device wirelessly. For example, a wireless communication module may include at least one module among a Wi-Fi module, a Bluetooth module, an infrared communication module, or other communication modules.

A Wi-Fi module and a Bluetooth module may perform communication by a Wi-Fi method and a Bluetooth method, respectively. In the case of using a Wi-Fi module or a Bluetooth module, various types of connection information such as a service set identifier (SSID) and a session key, etc. is transmitted and received first, and connection of communication is performed by using the information, and various types of information may be transmitted and received thereafter.

An infrared communication module performs communication according to an infrared Data Association (IrDA) technology of transmitting data to a near field wirelessly by using infrared rays between visible rays and millimeter waves.

Other communication modules may include at least one communication chip that performs communication according to various wireless communication protocols such as Zigbee, 3rd Generation (3G), 3rd Generation Partnership Project (3GPP), Long Term Evolution (LTE), LTE Advanced (LTE-A), 4th Generation (4G), 5th Generation (5G), etc. other than the aforementioned communication methods.

A wired communication module may be a module that communicates with an external device via wire. For example, a wired communication module may include at least one of a local area network (LAN) module, an Ethernet module, a pair cable, a coaxial cable, an optical fiber cable, or an ultra wide-band (UWB) module.

The manipulation interface 115 may include various types of input devices. For example, the manipulation interface 115 may include physical buttons. Here, the physical buttons may include function keys, direction keys (e.g., four-direction keys), or dial buttons. According to one or more embodiments, the physical buttons may be implemented as a plurality of keys. According to one or more other embodiments, the physical buttons may be implemented as one key. Here, in case the physical buttons are implemented as one key, the electronic device 100 may receive a user input by which the one key is pressed during a threshold time or longer. When a user input by which the one key is pressed during the threshold time or longer is received, the processor 111 may perform a function corresponding to the user input. For example, the processor 111 may provide the illumination function based on the user input.

Also, the manipulation interface 115 may receive a user input by using a non-contact method. In the case of receiving a user input through a contact method, a physical force should be transmitted to the electronic device 100. Accordingly, a method for controlling the electronic device 100 may be needed regardless of the physical force. For example, the manipulation interface 115 may receive a user gesture, and perform an operation corresponding to the received user gesture. Here, the manipulation interface 115 may receive the user gesture through a sensor (e.g., an image sensor or an infrared sensor).

In addition, the manipulation interface 115 may receive a user input by using a touch method. For example, the manipulation interface 115 may receive a user input through a touch sensor. According to one or more embodiments, the touch method may be implemented as the non-contact method. For example, the touch sensor may determine whether a user body approached within a threshold distance. Here, the touch sensor may identify a user input even when the user does not touch the touch sensor. According to another implementation example, the touch sensor may identify a user input by which the user touches the touch sensor.

The electronic device 100 may receive a user input in various ways other than the manipulation interface 115 described above. According to one or more embodiments, the electronic device 100 may receive a user input through an external remote control device. Here, the external remote control device may be a remote control device corresponding to the electronic device 100 (e.g., a control device dedicated to the electronic device 100) or a portable communication device (e.g., a smartphone or a wearable device) of the user. Here, the portable communication device of the user may store an application for controlling the electronic device 100. The portable communication device may obtain a user input through the application stored therein, and transmit the obtained user input to the electronic device 100. The electronic device 100 may receive the user input from the portable communication device, and perform an operation corresponding to the user's control command.

The electronic device 100 may receive a user input by using voice recognition. According to one or more embodiments, the electronic device 100 may receive a user voice through the microphone included in the electronic device 100. According to one or more other embodiments, the electronic device 100 may receive a user voice from the microphone or an external device. For example, the external device may obtain a user voice through the microphone of the external device, and transmit the obtained user voice to the electronic device 100. The user voice transmitted from the external device may be audio data or digital data converted from audio data (e.g., audio data converted into a frequency domain, etc.). Here, the electronic device 100 may perform an operation corresponding to the received user voice. For example, the electronic device 100 may receive audio data corresponding to the user voice through the microphone. The electronic device 100 may then convert the received audio data into digital data. The electronic device 100 may then convert the converted digital data into text data by using a speech-to-text (STT) function. According to one or more embodiments, the speech-to-text (STT) function may be directly performed in the electronic device 100.

According to one or more other embodiments, the speech-to-text (STT) function may be performed in an external server. The electronic device 100 may transmit digital data to the external server. The external server may convert the digital data into text data, and obtain control command data based on the converted text data. The external server may transmit the control command data (which may here also include the text data) to the electronic device 100. The electronic device 100 may perform an operation corresponding to the user voice based on the obtained control command data.

The electronic device 100 may provide a voice recognition function by using one assistance (or an artificial intelligence agent), but this is merely one of various examples, and the electronic device 100 may provide the voice recognition function through a plurality of assistances. Here, the electronic device 100 may provide the voice recognition function by selecting one of the plurality of assistances based on a trigger word corresponding to the assistance or a specific key included in a remote controller.

The electronic device 100 may receive a user input by using a screen interaction. A screen interaction may be a function in which the electronic device 100 identifies whether a predetermined event is generated through an image projected on a screen (or a projection surface), and obtains a user input based on the predetermined event. Here, the predetermined event may be an event in which a predetermined object is identified in a specific position (e.g., a position on which a UI for receiving a user input is projected). Here, the predetermined object may include at least one of the user's body part (e.g., a finger), a pointer, or a laser point. When the predetermined object is identified in the position corresponding to the projected UI, the electronic device 100 may identify that a user input for selecting the projected UI was received. For example, the electronic device 100 may project a guide image such that a UI is displayed on the screen. The electronic device 100 may then identify whether the user selects the projected UI. For example, when the predetermined event is identified in the position of the projected UI, the electronic device 100 may identify that the user selected the projected UI. Here, the projected UI may include at least one item. Here, the electronic device 100 may perform spatial analysis to identify whether the predetermined event exists in the position of the projected UI. Here, the electronic device 100 may perform the spatial analysis through the sensor (e.g., an image sensor, an infrared sensor, a depth camera, a distance sensor, etc.). The electronic device 100 may identify whether the predetermined event is generated in the specific position (the position on which the UI is projected) by performing the spatial analysis. Then, when it is identified that the predetermined event is generated in the specific position (the position on which the UI is projected), the electronic device 100 may identify that a user input for selecting the UI corresponding to the specific position was received.

The input/output interface 116 is a component for inputting or outputting at least one of an audio signal or an image signal. The input/output interface 116 may receive at least one of an audio signal or an image signal from an external device, and output a control command to the external device.

Depending on implementation examples, the input/output interface 116 may be implemented as an interface inputting or outputting only audio signals and an interface inputting or outputting only image signals, or implemented as one interface inputting or outputting both audio signals and image signals.

The input/output interface 116 according to one or more embodiments of the disclosure may be implemented as a wired input/output interface of at least one of a high definition multimedia interface (HDMI), a mobile high-definition link (MHL), a universal serial bus (USB), a USB C-type, a display port (DP), a Thunderbolt, a video graphics array (VGA) port, a red-green-blue (RGB) port, a D-subminiature (D-SUB) or a digital visual interface (DVI). According to one or more embodiments, the wired input/output interface may be implemented as an interface inputting or outputting only audio signals and an interface inputting or outputting only image signals, or implemented as one interface inputting or outputting both audio signals and image signals.

In addition, the electronic device 100 may receive data through the wired input/output interface, but this is merely one of various examples, and the electronic device 100 may receive power through the wired input/output interface. For example, the electronic device 100 may receive power from an external battery through a USB C-type, or receive power from an outlet through a power adapter. As another example, the electronic device 100 may receive power from an external device (e.g., a laptop computer or a monitor, etc.) through a display port (DP).

The electronic device 100 may be implemented such that an audio signal is input through the wired input/output interface, and an image signal is input through a wireless input/output interface (or the communication interface). However, embodiments are not limited thereto, and for example, the electronic device 100 may be implemented such that an audio signal is input through a wireless input/output interface (or the communication interface), and an image signal is input through the wired input/output interface.

The speaker 117 is a component that outputs audio signals. In particular, the speaker 117 may include an audio output mixer, an audio signal processor, and an audio output module. The audio output mixer may mix a plurality of audio signals to be output as at least one audio signal. For example, the audio output mixer may mix an analog audio signal and another analog audio signal (e.g., an analog audio signal received from the outside) as at least one analog audio signal. The audio output module may include a speaker or an output terminal. According to one or more embodiments, the audio output module may include a plurality of speakers, and in this case, the audio output module may be disposed inside the main body, and audio emitted while covering at least a portion of a diaphragm of the audio output module may pass through a waveguide to be transmitted to the outside of the main body. The audio output module may include a plurality of audio output units, and the plurality of audio output units may be symmetrically disposed on the exterior of the main body, and accordingly, audio may be emitted to all directions, i.e., all directions in 360 degrees.

The microphone 118 is a component for receiving input of a user voice or other sounds, and converting them into audio data. The microphone 118 may receive a voice of a user in an activated state. For example, the microphone 118 may be formed as an integrated type on the upper side or the front surface direction, the side surface direction, etc. of the electronic device 100. The microphone 118 may include various components such as a microphone collecting a user voice in an analogue form, an amp circuit amplifying the collected user voice, an A/D conversion circuit that samples the amplified user voice and converts the user voice into a digital signal, a filter circuit that removes noise components from the converted digital signal, etc.

The power part 119 may receive power from the outside and supply power to the various components of the electronic device 100. The power part 119 according to the one or more embodiments of the disclosure may receive power in various ways. According to one or more embodiments, the power part 119 may receive power by using the connector 130 as illustrated in FIG. 1. In addition, the power part 119 may receive power by using a direct current (DC) power cord of 220V. However, the disclosure is not limited thereto, and the electronic device 100 may receive power by using a USB power cord, or may receive power by using a wireless charging method.

In addition, the power part 119 may receive power by using an internal battery or an external battery. The power part 119 according to the one or more embodiments of the disclosure may receive power through the internal battery. For example, the power part 119 may charge power of the internal battery by using at least one of a DC power cord of 220V, a USB power cord, or a USB C-Type power cord, and may receive power through the charged internal battery. Also, the power part 119 according to the one or more embodiments of the disclosure may receive power through the external battery. For example, the power part 119 may receive power through the external battery in case connection between the electronic device 100 and the external battery is performed through various wired communication methods such as the USB power code, the USB C-type power code, or a socket groove, etc. That is, the power part 119 may directly receive power from the external battery, or charge the internal battery through the external battery and receive power from the charged internal battery.

The power part 119 according to the disclosure may receive power by using at least one of the aforementioned plurality of power supply methods.

With respect to power consumption, the electronic device 100 may have power consumption of a predetermined value (e.g., 43 W) or less due to the socket type, other standards, etc. Here, the electronic device 100 may vary power consumption to reduce the power consumption when using the battery. That is, the electronic device 100 may vary power consumption based on the power supply method, the power usage amount, or the like.

The driver 120 may drive at least one hardware component included in the electronic device 100. The driver 120 may generate physical force, and transmit the force to at least one hardware component included in the electronic device 100.

Here, the driver 120 may generate driving power for a moving operation of a hardware component included in the electronic device 100 (e.g., moving of the electronic device 100) or a rotating operation of a component (e.g., rotation of the projection lens).

The driver 120 may adjust a projection direction (or a projection angle) of the projection part 122. Also, the driver 120 may move the position of the electronic device 100. Here, the driver 120 may control the moving element 109 for moving the electronic device 100. For example, the driver 120 may control the moving element 109 by using the motor.

The sensor part 121 may include at least one sensor. For example, the sensor part 121 may include at least one of a tilt senor that senses the tilt of the electronic device 100 or an image sensor that captures an image. Here, the tilt sensor may be an acceleration sensor or a gyro sensor, and the image sensor may be a camera or a depth camera. The tilt sensor may also be described as a motion sensor. Also, the sensor part 121 may include various sensors other than a tilt sensor or an image sensor. For example, the sensor part 121 may include an illumination sensor or a distance sensor. The distance sensor may be a Time of Flight (ToF) sensor. Also, the sensor part 121 may include a LiDAR sensor.

The electronic device 100 may control the illumination function by being interlocked with an external device. For example, the electronic device 100 may receive illumination information from an external device. Here, the illumination information may include at least one of brightness information or color temperature information set in the external device. Here, the external device may be a device connected to the same network as the electronic device 100 (e.g., an IoT device included in the same home/company network) or a device that is not connected to the same network as the electronic device 100 but can communicate with the electronic device 100 (e.g., a remote control server). For example, it is assumed that an external illumination device (an IoT device) included in the same network as the electronic device 100 is outputting a red lighting at the brightness of 50. The external illumination device (an IoT device) may directly or indirectly transmit illumination information (e.g., information that the red lighting is being output at the brightness of 50) to the electronic device 100. Here, the electronic device 100 may control an output of a light source based on the illumination information received from the external illumination device. For example, when the illumination information received from the external illumination device includes information that the red lighting is being output at the brightness of 50, the electronic device 100 may output the red lighting at the brightness of 50.

The electronic device 100 may control the illumination function based on biometric information. For example, the processor 111 may obtain the biometric information of the user. Here, the biometric information may include at least one of the body temperature, the heart rate, the blood pressure, the breathing, or the electrocardiogram of the user. Here, the biometric information may include various kinds of information other than the aforementioned information. As an example, the electronic device 100 may include a sensor for measuring biometric information. The processor 111 may obtain the biometric information of the user through the sensor, and control an output of a light source based on the obtained biometric information. As another example, the processor 111 may receive biometric information from an external device through the input/output interface 116. Here, the external device may be a portable communication device (e.g., a smartphone or a wearable device) of the user. The processor 111 may obtain the biometric information of the user from the external device, and control an output of a light source based on the obtained biometric information. Depending on implementation examples, the electronic device 100 may identify whether the user is sleeping, and when it is identified that the user is sleeping (or is preparing to sleep), the processor 111 may control an output of a light source based on the biometric information of the user.

The electronic device 100 according to the one or more embodiments of the disclosure may provide various smart functions.

For example, the electronic device 100 may be connected to a portable terminal device for controlling the electronic device 100, and the screen output from the electronic device 100 may be controlled through a user input that is input into the portable terminal device. For example, the portable terminal device may be implemented as a smartphone including a touch display, and the electronic device 100 may receive screen data provided by the portable terminal device from the portable terminal device and output the data, and the screen output from the electronic device 100 may be controlled according to a user input that is input into the portable terminal device.

The electronic device 100 may perform connection to the portable terminal device through various communication methods such as Miracast, Airplay, wireless Dalvik Executable (DEX) and a remote personal computer (PC) method, etc., and may share a content or music provided by the portable terminal device.

In addition, connection between the portable terminal device and the electronic device 100 may be performed by various connection methods. According to one or more embodiments, the portable terminal device may search for the electronic device 100 and perform wireless connection therebetween, or the electronic device 100 may search for the portable terminal device and perform wireless connection therebetween. The electronic device 100 may then output a content provided by the portable terminal device.

According to one or more embodiments, while a specific content or music is being output from the portable terminal device, when the portable terminal device is positioned around the electronic device 100 and then a predetermined gesture (e.g., a motion tap view) is detected through the display of the portable terminal device, the electronic device 100 may output the content or music that is being output from the portable terminal device.

According to one or more embodiments, while a specific content or music is being output from the portable terminal device, when the portable terminal device becomes close to the electronic device 100 by a predetermined distance or less (e.g., a non-contact tap view), or the portable terminal device touches the electronic device 100 twice at short intervals (e.g., a contact tap view), the electronic device 100 may output the content or music that is being output from the portable terminal device.

In the aforementioned embodiment, it was described that a screen identical to the screen that is being provided on the portable terminal device is provided on the electronic device 100, but embodiments are not limited thereto. When connection between the portable terminal device and the electronic device 100 is established, a first screen provided by the portable terminal device may be output on the portable terminal device, and a second screen provided by the portable terminal device, which is different from the first screen, may be output on the electronic device 100. As an example, the first screen may be a screen provided by a first application installed in the portable terminal device, and the second screen may be a screen provided by a second application installed in the portable terminal device. For example, the first screen and the second screen may be screens different from each other that are provided by one application installed in the portable terminal device. In addition, for example, the first screen may be a screen including a UI in a remote controller form for controlling the second screen.

The electronic device 100 according one or more embodiments may output a standby screen. For example, the electronic device 100 may output a standby screen in case connection between the electronic device 100 and an external device was not performed or there was no input received from an external device during a predetermined time. A condition for the electronic device 100 to output a standby screen is not limited to the above-described example, and a standby screen may be output by various conditions.

The electronic device 100 may output a standby screen in the form of a blue screen, but the disclosure is not limited thereto. For example, the electronic device 100 may obtain an atypical object by extracting only the shape of a specific object from data received from an external device, and output a standby screen including the obtained atypical object.

The electronic device 100 may further include a display (not shown).

The display may be implemented as displays in various forms such as a liquid crystal display (LCD), an organic light emitting diodes (OLED) display, a plasma display panel (PDP), etc. Inside the display, driving circuits that may be implemented in forms such as an amorphous silicon thin film transistor (a-si TFT), a low temperature poly silicon (LTPS) TFT, an organic TFT (OTFT), etc., and a backlight unit, etc. may also be included. The display may be implemented as a touch screen combined with a touch sensor, a flexible display, a three-dimensional (3D) display, etc. Also, the display according to the one or more embodiments of the disclosure may include not only a display panel outputting images, but also a bezel housing the display panel. In particular, a bezel according to the one or more embodiments of the disclosure may include a touch sensor for detecting user interactions.

The electronic device 100 may further include a shutter part.

The shutter part may include at least one of a shutter, a fixing element, a rail, or a body.

Here, the shutter may block light output from the projection part 112. Here, the fixing element may fix the location of the shutter. Here, the rail may be a route through which the shutter and the fixing element are moved. Here, the body may be a component including the shutter and the fixing element.

FIG. 4 is a perspective view illustrating an exterior of the electronic device 100 according to one or more embodiments.

Referring to the embodiment 410 in FIG. 4, the electronic device 100 may include a support (or it is referred to as “a handle”) 108a.

The support 108a according to one or more embodiments may be a handle or a ring that is provided for the user to grip or move the electronic device 100. However, embodiments are not limited thereto, and for example, the support 108a may be a stand that supports the main body 105 while the main body 105 is laid sideways.

The support 108a may be connected in a hinge structure so as to be coupled to or separated from the outer circumferential surface of the main body 105, and may be selectively separated from or fixed to the outer circumferential surface of the main body 105 depending on the user's need. The number, shape, or disposition structure of the support 108a may be implemented in various ways without restriction. The support 108a may be built inside the main body 105, and taken out and used by the user depending on the user's need. However, embodiments are not limited thereto, and for example, the support 108a may be implemented as a separate accessory, and attached to or detached from the electronic device 100.

The support 108a may include a first support surface 108a-1 and a second support surface 108a-2. The first support surface 108a-1 may be a surface that faces the outward direction of the main body 105 while the support 108a is separated from the outer circumferential surface of the main body 105, and the second support surface 108a-2 may be a surface that faces the inward direction of the main body 105 while the support 108a is separated from the outer circumferential surface of the main body 105.

The first support surface 108a-1 may be developed from the lower portion to the upper portion of the main body 105 to be farther away from the main body 105, and the first support surface 108a-1 may have a flat or uniformly curved shape. The first support surface 108a-1 may support the main body 105 in case the electronic device 100 is held in such a manner that the outer side surface of the main body 105 is in contact with the bottom surface, i.e., in case the electronic device 100 is disposed in such a manner that the projection lens 101 is toward the front direction. In an embodiment in which the electronic device 100 includes two or more supports 108a, the head 103 and the projection angle of the projection lens 101 may be adjusted by adjusting the interval or hinge opening angle of the two supports 108a.

The second support surface 108a-2 may be a surface touched by the user or an external holding structure when the support 108a is supported by the user or an external holding structure, and may have a shape corresponding to a gripping structure of the user's hand or the external holding structure such that the electronic device 100 does not slip in case the electronic device 100 is supported or moved. The user may move the electronic device 100 by making the projection lens 101 face toward the front direction, and fixing the head 103 and holding the support 108a, and use the electronic device 100 like a flashlight.

The support groove 104 is a groove structure which is provided in the main body 105 and accommodates the support 108a when the support 108a is not used, and it may be implemented as a groove structure corresponding to the shape of the support 108a on the outer circumferential surface of the main body 105. Through the support groove 104, the support 108a may be stored on the outer circumferential surface of the main body 105 when the support 108a is not used, and the outer circumferential surface of the main body 105 may be maintained to be slick.

However, embodiments are not limited thereto, and for example, the support 108a may be a structure that is stored inside the main body 105, and is taken out to the outside of the main body 105 in case the support 108a is needed. In this case, the support groove 104 may be a structure that is led inside the main body 105 to accommodate the support 108a, and the second support surface 108a-2 may include a door that adheres to the outer circumferential surface of the main body 105 or opens or closes the separate support groove 104.

The electronic device 100 may include various kinds of accessories that are helpful in using or storing the electronic device 100. For example, the electronic device 100 may include a protection case for the electronic device 100 to be more easily carried while being protected. However, embodiments are not limited thereto, and for example, the electronic device 100 may include a tripod that supports or fixes the main body 105, or a bracket that is coupled to the outer surface of the electronic device 100 and can fix the electronic device 100.

The embodiment 420 in FIG. 4 illustrates a state wherein the electronic device 100 in the embodiment 410 is held to be in contact with the bottom surface.

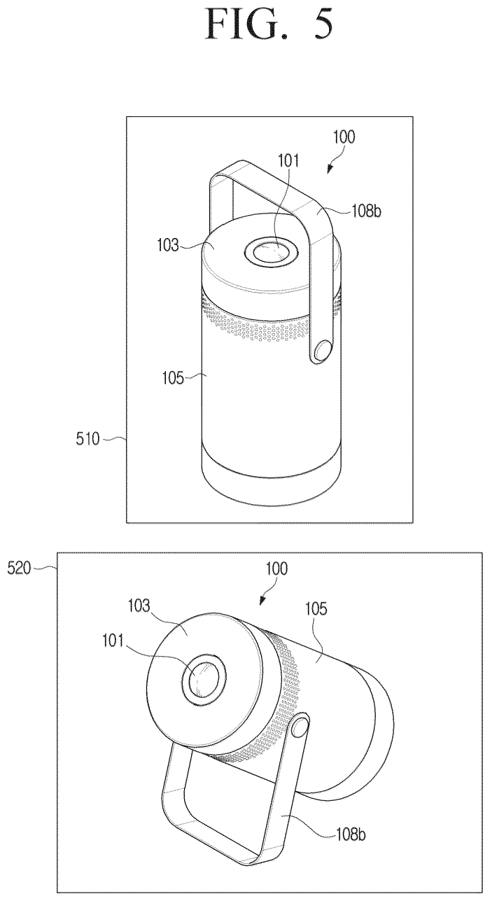

FIG. 5 is a perspective view illustrating an exterior of the electronic device 100 according to one or more embodiments.

Referring to the embodiment 510 in FIG. 5, the electronic device 100 may include a support (or it is referred to as “a handle”) 108b.

The support 108b according to one or more embodiments may be a handle or a ring that is provided for the user to grip or move the electronic device 100. However, embodiments are not limited thereto, and for example, the support 108b may be a stand that supports the main body 105 so as to be toward a certain angle while the main body 105 is laid sideways.

For example, the support 108b may be connected with the main body 105 on a predetermined point of the main body 105 (e.g., a ⅔-¾ point of the height of the main body). When the support 108b rotates in the direction of the main body 105, the support 108b may support the main body 105 so as to be toward a certain angle while the main body 105 is laid sideways.

The embodiment 520 in FIG. 5 illustrates a state wherein the electronic device 100 in the embodiment 510 is held to be in contact with the bottom surface.

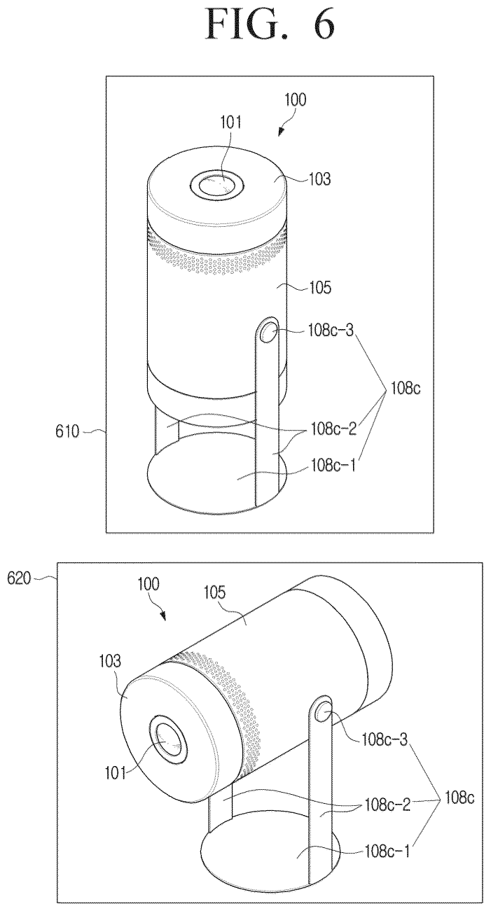

FIG. 6 is a perspective view illustrating an exterior of the electronic device 100 according to one or more embodiments.

Referring to the embodiment 610 in FIG. 6, the electronic device 100 may include a support (or it is referred to as “a prop”) 108c.

The support 108c according to one or more embodiments may include a base plate 108c-1 that is provided to support the electronic device 100 on the ground surface and two support elements 108c-2. Here, the two support elements 108c-2 may connect the base plate 108c-1 and the main body 105.

According to the one or more embodiments of the disclosure, the heights of the two support elements 108c-2 are identical, and each one cross-section of the two support elements 108c-2 may be coupled to or separated from a groove provided on one outer circumferential surface of the main body 105 by a hinge element 108c-3.

The two support elements may be hinge-coupled to the main body 105 on a predetermined point of the main body 105 (e.g., a ⅓- 2/4 point of the height of the main body).

When the two support elements 108c-2 and the main body 105 are coupled by the hinge elements 108c-3, the main body 105 may rotate based on a virtual horizontal axis formed by the two hinge elements 108c-3, and accordingly, the projection angle of the projection lens 101 may be adjusted.

The embodiment 620 in FIG. 6 illustrates a state wherein the electronic device 100 in the embodiment 610 rotated.

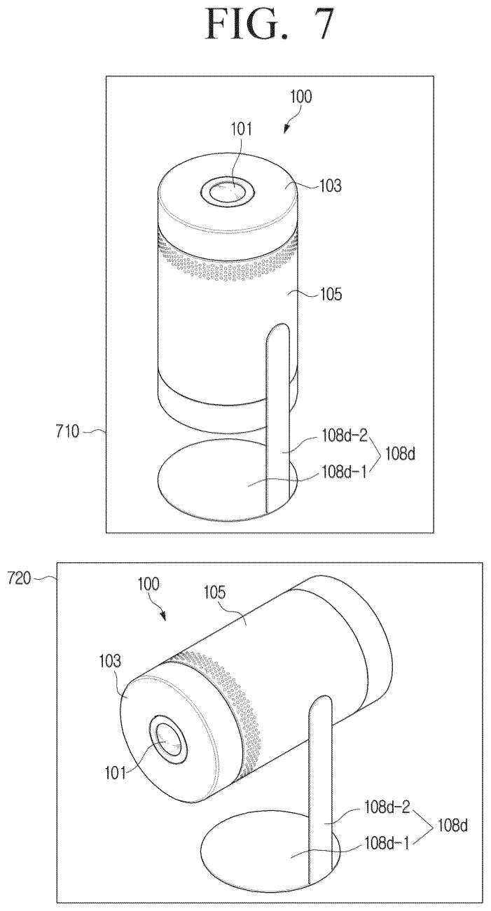

In FIG. 6, an embodiment wherein the two support elements 108c-2 are connected with the main body 105 is illustrated. However, the disclosure is not limited thereto, and one support element and the main body 105 may be connected by one hinge element as in FIG. 7.

FIG. 7 is a perspective view illustrating an exterior of the electronic device 100 according to one or more embodiments.

Referring to the embodiment 710 in FIG. 7, the electronic device 100 may include a support (or it is referred to as “a prop”) 108d.

The support 108d according to one or more embodiments may include a base plate 108d-1 that is provided to support the electronic device 100 on the ground surface and one support element 108d-2 that connects the base plate 108d-1 and the main body 105.

Also, a cross-section of the one support element 108d-2 may be coupled to or separated from a groove provided on one outer circumferential surface of the main body 105 by a hinge element.

When the one support element 108d-2 and the main body 105 are coupled by the one hinge element, the main body 105 may rotate based on a virtual horizontal axis formed by the one hinge element.

The embodiment 720 in FIG. 7 illustrates a state wherein the electronic device 100 in the embodiment 710 rotated.

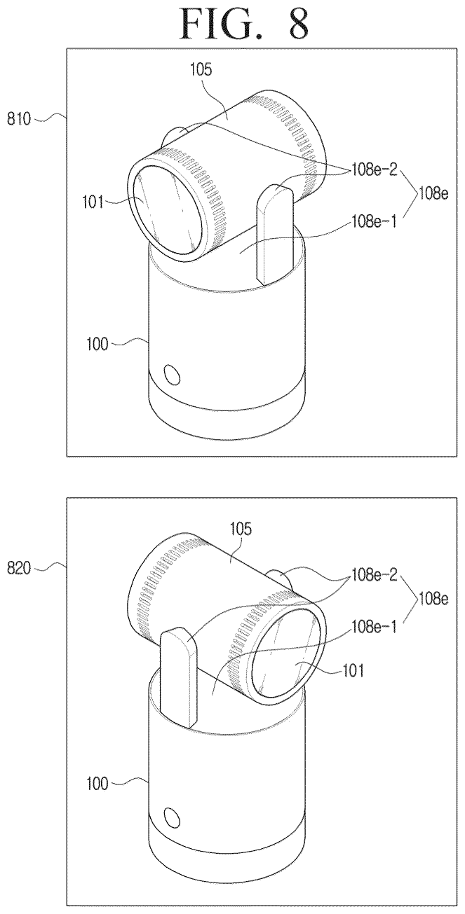

FIG. 8 is a perspective view illustrating an exterior of the electronic device 100 according to one or more embodiments.

Referring to the embodiment 810 in FIG. 8, the electronic device 100 may include a support (or it is referred to as “a prop”) 108e.

The support 108e according to one or more embodiments may include a base plate 108e-1 that is provided to support the electronic device 100 on the ground surface and two support elements 108e-2. Here, the two support elements 108e-2 may connect the base plate 108e-1 and the main body 105.

According to the one or more embodiments of the disclosure, the heights of the two support elements 108e-2 are identical, and each one cross-section of the two support elements 108e-2 may be coupled to or separated from a groove provided on one outer circumferential surface of the main body 105 by a hinge element.

The two support elements may be hinge-coupled to the main body 105 on a predetermined point of the main body 105 (e.g., a ⅓- 2/4 point of the height of the main body).

When the two support elements 108e-2 and the main body 105 are coupled by the hinge elements, the main body 105 may rotate based on a virtual horizontal axis formed by two hinge elements, and accordingly, the projection angle of the projection lens 101 may be adjusted.

The electronic device 100 may rotate the main body 105 including the projection lens 101. The main body 105 and the support 108e may be rotated based on a virtual vertical axis in the center point of the base plate 108e-1.

The embodiment 820 in FIG. 8 illustrates a state wherein the electronic device 100 in the embodiment 810 rotated.

The support illustrated in FIG. 4, FIG. 5, FIG. 6, FIG. 7, and FIG. 8 is merely one of various examples, and the electronic device 100 can obviously include a support in various locations and shapes.

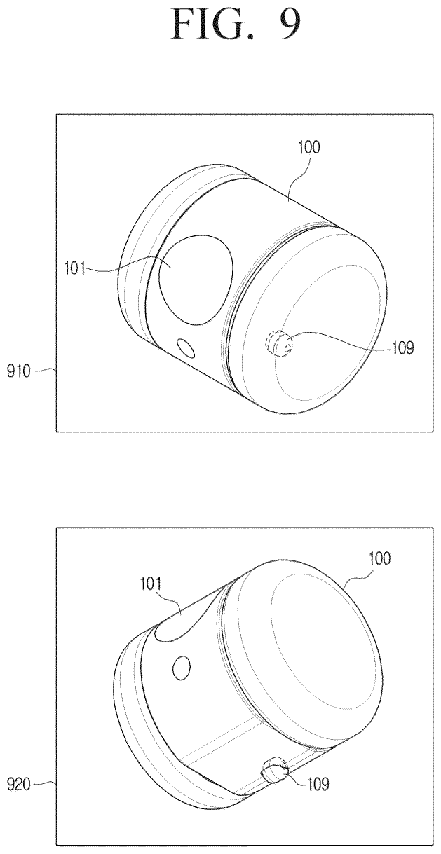

FIG. 9 is a perspective view illustrating an exterior of the electronic device 100 according to one or more embodiments.

Referring to the embodiment 910 in FIG. 9, the electronic device 100 may include a moving element 109. The moving element 109 may be an element for moving the electronic device 100 from the first position to the second position in the space wherein the electronic device 100 is disposed. The electronic device 100 may control the moving element 109 such that the electronic device 100 is moved by using force generated in the driver 120.

The embodiment 920 in FIG. 9 is a diagram that views the electronic device 100 in the embodiment 910 in a different direction.

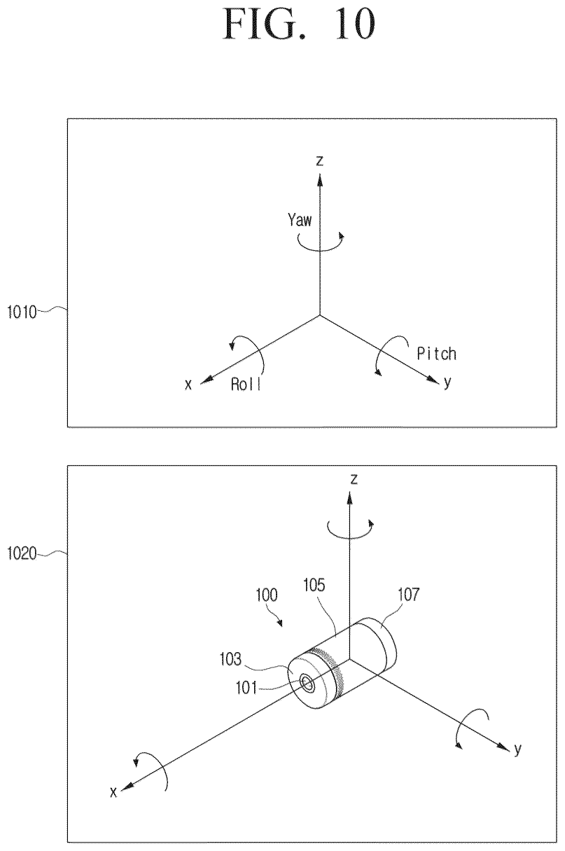

FIG. 10 is a diagram for illustrating rotation information of the electronic device 100.

The embodiment 1010 in FIG. 10 is a graph that defined rotating directions according to the x, y, and z axes. Rotating based on the x axis may be defined as a roll, and rotating based on the y axis may be defined as a pitch, and rotating based on the z axis may be defined as a yaw.

The embodiment 1020 in FIG. 10 may explain a rotating direction of the electronic device 100 as a rotating direction defined in the embodiment 1010. The x axis rotation information of the electronic device 100 may correspond to a roll of rotating based on the x axis of the electronic device 100. The y axis rotation information of the electronic device 100 may correspond to a pitch of rotating based on the y axis of the electronic device 100. The z axis rotation information of the electronic device 100 may correspond to a yaw of rotating based on the z axis of the electronic device 100.

The x axis rotation information may also be described as the first axis rotation information, the first axis tilt information, or horizontal warping information. In addition, the y axis rotation information may also be described as the second axis rotation information, the second axis tilt information, or vertical tilt information. Further, the z axis rotation information may also be described as the third axis rotation information, the third axis tilt information, or horizontal tilt information.

The sensor part 121 may obtain state information (or tilt information) of the electronic device 100. Here, the state information of the electronic device 100 may be a rotating state of the electronic device 100. Here, the sensor part 121 may include at least one of a gravity sensor, an acceleration sensor, or a gyro sensor. The x axis rotation information of the electronic device 100 and the y axis rotation information of the electronic device 100 may be determined based on sensing data obtained through the sensor part 121.

The z axis rotation information may be obtained based on how much the electronic device 100 was rotated according to a movement of the electronic device 100.

According to one or more embodiments, the z axis rotation information may indicate how much the electronic device 100 was rotated to the z axis during a predetermined time. For example, the z axis rotation information may indicate how much the electronic device 100 was rotated to the z axis on a second time point based on a first time point.

According to one or more embodiments, the z axis rotation information may indicate an angle between a virtual xz plane from which the electronic device 100 views the projection surface 10 and a virtual plane perpendicular to the projection surface 10. For example, in case the projection surface 10 and the electronic device 100 view each other in a front direction, the z axis rotation information may be 0 degree.

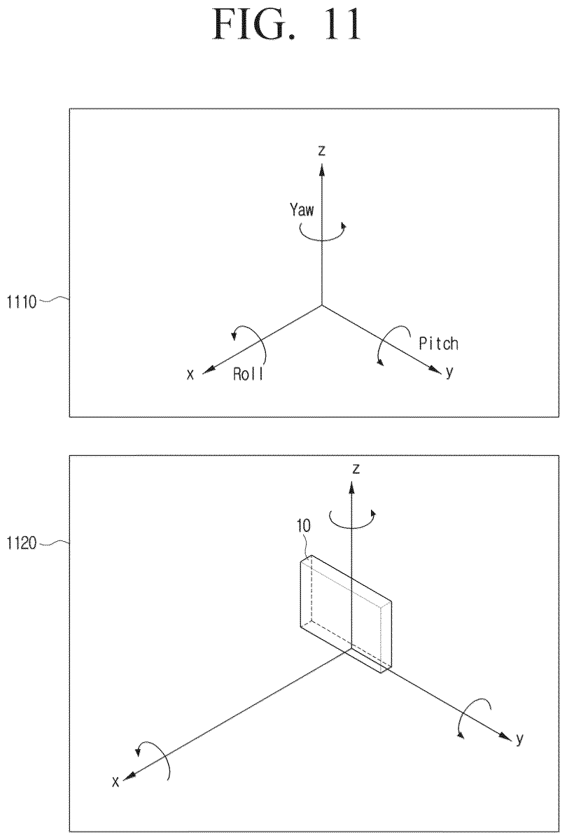

FIG. 11 is a diagram for illustrating rotation information of the projection surface 10.

The embodiment 1110 in FIG. 11 is a graph that defined rotating directions according to the x, y, and z axes. Rotating based on the x axis may be defined as a roll, and rotating based on the y axis may be defined as a pitch, and rotating based on the z axis may be defined as a yaw.

The embodiment 1120 in FIG. 11 may explain a rotating direction of the projection surface 10 as a rotating direction defined in the embodiment 1110. The x axis rotation information of the projection surface 10 may correspond to a roll of rotating based on the x axis of the projection surface 10. The y axis rotation information of the projection surface 10 may correspond to a pitch of rotating based on the y axis of the projection surface 10. The z axis rotation information of the projection surface 10 may correspond to a yaw of rotating based on the z axis of the projection surface 10.

The x axis rotation information may also be described as the first axis rotation information or the first axis tilt information. In addition, the y axis rotation information may also be described as the second axis rotation information or the second axis tilt information. Further, the z axis rotation information may also be described as the third axis rotation information or the third axis tilt information.

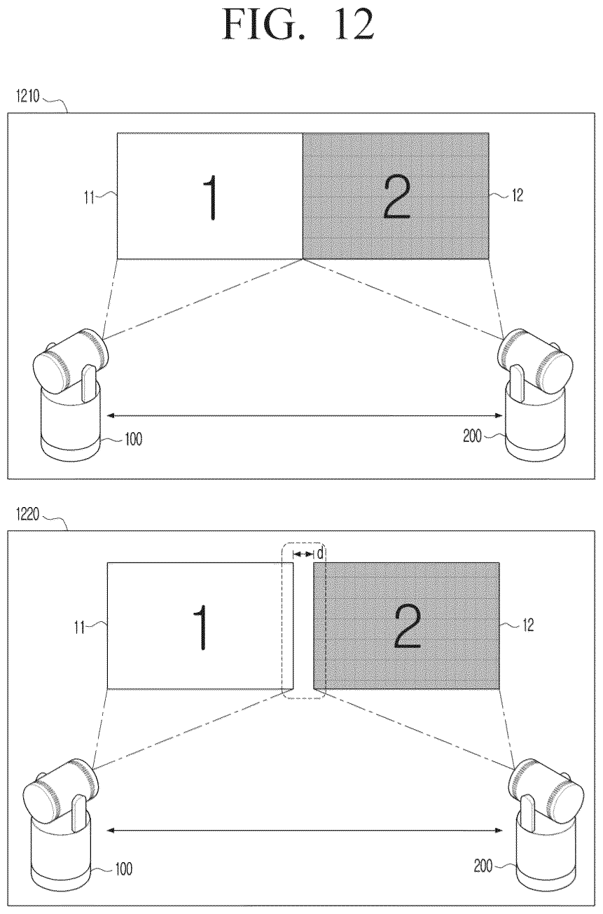

FIG. 12 is a diagram for illustrating an operation of controlling a horizontal projection interval between the first content 11 and the second content 12.

Referring to the embodiment 1210 in FIG. 12, the electronic device 100 may project the first content 11, and the external device 200 may output the second content 12. In this case, there may be no projection interval between the first content 11 and the second content 12. In case there is a big difference in luminance values between the first content 11 and the second content 12, the user may have inconvenience in multi-view viewing. Accordingly, the electronic device 100 may determine projection positions such that a projection interval exists on the projection surface 10 on which the first content 11 and the second content 12 are output.

Referring to the embodiment 1220 in FIG. 12, the electronic device 100 and the external device 200 may respectively project the first content 11 and the second content 12 such that a projection interval d between the first content 11 and the second content 12 exists.

Here, the electronic device 100 and the external device 200 may be communicatively connected with each other for performing the multi-view function.

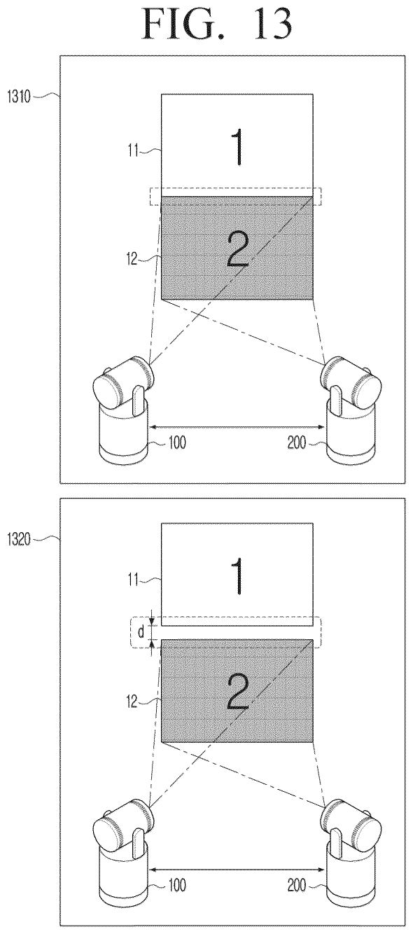

FIG. 13 is a diagram for illustrating an operation of controlling a vertical projection interval between the first content 11 and the second content 12.

Referring to the embodiment 1310 in FIG. 13, the first content 11 and the second content 12 may be projected in a vertical direction. Here, the first content 11 may be projected on the upper side or the lower side of the second content 12. As explained in FIG. 12, there may be no projection interval between the first content 11 and the second content 12.

Referring to the embodiment 1320 in FIG. 13, the electronic device 100 and the external device 200 may respectively project the first content 11 and the second content 12 such that a projection interval d between the first content 11 and the second content 12 exists. The reference numerals of the first content 11 and the second content 12 may be omitted.

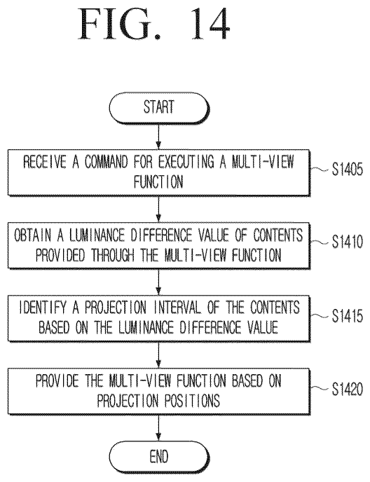

FIG. 14 is a flow chart for illustrating an operation of providing a multi-view function based on a luminance difference value according to one or more embodiments.

Referring to FIG. 14, the electronic device 100 may receive a command for performing a multi-view function in operation S1405. The electronic device 100 may obtain a luminance difference value of contents provided through the multi-view function in operation S1410. The electronic device 100 may identify a projection interval of the contents based on the luminance difference value in operation S1415. The electronic device 100 may provide the multi-view function based on the projection interval. For example, the electronic device 100 may control the electronic device 100 and the external device 200 to project contents based on the projection interval.

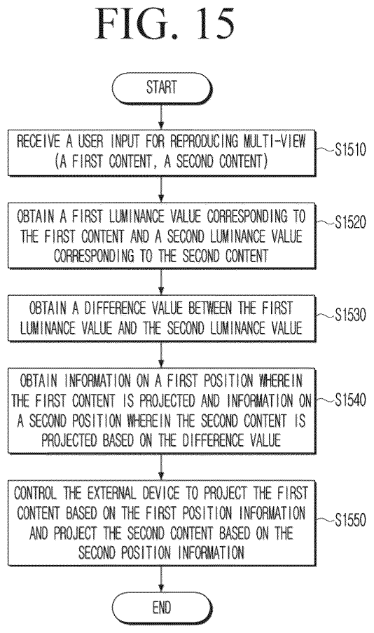

FIG. 15 is a flow chart for illustrating an operation of providing a multi-view function based on a luminance difference value according to one or more embodiments.

Referring to FIG. 15, the electronic device 100 may receive a user input for reproducing (or projecting) the first content 11 and the second content 12 corresponding to multi-view in operation S1510. The electronic device 100 may obtain a first luminance value corresponding to the first content 11 and a second luminance value corresponding to the second content 12 in operation S1520. The electronic device 100 may obtain a difference value between the first luminance value and the second luminance value in operation S1530. The electronic device 100 may obtain information on a first position wherein the first content 11 is projected and information on a second position wherein the second content 12 is projected based on the difference value in operation S1540. The electronic device 100 may control the projection part 112 to project the first content 11 based on the first position information, and control the external device 200 to project the second content 12 based on the second position information in operation S1550.

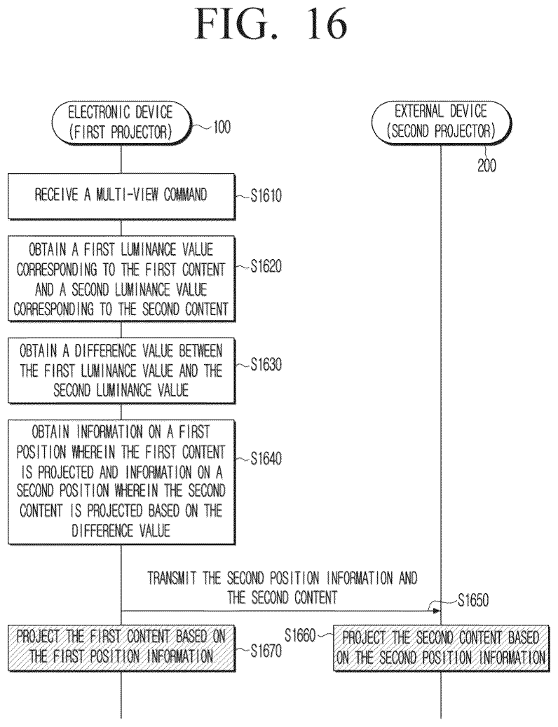

FIG. 16 is a flow chart for illustrating an operation of providing a multi-view function by using the electronic device 100 and the external device 200.

The operations S1610, S1620, S1630, and S1640 in FIG. 16 may correspond to the operations S1510, S1520, S1530, and S1540 in FIG. 15. Accordingly, overlapping explanation will be omitted.

After obtaining the first position information and the second position information, the electronic device 100 may transmit the second position information and the second content 12 to the external device 200 in operation S1650.

The external device 200 may receive the second position information and the second content 12 from the electronic device 100. The external device 200 may project the second content 12 based on the second position information in operation S1660.

Also, the electronic device 100 may project the first content 11 based on the first position information in operation S1670. Here, the first content 11 and the second content 12 may be projected simultaneously.

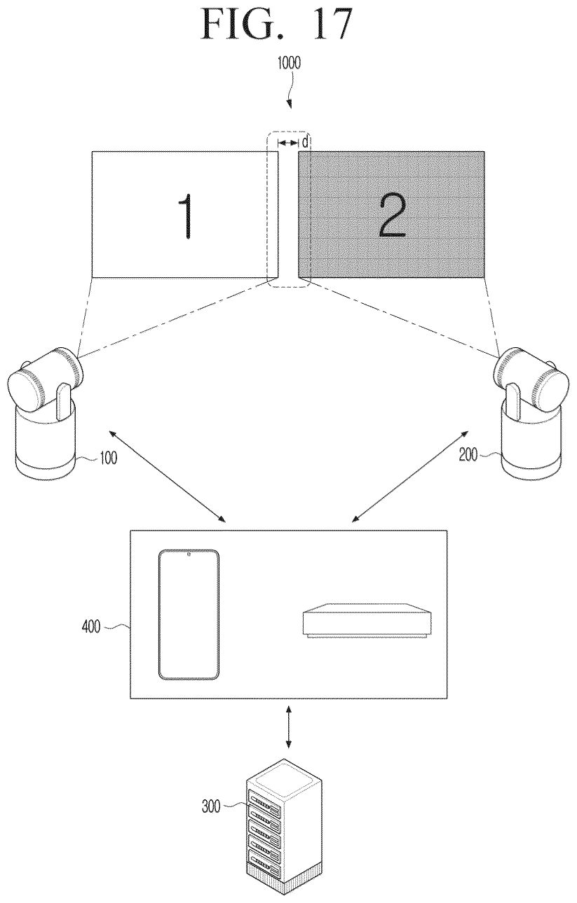

FIG. 17 is a diagram for illustrating an operation of providing a multi-view function by using the electronic device 100, the external device 200, and the server 300 according to one or more embodiments.

Referring to FIG. 17, the system 1000 may be the electronic device 100, the external device 200, the server 300, and the router 400. Here, the router 400 may be at least one of a user terminal device (e.g., a smartphone), a set-top box, or a router.

The electronic device 100 and the external device 200 may be communicatively connected. Here, the electronic device 100 and the external device 200 may transmit/receive information with each other through the router 400. The electronic device 100 may be connected with the server 300 as it is connected with the router 400. The external device 200 may be connected with the server 300 as it is connected with the router 400.

The router 400 may transmit information received from the electronic device 100 or the external device 200 to the server 300. Also, the router 400 may transmit information received from the server 300 to the electronic device 100 or the external device 200.

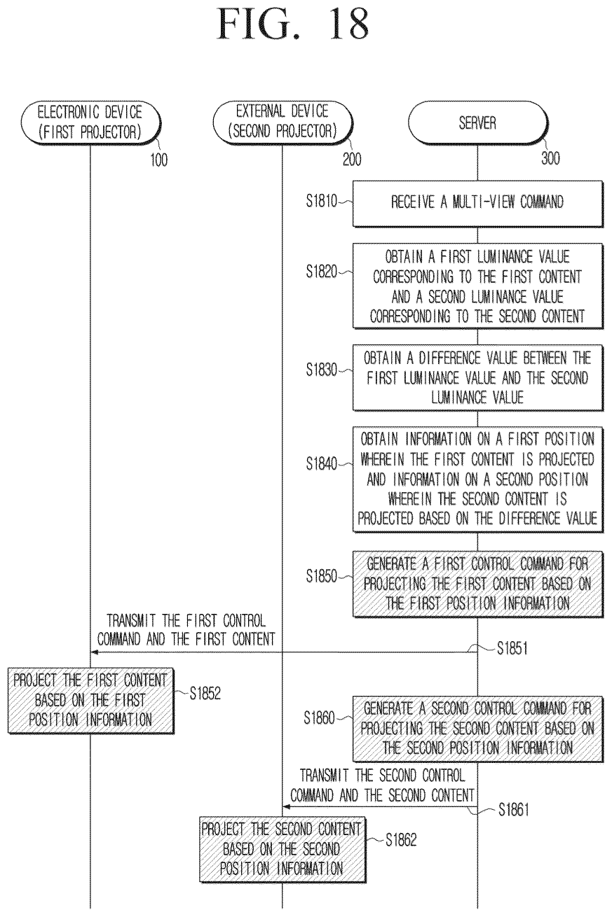

FIG. 18 is a flow chart for illustrating an operation of generating a control command in the server 300 for providing a multi-view function.

The operations S1810, S1820, S1830, and S1840 in FIG. 18 may correspond to the operations S1610, S1620, S1630, and S1640 in FIG. 16. Accordingly, overlapping explanation will be omitted. In FIG. 16, it was described that the operations are performed in the electronic device 100, but in FIG. 18, the operations may be performed by the server 300. The server 300 may store the first content 11 and the second content 12.

After both of the first position information and the second position information are obtained, the server 300 may generate a first control command for projecting the first content 11 based on the first position information in operation S1850. The server 300 may transmit the first control command and the first content 11 to the electronic device 100 in operation S1851.

The electronic device 100 may receive the first control command and the first content 11 from the server 300. The electronic device 100 may project the first content 11 based on the first position information in operation S1852.

The server 300 may generate a second control command for projecting the second content 12 based on the second position information in operation S1860. The server 300 may transmit the second control command and the second content 12 to the electronic device 100 in operation S1861.

The external device 200 may receive the second control command and the second content 12 from the server 300. The external device 200 may project the second content 12 based on the second position information in operation S1862.

FIG. 19 is a flow chart for illustrating an operation of obtaining position information by using a projection interval.

The operations S1910, S1920, and S1930 in FIG. 19 may correspond to the operations S1610, S1620, and S1630 in FIG. 16. Accordingly, overlapping explanation will be omitted.

After obtaining the first luminance value and the second luminance value, the electronic device 100 may obtain a projection interval of the first content 11 and the second content 12 based on the difference value in operation S1941.

Here, the electronic device 100 may transmit the second content 12 to the external device 200 in operation S1950.

The external device 200 may receive the second content 12 from the electronic device 100. Then, the external device 200 may project the second content 12 in operation S1960. Here, the external device 200 may project the second content 12 based on the setting that is currently applied to the external device 200.

The electronic device 100 may project the first content 11 based on the projection interval in operation S1970. The electronic device 100 may control the position wherein the first content 11 is projected such that the first content 11 and the second content 12 are projected to be distanced from each other by the projection interval.

FIG. 20 is a diagram for illustrating an operation of obtaining a luminance value based on metadata.

The embodiment 2010 in FIG. 20 may indicate the first metadata of the first content 11. The metadata may include at least one of the name, the type, the reproduction time, the basic luminance value, or the basic sound value. For example, the first metadata of the first content 11 may include at least one of the name (#A), the type (sport), the reproduction time (120 minutes), the basic luminance value (50), or the basic sound value (40).

Here, the basic luminance value may be an average luminance value of a content. The basic luminance value may be a value that indicates with a light source of which degree pixels output from a content should be output. The number 50 is a random number, and the number may be a percentage (%) indicating the relative strength of a light source. According to one or more embodiments, 50 may be cd/m\hat{ }2 or nit indicating a unit of a light source.

Here, the basic sound value may be an average sound value of a content. The basic sound value may indicate in strength of which degree audio output from a content should be output. The number 40 is a random number, and the number may be a percentage (%) indicating the relative strength of sound. According to one or more embodiments, 40 may be dB indicating the size of sound.

The embodiment 2020 in FIG. 20 may indicate the second metadata of the second content 12. For example, the second metadata of the second content 12 may include at least one of the name (#B), the type (a movie), the reproduction time (140 minutes), the basic luminance value (20), or the basic sound value (30).

According to the embodiments 2010 and 2020 in FIG. 20, it may be indicated that the first content 11 is a content having luminance that is brighter than that of the second content 12 on average.

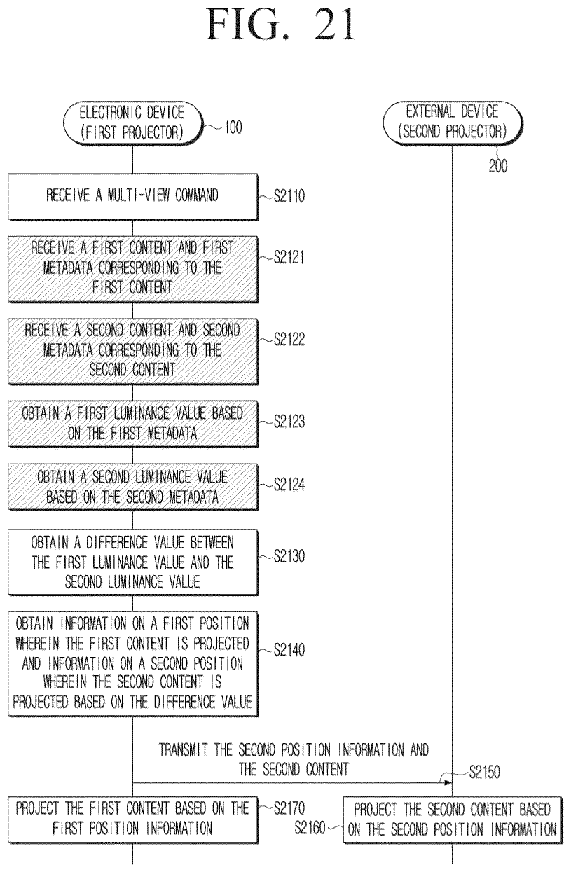

FIG. 21 is a flow chart for illustrating an operation of obtaining a luminance value based on metadata.

The operations S2110, S2130, S2140, S2150, S2160, and S2170 in FIG. 21 may correspond to the operations S1610, S1630, S1640, S1650, S1660, and S1670 in FIG. 16. Accordingly, overlapping explanation will be omitted.

After receiving a multi-view command, the electronic device 100 may obtain a first content 11 and first metadata corresponding to the first content 11 in operation S2121. The electronic device 100 may receive a second content 12 and second metadata corresponding to the second content 12 in operation S2122. Here, the electronic device 100 may receive the first metadata or the second metadata through the server 300 or the router 400.

Here, the electronic device 100 may obtain a first luminance value based on the first metadata in operation S2123. The electronic device 100 may obtain a second luminance value based on the second metadata in operation S2124.

After the first luminance value and the second luminance value are obtained, the operations S2130, S2140, S2150, S2160, and S2170 may be performed.

FIG. 22 is a diagram for illustrating an operation of obtaining a luminance value based on an average pixel value of frames.

The embodiment 2210 in FIG. 22 indicates a plurality of frames included in the first content 11. The electronic device 100 may analyze pixel values of the plurality of frames included in the first content 11, and obtain an average pixel value of the first content 11. The electronic device 100 may obtain a first luminance value corresponding to the first content 11 based on the average pixel value.

The embodiment 2220 in FIG. 22 indicates a plurality of frames included in the second content 12. The electronic device 100 may analyze pixel values of the plurality of frames included in the second content 12, and obtain an average pixel value of the second content 12. The electronic device 100 may obtain a second luminance value corresponding to the second content 12 based on the average pixel value.

FIG. 23 is a flow chart for illustrating an operation of obtaining a luminance value based on an average pixel value of frames.

Referring to FIG. 23, the operations S2310, S2330, S2340, S2350, S2360, and S2370 in FIG. 23 may correspond to the operations S1610, S1630, S1640, S1650, S1660, and S1670 in FIG. 16. Accordingly, overlapping explanation will be omitted.

After receiving a multi-view command, the electronic device 100 may receive a first content 11 and first metadata corresponding to the first content 11, and receive second metadata corresponding to the second content 12 in operation S2321.

The electronic device 100 may identify whether a first luminance value and a second luminance value were obtained based on the first metadata and the second metadata in operation S2322. When the first metadata and the second metadata are not obtained in operation S2322-N, the electronic device 100 may obtain the first luminance value based on an average pixel value of a plurality of frames included in the first content 11 in operation S2323. Also, the electronic device 100 may obtain the second luminance value based on an average pixel value of a plurality of frames included in the second content 12 in operation S2324. Then, the electronic device 100 may obtain a difference value between the first luminance value and the second luminance value in operation S2330.

When the first luminance value and the second luminance value are obtained based on the first metadata and the second metadata in operation S2322-Y, the electronic device 100 may perform the operations S2330, S2340, S2350, S2360, and S2370.

FIG. 24 is a diagram for illustrating an operation of obtaining a luminance value based on a captured image.

Referring to the embodiment 2410 in FIG. 24, the electronic device 100 may include a camera. Here, the camera may be a device that captures an ambient space of the electronic device 100. The electronic device 100 may obtain a captured image through the camera. The electronic device 100 may capture the projection surface 10 including the first content 11 or the second content 12.

Referring to the embodiment 2420 in FIG. 24, the electronic device 100 may analyze a captured image, and obtain a first luminance value corresponding to the first content 11 and a second luminance value corresponding to the second content 12. For example, the electronic device 100 may determine the first luminance value of the first content 11 that is currently projected as 70. Also, the electronic device 100 may determine the second luminance value of the second content 12 that is currently projected as 30. Here, the luminance values may be values that are obtained through an image analysis function.

FIG. 25 is a flow chart for illustrating an operation of obtaining a luminance value based on a captured image.

Referring to FIG. 25, the operations S2510, S2530, S2540, S2550, S2560, and S2570 in FIG. 25 may correspond to the operations S1610, S1630, S1640, S1650, S1660, and S1670 in FIG. 16. Also, the operations S2521 and S2522 in FIG. 25 may correspond to the operations S2321 and S2322 in FIG. 23. Accordingly, overlapping explanation will be omitted.

If the first metadata and the second metadata are not obtained in operation S2522-N, the electronic device 100 may obtain an image (or a captured image) including the first content 11 and the second content 12 in operation S2523. The electronic device 100 may obtain at least one of the first luminance value or the second luminance value based on the obtained image in operation S2524.

When the first luminance value and the second luminance value are obtained, the operations S2530, S2540, S2550, S2560, and S2570 may be performed.

FIG. 26 is a diagram for illustrating an operation of controlling a projection angle.

Referring to the embodiment 2610 in FIG. 26, the electronic device 100 may project the first content 11 based on a projection angle θ1, and the external device 200 may also project the second content 12 based on the projection angle θ1. Here, the distance between the electronic device 100 and the external device 200 may be a.

Referring to the embodiment 2620 in FIG. 26, the electronic device 100 may control a projection method such that there is a projection interval between the first content 11 and the second content 12. Here, the disposed locations of the electronic device 100 and the external device 200 may be fixed. For example, in the embodiment 2610, when the distance between the electronic device 100 and the external device 200 is a, the distance between the electronic device 100 and the external device 200 may also be a in the embodiment 2620. In order that the first content 11 and the second content 12 may be projected so as to be distanced from each other by a projection interval d while the disposed locations of the electronic device 100 and the external device 200 are fixed, the electronic device 100 and the external device 200 may respectively change the projection angle. For example, the electronic device 100 and the external device 200 may change the projection angle from 01 to 02.

In FIG. 26, it was described that the electronic device 100 and the external device 200 project contents in the same projection angle, but according to one or more embodiments, the projection angle of the electronic device 100 and the projection angle of the external device 200 may be different.

FIG. 27 is a diagram for illustrating an operation of calculating a projection angle.

In the embodiment 2710 in FIG. 27, it is assumed that the first content 11 and the second content 12 were projected without a projection interval. In FIG. 27, for the convenience of explanation, only the first content 11 is illustrated. The distance from the electronic device 100 to the closest point 2711 on the plane of the projection surface 10 may be p1. Also, the distance from the point 2711 to the center point 2712 of the projection surface 10 may be a1. Also, the horizontal size of the first content 11 may be c1. The electronic device 100 may identify a center point 2713 in a position wherein the first content 11 is output for projecting the first content 11. The electronic device 100 may identify a projection angle θ1 based on the point 2713. The distance x1 between the point 2711 and the point 2713 may be calculated by subtracting the distance (c1/2) between the point 2713 and the point 2712 from the distance a1 between the point 2711 and the point 2712.

Based on the formula 2711 in FIG. 27, the electronic device 100 may obtain a projection angle θ1. The projection angle θ1 may be tan \hat{ }−1(x1/p1).

In the embodiment 2720 in FIG. 27, it is assumed that the first content 11 and the second content 12 were projected to be distanced from each other as much as a projection interval d.

The distance from the electronic device 100 to the closest point 2721 on the plane of the projection surface 10 may be p1. Also, the distance from the point 2721 to the center point 2722 of the projection surface 10 may be a1. Here, the point 2721 in the embodiment 2720 may be identical to the point 2711 in the embodiment 2710, and the point 2722 in the embodiment 2720 may be identical to the point 2712 in the embodiment 2710. Also, the horizontal size of the first content 11 may be c1. The electronic device 100 may identify a center point 2723 in a position wherein the first content 11 is output for projecting the first content 11. The electronic device 100 may identify a projection angle θ2 based on the point 2723. The distance x2 between the point 2721 and the point 2723 may be calculated by subtracting the distance (c1/2+d/2) between the point 2723 and the point 2722 from the distance a1 between the point 2721 and the point 2722.

Based on the formula 2721 in FIG. 27, the electronic device 100 may obtain a projection angle θ2. The projection angle θ2 may be tan \hat{ }−1(x2/p1). Also, the projection angle θ2 may be θ1−tan \hat{ }−1((d/2)/p1). Here, tan \hat{ }−1((d/2)/p1) may be described as θd. As a result, the projection angle θ2 may be a value obtained by subtracting θd from θ1. Accordingly, the electronic device 100 may change the projection angle by θd to project the first content 11 and the second content 12 to be distanced from each other by the projection interval d.

FIG. 28 is a flow chart for illustrating an operation of controlling a projection angle.

The operations S2810, S2820, and S2830 in FIG. 28 may correspond to the operations S1610, S1620, and S1630 in FIG. 16. Accordingly, overlapping explanation will be omitted.

After a difference value between the first luminance value and the second luminance value are obtained, the electronic device 100 may obtain a projection interval between the first content 11 and the second content 12 based on the difference value in operation S2841. The electronic device 100 may obtain distance information related to the projection surface 10, size information of the first content 11, and size information of the second content 12 in operation S2842.

Here, the distance information related to the projection surface 10 may indicate distance information between the electronic device 100 and the projection surface 10. Also, the distance information related to the projection surface 10 may be a1, p1, etc. in FIG. 27.

The electronic device 100 may obtain information on the first position wherein the first content 11 is projected and the first projection angle of the electronic device 100 based on the projection interval, the distance information related to the projection surface 10, and the size information of the first content 11 in operation S2843.

Also, the electronic device 100 may obtain information on the second position wherein the second content 12 is projected and the second projection angle of the external device 200 based on the projection interval, the distance information related to the projection surface 10, and the size information of the second content 12 in operation S2844.

In addition, the electronic device 100 may transmit the second projection angle, the second position information, and the second content 12 to the external device 200 in operation S2850.

The external device 200 may receive the second projection angle, the second position information, and the second content 12 from the electronic device 100. The external device 200 may project the second content 12 based on the second projection angle and the second position information in operation S2860.

The electronic device 100 may project the first content 11 based on the first projection angle and the first position information in operation S2870.

FIG. 29 is a diagram for illustrating an operation wherein the electronic device 100 and the external device 200 move.

Referring to the embodiment 2910 in FIG. 29, the first content 11 and the second content 12 may be projected on the projection surface 10 without a projection interval. Here, the distance between the electronic device 100 and the external device 200 may be x3.

Referring to the embodiment 2920 in FIG. 29, the first content 11 and the second content 12 may be projected to be distanced from each other by a projection interval d. Here, the electronic device 100 and the external device 200 may move by themselves for projecting contents on new projection positions. For example, the electronic device 100 may move to the left side by d/2, and the external device 200 may move to the right side by d/2. Here, the distance between the electronic device 100 and the external device 200 may be x3+d.

FIG. 30 is a flow chart for illustrating an operation wherein the electronic device 100 and the external device 200 move.

The operations S3010, S3020, S3030, S3040, S3050, S3060, and S3070 in FIG. 30 may correspond to the operations S1610, S1620, S1630, S1640, S1650, S1660, and S1670 in FIG. 16. Accordingly, overlapping explanation will be omitted.

After the first position information and the second position information are obtained, the electronic device 100 may identify a projection area of the projection surface 10 in operation S3041. The electronic device 100 may identify whether both of the first content 11 and the second content 12 may be projected on the projection area by controlling the projection angle in operation S3042.

In case both of the first content 11 and the second content 12 may not be projected on the projection area in operation S3042-N, the electronic device 100 may identify a first moving distance of the electronic device 100 and a second moving distance of the external device 200 in operation S3043. The electronic device 100 may move based on the first moving distance in operation S3044. The electronic device 100 may transmit the second moving distance to the external device 200 in operation S3045.

The external device 200 may receive the second moving distance from the electronic device 100. The external device 200 may move based on the second moving distance in operation S3046. Then, the external device 200 may project the second content 12 based on the second position information in operation S3060.

In case both of the first content 11 and the second content 12 may be projected on the projection area in operation S3042-Y, the operations S3050, S3060, and S3070 may be performed.

FIG. 31 is a diagram for illustrating an operation of changing a size of a content.

Referring to the embodiment 3110 in FIG. 31, the first content 11 and the second content 12 may be projected on the projection surface 10 without a projection interval.

Referring to the embodiment 3120 in FIG. 31, the first content 11 and the second content 12 may be projected to be distanced from each other by a projection interval d. The electronic device 100 may change the sizes of the first content 11 and the second content 12 to be smaller. When the horizontal length of the first content 11 is reduced by d/2 and the horizontal length of the second content 12 is reduced by d/2, the electronic device 100 may project the first content 11 and the second content 12 to be distanced from each other by the projection interval d.

FIG. 32 is a flow chart for illustrating an operation of changing a size of a content.

The operations S3210, S3220, S3230, S3240, S3250, S3260, and S3270 in FIG. 32 may correspond to the operations S1610, S1620, S1630, S1640, S1650, S1660, and S1670 in FIG. 16. Also, the operations S3241 and S3242 may correspond to the operations S3041 and S3042 in FIG. 30. Accordingly, overlapping explanation will be omitted.

In case both of the first content 11 and the second content 12 may not be projected on the projection area in operation S3242-N, the electronic device 100 may change the size of the first content 11 and the size of the second content 12 in operation S3243. Then, the electronic device 100 may transmit the changed second content 12 to the external device 200 together with the second position information in operation S3250. The external device 200 may project the changed second content 12 based on the second position information in operation S3260.

The electronic device 100 may project the changed first content 11 based on the first position information in operation S3270.

FIG. 33 is a diagram for illustrating an operation of changing a luminance value corresponding to a content.

Referring to FIG. 33, the electronic device 100 may change the first luminance value of the first content 11 and change the second luminance value of the second content 12. The electronic device 100 may project a bright content to be darker than a previous case, and project a dark content to be brighter than a previous case. In case the difference value between the luminance values is relatively big, the user may feel inconvenience even when the projection interval is set to be relatively far. Also, there may be spatial restriction on the projection area. Accordingly, the electronic device 100 may change a luminance value corresponding to a content.

FIG. 34 is a flow chart for illustrating an operation of changing a luminance value corresponding to a content.

Referring to FIG. 34, the electronic device 100 may change a luminance value of a content itself. Here, the luminance value may be a pixel value.

The operations S3410, S3420, S3430, S3440, S3450, S3460, and S3470 in FIG. 34 may correspond to the operations S1610, S1620, S1630, S1640, S1650, S1660, and S1670 in FIG. 16. Also, the operations S3450, S3460, and S3470 may correspond to the operations S3250, S3260, and S3270 in FIG. 32. Accordingly, overlapping explanation will be omitted.

After the first position information and the second position information are obtained, the electronic device 100 may identify whether a difference value is greater than or equal to a threshold luminance value in operation S3441. When the difference value is greater than or equal to the threshold luminance value in operation S3441-Y, the electronic device 100 may change the first content 11 based on a third luminance value in operation S3442. The electronic device 100 may change the second content 12 based on a fourth luminance value in operation S3443. Then, the operations S3450, S3460, and S3470 may be performed.

When the difference value is not greater than or equal to the threshold luminance value in operation S3441-N, the operations S3450, S3460, and S3470 may be performed.

FIG. 35 is a flow chart for illustrating an operation of changing a set luminance value for projecting a content.

The operations S3510, S3520, S3530, and S3540 in FIG. 35 may correspond to the operations S1610, S1620, S1630, and S1640 in FIG. 16. Accordingly, overlapping explanation will be omitted.

After the first position information and the second position information are obtained, the electronic device 100 may identify whether a difference value is greater than or equal to the threshold luminance value in operation S3541. When the difference value is greater than or equal to the threshold luminance value in operation S3541-Y, the electronic device 100 may identify a third luminance value as the setting of the projection brightness of the electronic device 100 for projecting the first content 11 in operation S3542. The electronic device 100 may identify a fourth luminance value as the setting of the projection brightness of the external device 200 for projecting the second content 12 in operation S3543.

The electronic device 100 may change the setting of the projection brightness of the electronic device 100 based on the third luminance value in operation S3544. The electronic device 100 may transmit the fourth luminance value to the external device 200 in operation S3545.

The external device 200 may receive the fourth luminance value from the electronic device 100. The external device 200 may change the setting of the projection brightness of the external device 200 based on the fourth luminance value in operation S3546.

When the difference value is not greater than or equal to the threshold luminance value in operation S3541-N, the operations S3550, S3560, and S3570 may be performed.

FIG. 36 is a table for illustrating a projection method corresponding to power information according to one or more embodiments.

The table 3610 in FIG. 36 indicates a projection method corresponding to power information of the electronic device 100 and the external device 200 in a situation wherein the first content 11 has relatively higher (or bigger) luminance than the second content 12. Here, the power information may be the remaining amount of the battery. It is assumed that the power threshold value determining shortage of power is 30%. Here, the power threshold value may be different according to the user setting. Here, the described expressions high luminance and low luminance may indicate relative luminance from among two contents. Here, the described high luminance may be luminance greater than or equal to the threshold luminance value. Also, the low luminance may be luminance smaller than the threshold luminance value. In addition, a content of high luminance may be a content of which basic luminance value is greater than or equal to the threshold luminance value. Further, a content of low luminance may be a content of which basic luminance value is smaller than the threshold luminance value. Here, the threshold luminance value may be different according to the user setting.

In case the first power information of the electronic device 100 is 25% and the second power information of the external device 200 is 25%, the electronic device 100 may project the first content 11 of high luminance in low luminance. As the remaining amounts of the batteries are insufficient in both of the electronic device 100 and the external device 200, the electronic device 100 may change the first content 11 of high luminance to the first content 11 of low luminance. Here, the changing operation may be an image correcting operation. The electronic device 100 may perform an image correcting function such that an average pixel value of frames included in the content becomes lower. Then, the electronic device 100 may project the first content 11 of low luminance. As both of the first content 11 and the second content 12 may be projected in low luminance, the power of the electronic device 100 and the external device 200 may be saved. According to one or more embodiments, the electronic device 100 may lower the setting of the projection brightness instead of changing a content to a content of low luminance. The electronic device 100 may fix the luminance of a content itself, and lower the setting of the projection brightness related to output of a light source to specific brightness.

In case the first power information of the electronic device 100 is 25% and the second power information of the external device 200 is 75%, the electronic device 100 may project the second content 12 and the external device 200 may project the first content 11. The power of the electronic device 100 projecting the first content 11 of high luminance may be insufficient, and the power of the external device 200 projecting the second content 12 of low luminance may be sufficient. The electronic device 100 may determine the projection method such that the external device 200 projects the first content 11 of high luminance and the electronic device 100 projects the second content 12 of low luminance.

In case the first power information of the electronic device 100 is 75% and the second power information of the external device 200 is 25%, the electronic device 100 may maintain the current projection method. The electronic device 100 having sufficient power may be projecting the first content 11 of high luminance, and the external device 200 having insufficient power may be projecting the second content 12 of low luminance. Accordingly, the electronic device 100 may maintain the current projection method.

In case the first power information of the electronic device 100 is 75% and the second power information of the external device 200 is 75%, the electronic device 100 may maintain the current projection method. The current projection method may be a method by which the electronic device 100 projects the first content 11 and the external device 200 projects the second content 12. Both of the electronic device 100 and the external device 20 may be in a situation wherein power is sufficient. Accordingly, the electronic device 100 may maintain the current projection method.

The table 3620 in FIG. 36 indicates a projection method corresponding to the power information of the electronic device 100 and the external device 200 in a situation wherein the first content 11 has relatively lower (or smaller) luminance than the second content 12. Here, the power information may be the remaining amount of the battery. It is assumed that the power threshold value determining shortage of power is 30%. Here, the power threshold value may be different according to the user setting.

In case the first power information of the electronic device 100 is 25% and the second power information of the external device 200 is 25%, the external device 200 may project the second content 12 of high luminance in low luminance. As the remaining amounts of the batteries are insufficient in both of the electronic device 100 and the external device 200, the electronic device 100 (or the external device 200) may change the second content 12 of high luminance to the second content 12 of low luminance. Here, the changing operation may be an image correcting operation. The electronic device 100 (or the external device 200) may perform an image correcting function such that an average pixel value of frames included in the content becomes lower. Then, the external device 200 may project the second content 12 of low luminance. As both of the first content 11 and the second content 12 may be projected in low luminance, the power of the electronic device 100 and the external device 200 may be saved. According to one or more embodiments, the electronic device 100 may lower the setting of the projection brightness instead of changing a content to a content of low luminance. The electronic device 100 may fix the luminance of a content itself, and lower the setting of the projection brightness related to output of a light source to specific brightness.

In case the first power information of the electronic device 100 is 25% and the second power information of the external device 200 is 75%, the electronic device 100 may maintain the current projection method. The electronic device 100 having insufficient power may be projecting the first content 11 of low luminance, and the external device 200 having sufficient power may be projecting the second content 12 of high luminance. Accordingly, the electronic device 100 may maintain the current projection method.

In case the first power information of the electronic device 100 is 75% and the second power information of the external device 200 is 25%, the electronic device 100 may project the second content 12 and the external device 200 may project the first content 11. The power of the electronic device 100 projecting the first content 11 of low luminance may be sufficient, and the power of the external device 200 projecting the second content 12 of high luminance may be insufficient. The electronic device 100 may determine the projection method such that the external device 200 projects the first content 11 of low luminance and the electronic device 100 projects the second content 12 of high luminance.

In case the first power information of the electronic device 100 is 75% and the second power information of the external device 200 is 75%, the electronic device 100 may maintain the current projection method. The current projection method may be a method by which the electronic device 100 projects the first content 11 and the external device 200 projects the second content 12. Both of the electronic device 100 and the external device 20 may be in a situation wherein power is sufficient. Accordingly, the electronic device 100 may maintain the current projection method.

FIG. 37 is a diagram for illustrating an operation of changing a content projection device based on power information.

Referring to the embodiment 3710 in FIG. 37, when the remaining amount of the battery drops to a specific level, a UI 3711 guiding conversion of a content screen may be provided. It is assumed that the remaining amount of the battery of the electronic device 100 drops to a specific level or lower from among the electronic device 100 and the external device 200. Also, it is assumed that the first content 11 has a higher luminance value than the second content 12 on average. Accordingly, the remaining amount of the battery of the electronic device 100 projecting the first content 11 may be less than that of the external device 200.

The guide UI 3711 may include at least one of guide text information 3712, a UI 3713 indicating the remaining amount of the battery of the electronic device 100, or a UI 3714 indicating the remaining amount of the battery of the external device 200.

The guide text information 3712 may include at least one of text information indicating the reason that screen conversion is needed (e.g., “There is not enough battery”) or text information for guiding screen conversion (e.g., “Do you want to convert the screen?” or “Do you want to project the first content 11 on the external device?”). Here, the remaining amount of the battery may also be described as power information.

Referring to the embodiment 3720 in FIG. 37, it is assumed that a user input for screen conversion was received. The electronic device 100 may project the second content 12 on the area wherein the first content 11 was projected instead of the first content 11. The external device 200 may project the first content 11 on the area wherein the second content 12 was projected instead of the second content 12.

FIG. 38 is a flow chart for illustrating an operation of changing a content projection device based on power information in case the first content 11 is a high luminance content and the second content 12 is a low luminance content.

Referring to FIG. 38, it is assumed that the first content 11 has higher luminance than the second content 12 on average.

The electronic device 100 may project the first content 11 based on the first position information in operation S3811. The electronic device 100 may obtain the first power information regarding the battery in operation S3812.

The external device 200 may project the second content 12 based on the second position information in operation S3821. The external device 200 may obtain the second power information regarding the battery in operation S3822. The external device 200 may transmit the second power information to the electronic device 100 in operation S2723.

The electronic device 100 may receive the second power information from the external device 200.

The electronic device 100 may identify whether the first power information is greater than or equal to the threshold power value in operation S3831. When the first power information is greater than or equal to the threshold power value in operation S3831-Y, the electronic device 100 may repeat the operations S3811, S3812, S3821, S3822, S3823, and S3831.

When the first power information is not greater than or equal to the threshold power value in operation S3831-N, the electronic device 100 may identify whether the second power information is greater than or equal to the threshold power value in operation S3832. When the second power information is less than or equal to the threshold power value in operation S3832-N, the electronic device 100 may repeat the operations S3811, S3812, S3821, S3822, S3823, S3831, and S3832.

When the second power information is greater than or equal to the threshold power value in operation S3832-Y, the electronic device 100 may project a guide UI for changing the projection device of a content in operation S3840. The electronic device 100 may identify whether a user input for changing the projection device of a content was received in operation S3841. When a user input was not received in operation S3841-N, the electronic device 100 may repeat the operations S3811, S3812, S3821, S3822, S3823, S3831, S3832, S3840, and S3841.

When a user input was received in operation S3841-Y, the electronic device 100 may transmit the first content 11 to the external device 200 in operation S3850. According to one or more embodiments, the electronic device 100 may transmit the second position information together with the first content 11.

The external device 200 may receive the first content 11 from the electronic device 100. The external device 200 may project the first content 11 based on the second position information in operation S3860.

The electronic device 100 may project the second content 12 based on the first position information in operation S3870.

FIG. 39 is a flow chart for illustrating an operation of changing a content projection device based on power information in case the first content 11 is a low luminance content and the second content 12 is a high luminance content.

Referring to FIG. 39, it is assumed that the first content 11 has lower luminance than the second content 12 on average.

The operations S3911, S3912, S3921, S3922, S3923, S3940, S3941, S3950, S3960, and S3970 in FIG. 39 may correspond to the operations S3811, S3812, S3821, S3822, S3823, S3840, S3841, S3850, S3860, and S3870 in FIG. 38. Accordingly, overlapping explanation will be omitted.

After the first power information and the second power information are obtained, the electronic device 100 may identify whether the second power information is greater than or equal to the threshold power value.

The electronic device 100 may identify whether the second power information is greater than or equal to the threshold power value in operation S3931. When the second power information is greater than or equal to the threshold power value in operation S3931-Y, the electronic device 100 may repeat the operations S3911, S3912, S3921, S3922, S3923, and S3931.

When the second power information is not greater than or equal to the threshold power value in operation S3931-N, the electronic device 100 may identify whether the first power information is greater than or equal to the threshold power value in operation S3932. When the first power information is not greater than or equal to the threshold power value in operation S3932-N, the electronic device 100 may repeat the operations S3911, S3912, S3921, S3922, S3923, S3931, and S3932.

When the first power information is greater than or equal to the threshold power value in operation S3932-Y, the electronic device 100 may project a guide UI for changing the projection device of a content in operation S3940.

FIG. 40 is a diagram for illustrating an operation of changing a luminance value based on power information according to one or more embodiments.

Referring to the embodiment 4010 in FIG. 40, the remaining amount of the battery of the electronic device 100 may be 25% and the remaining amount of the battery of the external device 200 may be 75%. Here, it is assumed that the electronic device 100 is projecting the first content 11 of high luminance and the external device 200 is projecting the second content 12 of low luminance. In the current situation, in case the electronic device 100 keeps projecting the first content 11 of high luminance, even though the remaining amount of the battery of the electronic device 100 is more insufficient than that of the external device 200, power may fall short.

Referring to the embodiment 4020 in FIG. 40, the electronic device 100 having insufficient power may change the first content 11 of high luminance to the first content 11 of low luminance. Here, the changing operation may be an image correcting operation. The electronic device 100 (or the external device 200) may perform an image correcting function such that an average pixel value of frames included in the content becomes lower. Here, the electronic device 100 may obtain an average pixel value of the second content 12. The electronic device 100 may correct the first content 11 such that the average pixel value of the first content 11 becomes the average pixel value of the second content 12. When the average pixel value of the first content 11 becomes lower, the electronic device 100 may project the first content 11 longer than in a previous case while power is insufficient.

FIG. 41 is a diagram for illustrating an operation of changing a luminance value based on power information according to one or more embodiments.

Referring to the embodiment 4110 in FIG. 41, the remaining amount of the battery of the electronic device 100 may be 40%, the remaining amount of the battery of the first external device 200-1 may be 25%, and the remaining amount of the battery of the second external device 200-2 may be 75%. Here, the electronic device 100 may project the first content 11, the first external device 200-1 may project the second content 12, and the second external device 200-2 may project the third content 13. Here, in order that the plurality of devices 100, 200-1, 200-2 can output contents during the same time, the electronic device 100 may control the plurality of devices 100, 200-1, 200-2 to apply the setting of the projection brightness related to outputs of light sources correspondingly to the remaining amounts of the batteries.

For example, as the remaining amount of the battery of the electronic device 100 is 40%, the electronic device 100 may project the first content 11 in the brightness of 40%. Also, as the remaining amount of the battery of the first external device 200-1 is 25%, the first external device 200-1 may project the second content 12 in the brightness of 25%. In addition, as the remaining amount of the battery of the second external device 200-2 is 75%, the second external device 200-2 may project the third content 13 in the brightness of 75%.

However, in case contents that are simultaneously output have different brightness in providing the multi-view function, the user may feel inconvenience. Accordingly, the plurality of devices 100, 200-1, 200-2 may output contents based on the same luminance value.

Referring to the embodiment 4120 in FIG. 42, the electronic device 100 may obtain power information of the plurality of devices 100, 200-1, 200-2. The electronic device 100 may identify a device having the lowest remaining amount of the battery among the plurality of devices 100, 200-1, 200-2. The remaining amount of the battery of the electronic device 100 may be 40%, the remaining amount of the battery of the first external device 200-1 may be 25%, and the remaining amount of the battery of the second external device 200-2 may be 75%. Here, the device having the lowest remaining amount of the battery may be the first external device 200-1. The electronic device 100 may perform control such that the plurality of devices 100, 200-1, 200-2 apply the setting of the projection brightness provided by the first external device 200-1.

For example, as the remaining amount of the battery of the first external device 200-1 is 25%, the electronic device 100 may project the first content 11 in the brightness of 25%, the first external device 200-1 may project the second content 12 in the brightness of 25%, and the second external device 200-2 may project the third content 13 in the brightness of 25%. As the plurality of devices 100, 200-1, 200-2 project contents in the brightness corresponding to the lowest power, contents may be projected during a long time while visibility for the user is improved.

FIG. 42 is a flow chart for illustrating an operation of changing a luminance value based on power information according to one or more embodiments.

Referring to FIG. 42, the electronic device 100 may obtain first power information and second power information in operation S4205. The electronic device 100 may identify whether a first luminance value exceeds a second luminance value in operation S4210.

When the first luminance value exceeds the second luminance value in operation S4210-Y, the electronic device 100 may identify whether the first power information is greater than or equal to the second power information in operation S4215. When the first power information is greater than or equal to the second power information in operation S4215-Y, the electronic device 100 may project the first content 11, and the external device 200 may project the second content 12 in operation S4220. When the first power information is not greater than or equal to the second power information in operation S4215-N, the electronic device 100 may identify whether the second power information is greater than or equal to a threshold power value in operation S4225. When the second power information is greater than or equal to the threshold power value in operation S4225-Y, the electronic device 100 may project the second content 12, and the external device 200 may project the first content 11 in operation S4230. Here, the electronic device 100 may transmit the first content 11 to the external device 200. When the second power information is not greater than or equal to the threshold power value in operation S4225-N, the electronic device 100 may perform control such that the first content 11 is projected in low luminance in operation S4235.

When the first luminance value does not exceed the second luminance value in operation S4210-N, the electronic device 100 may identify whether the second power information is greater than or equal to the threshold power value in operation S4240. When the second power information is greater than or equal to the threshold power value in operation S4240-Y, the electronic device 100 may project the first content 11, and the external device 200 may project the second content 12 in operation S4220. When the second power information is not greater than or equal to the threshold power value in operation S4240-N, the electronic device 100 may identify whether the first power information is greater than or equal to the threshold power value in operation S4245. When the first power information is greater than or equal to the threshold power value in operation S4245-Y, the electronic device 100 may project the second content 12, and the external device 200 may project the first content 11 in operation S4230. Here, the electronic device 100 may transmit the first content 11 to the external device 200. When the first power information is not greater than or equal to the threshold power value in operation S4245-N, the electronic device 100 may perform control such that the external device 200 projects the second content 12 in low luminance in operation S4250.

The electronic device 100 may control overall operations related to output of contents by controlling the electronic device 100 and the external device 200. In FIG. 42, an embodiment of comparing the luminance of the first content 11 and the luminance of the second content 12 first, and then comparing the power information was described. According to one or more embodiments, an embodiment of comparing the power information first, and then comparing the luminance values will be described in FIG. 43.

FIG. 43 is a flow chart for illustrating an operation of changing a luminance value based on power information according to one or more embodiments.

Referring to FIG. 43, the electronic device 100 may obtain the first power information and the second power information in operation S4305. The electronic device 100 may identify whether the first power information is greater than or equal to the threshold power value in operation S4305.

When the first power information is greater than or equal to the threshold power value in operation S4305-Y, the electronic device 100 may identify whether the second power information is greater than or equal to the threshold power value in operation S4310. When the second power information is greater than or equal to the threshold power value in operation S4310-Y, the electronic device 100 may project the first content 11, and the external device 200 may project the second content 12 in operation S4315. When the second power information is not greater than or equal to the threshold power value in operation S4310-N, the electronic device 100 may identify whether the first luminance value exceeds the second luminance value in operation S4320. When the first luminance value exceeds the second luminance value in operation S4320-Y, the electronic device 100 may project the first content 11, and the external device 200 may project the second content 12 in operation S4315. When the first luminance value does not exceed the second luminance value in operation S4320-N, the electronic device 100 may project the second content 12, and the external device 200 may project the first content 11 in operation S4325. Here, the electronic device 100 may transmit the first content 11 to the external device 200.

When the first power information is not greater than or equal to the threshold power value in operation S4305-N, the electronic device 100 may identify whether the second power information is greater than or equal to the threshold power value in operation S4330. When the second power information is greater than or equal to the threshold value in operation S4330-Y, the electronic device 100 may identify whether the first luminance value exceeds the second luminance value in operation S4335. When the first luminance value exceeds the second luminance value in operation S4335-Y, the electronic device 100 may project the second content 12, and the external device 200 may project the first content 11 in operation S4325. Here, the electronic device 100 may transmit the first content 11 to the external device 200. When the first luminance value does not exceed the second luminance value in operation S4335-N, the electronic device 100 may project the first content 11, and the external device 200 may project the second content 12 in operation S4315. When the second power information is not greater than or equal to the threshold power value in operation S4330-N, the electronic device 100 may identify whether the first luminance value exceeds the second luminance value in operation S4340. When the first luminance value exceeds the second luminance value in operation S4340-Y, the electronic device 100 may project the first content 11 in low luminance in operation S4345. When the first luminance value does not exceed the second luminance value in operation S4340-N, the electronic device 100 may perform control such that the external device 200 projects the second content 12 in low luminance in operation S4350.

FIG. 44 is a diagram for illustrating a content projection method in case power of a specific device is insufficient according to one or more embodiments.

Referring to the embodiment 4410 in FIG. 44, when the remaining amount of the battery drops below a specific level (e.g., 5%), a UI 4411 guiding conversion of the content screen may be provided. It is assumed that the remaining amount of the battery of the electronic device 100 drops below a specific level from among the electronic device 100 and the external device 200. Also, it is assumed that the first content 11 has a higher luminance value than the second content 12 on average. Accordingly, the remaining amount of the battery of the electronic device 100 projecting the first content 11 may be less than that of the external device 200.

The guide UI 4411 may include at least one of guide text information 4412, a UI 4413 indicating the remaining amount of the battery of the electronic device 100, or a UI 4414 indicating the remaining amount of the battery of the external device 200.

The guide text information 4412 may include at least one of text information indicating the reason that screen conversion is needed (e.g., “There is not enough battery”) or text information for guiding screen conversion (e.g., “Do you want to project all contents at the second projector?”). Here, the remaining amount of the battery may also be described as power information.

The electronic device 100 may receive a user input through the guide UI 4411.

FIG. 45 is a diagram for illustrating a content projection method in case power of a specific device is insufficient according to one or more embodiments.

Referring to the embodiment 4510 in FIG. 45, the electronic device 100 may receive a user input for projecting all contents at the external device 200 (or the second projector) through the guide UI 4411. The electronic device 100 may stop a projecting operation of the first content 11. Then, the electronic device 100 may transmit the first content 11 to the external device 200. The external device 200 may project the first content 11 and the second content 12 together according to a projection interval d.

Referring to the embodiment 4520 in FIG. 45, the electronic device 100 may receive a user input for not projecting all contents at the external device 200 (or the second projector) through the guide UI 4411. The electronic device 100 may stop a projecting operation of the first content 11. Then, the external device 200 may output only the second content 12.

FIG. 46 is a diagram for illustrating a content projection method in case power of a specific device is insufficient according to one or more embodiments.

Referring to the embodiment 4610 in FIG. 46, the remaining amount of the battery of the electronic device 100 may be 40%, the remaining amount of the battery of the first external device 200-1 may be 0%, and the remaining amount of the battery of the second external device 200-2 may be 75%. Here, the electronic device 100 may project the first content 11, the first external device 200-1 may project the second content 12, and the second external device 200-2 may project the third content 13. Here, as the remaining amount of the battery of the first external device 200-1 is 0%, projection of the second content 12 may be stopped.

Referring to the embodiment 4620 in FIG. 46, when the remaining amount of the battery of a specific device among the plurality of devices 100, 200-1, 200-2 is smaller than the threshold power value (e.g., 5%), the remaining devices 100, 200-2 excluding the device 200-1 having the remaining amount of the battery smaller than the threshold power value may project a fourth content 14 wherein the first content 11, the second content 12, and the third content 13 are merged. Here, the merged fourth content 14 may include a content 14-1 projected from the electronic device 100 and a content 14-2 projected from the second external device 200-2. Depending on needs, the remaining devices 100, 200-2 may move.

FIG. 47 is a flow chart for illustrating a content projection method in case power of a specific device is insufficient according to one or more embodiments.

The electronic device 100 may obtain the first power information and the second power information in operation S4705. The electronic device 100 may identify whether the first power information is smaller than the threshold power value in operation S4710. Here, the threshold power value may be 5%. The threshold power value may be changed according to the user's setting.

When the first power information is smaller than the threshold power value in operation S4710-Y, the electronic device 100 may identify whether the second power information is smaller than the threshold power value in operation S4715. When the second power information is smaller than the threshold power value in operation S4715-Y, the electronic device 100 may provide a UI for guiding connection of the power of both of the electronic device 100 and the external device 200. In this situation, both of the electronic device 100 and the external device 200 may be in a state of having insufficient power. Accordingly, a guide UI notifying that connection of the power of both of the electronic device 100 and the external device 200 is needed may be provided to the user. When the second power information is not smaller than the threshold power value in operation S4715-N, the electronic device 100 may perform control such that the external device 200 projects both of the first content 11 and the second content 12 in operation S4725.

When the first power information is greater than or equal to the threshold value in operation S4710-N, the electronic device 100 may identify whether the second power information is smaller than the threshold power value in operation S4730. When the second power information is smaller than the threshold power value in operation S4730-Y, the electronic device 100 may project both of the first content 11 and the second content 12 in operation S4735. When the second power information is not smaller than the threshold power value in operation S4740-N, the electronic device 100 may perform control such that the electronic device 100 projects the first content 11, and the external device 200 projects the second content 12 in operation S4740.

FIG. 48 is a diagram for illustrating an operation of changing a projection interval between the first content 11 and the second content 12 in real time.

Referring to FIG. 48, the electronic device 100 may compare the first luminance value of the first content 11 and the second luminance value of the second content 12 in real time. Referring to FIG. 22 and FIG. 23, the electronic device 100 may compare the difference value of the luminance values based on the average pixel value of the frames during a predetermined period. Referring to FIG. 24 and FIG. 25, the electronic device 100 may obtain the difference value of the luminance values based on an image captured through the camera.

Referring to the embodiment 4810 in FIG. 48, the first content 11 and the second content 12 may be output without a projection interval. When the difference between the luminance values of the first content 11 and the second content 12 is not big, the first content 11 and the second content 12 may be output without a projection interval. In case there is no difference in the luminance values based on real time analysis, the electronic device 100 may perform control such that the first content 11 and the second content 12 are projected without a projection interval.

Referring to the embodiment 4820 in FIG. 48, the first content 11 and the second content 12 may be output to be distanced from each other by a projection interval d. In case there is a difference in the luminance values based on real time analysis, the electronic device 100 may perform control such that the first content 11 and the second content 12 are projected to be distanced from each other by the projection interval d.

FIG. 49 is a flow chart for illustrating an operation of changing a projection interval between the first content 11 and the second content 12 in real time.

Referring to FIG. 49, the electronic device 100 may receive a multi-view command in operation S4905. The electronic device 100 may obtain information on a first position wherein the first content 11 is projected and information on a second position wherein the second content 12 is projected in operation S4910. The electronic device 100 may transmit the second position information and the second content 12 to the external device 200 in operation S4915.

The external device 200 may receive the second position information and the second content 12 from the electronic device 100. The external device 200 may project the second content 12 based on the second position information in operation S4920.

The electronic device 100 may project the first content 11 based on the first position information in operation S4925. The electronic device 100 may obtain a first luminance value corresponding to the first content 11 and a second luminance value corresponding to the second content 12 in operation S4930. The electronic device 100 may obtain a difference value between the first luminance value and the second luminance value in operation S4935. The electronic device 100 may obtain the difference value through real time analysis. Detailed explanation in this regard was described in FIG. 22 to FIG. 25.

The electronic device 100 may identify whether the difference value is greater than or equal to the threshold luminance value in operation S4940. When the difference value is not greater than or equal to the threshold luminance value in operation S4940-N, the electronic device 100 may repeat the operations S4925, S4930, S4935, and S4940. When the difference value is greater than or equal to the threshold luminance value in operation S4940-Y, the electronic device 100 may obtain information on a third position wherein the first content 11 is projected and information on a fourth position wherein the second content 12 is projected in operation S4945. Here, the position information obtained based on the difference value may be information to which a projection interval determined according to the luminance difference value was reflected. The electronic device 100 may transmit the fourth position information to the external device 200 in operation S4950.

The external device 200 may receive the fourth position information from the electronic device 100. The external device 200 may project the second content 12 based on the fourth position information in operation S4955.

The electronic device 100 may project the first content 11 based on the third position information in operation S4960.

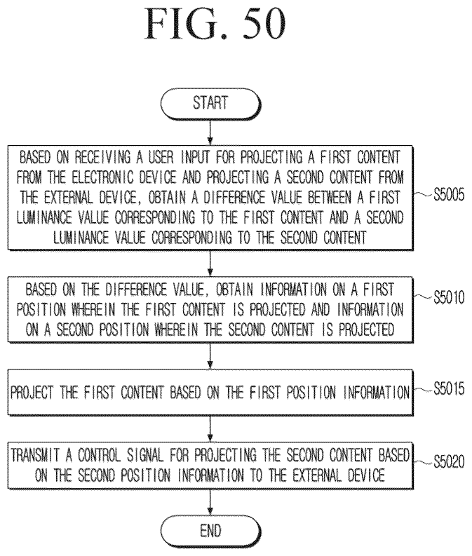

FIG. 50 is a flow chart for illustrating a control method of the electronic device 100 according to one or more embodiments.

Referring to FIG. 50, a control method of an electronic device that may store a first content 11 and a second content 12, and is configured to communicate with an external device includes the steps of, based on receiving a user input for projecting the first content 11 from the electronic device and projecting the second content 12 from the external device, obtaining a difference value between a first luminance value corresponding to the first content 11 and a second luminance value corresponding to the second content 12 (S5005), and based on the difference value, obtaining information on a first position wherein the first content 11 is projected and information on a second position wherein the second content 12 is projected (S5010), projecting the first content 11 based on the first position information (S5015), and transmitting a control signal for projecting the second content 12 to the external device based on the second position information (S5020).

In the operation S5010 of obtaining the first position information and the second position information, a projection interval between the first content 11 and the second content 12 may be obtained based on the difference value, and the first position information and the second position information may be obtained based on the projection interval, and the projection interval may become bigger as the difference value increases.

The control method may further include the steps of obtaining first metadata corresponding to the first content 11 and second metadata corresponding to the second content 12, obtaining the first luminance value based on the first metadata, and obtaining the second luminance value based on the second metadata.

In the step of obtaining the first luminance value, based on the first luminance value not being obtained on the basis of the first metadata, the first luminance value may be obtained based on an average pixel value of a plurality of frames included in the first content 11, and in the step of obtaining the second luminance value, based on the second luminance value not being obtained on the basis of the second metadata, the second luminance value may be obtained based on an average pixel value of a plurality of frames included in the second content 12.

In the step of obtaining the first luminance value, based on the first luminance value not being obtained on the basis of the first metadata, an image including the first content 11 projected on a projection surface 10 may be obtained, and the first luminance value may be obtained on the basis of the obtained image, and in the step of obtaining the second luminance value, based on the second luminance value not being obtained on the basis of the second metadata, an image including the second content 12 projected on the projection surface 10 may be obtained, and the second luminance value may be obtained on the basis of the obtained image.

In the operation S5015 of projecting the first content 11, the first content 11 may be projected on a first area corresponding to the first position information by controlling a projection angle.

The control method may further include the step of, based on identifying that the first content 11 may not be projected on the first area corresponding to the first position information by controlling the projection angle, controlling a moving element included in the electronic device to project the first content 11 on an area corresponding to the first position information.

The control method may further include the step of, based on identifying that the first content 11 may not be projected on the first area corresponding to the first position information by controlling the projection angle, changing the size of the first content 11, and in the operation S5015 of projecting the first content 11, the changed first content may be projected on the first area corresponding to the first position information.

The control method may further include the step of, based on the difference value being greater than or equal to a threshold luminance value, changing at least one of the first luminance value or the second luminance value, and in the operation S5015 of projecting the first content 11, based on the first luminance value being changed, the first content 11 may be projected based on the changed first luminance value, and in the operation S5020 of transmitting a control signal to the external device, based on the second luminance value being changed, a control signal for projecting the second content 12 based on the changed second luminance value may be transmitted to the external device.

The control method may further include the steps of obtaining first power information for a battery of the electronic device, obtaining second power information for a battery of the external device, and based on the first power information being smaller than a threshold power value, and the second power information being greater than or equal to the threshold power value, comparing the first luminance value and the second luminance value, and based on the first luminance value exceeding the second luminance value, projecting a guide user interface (UI) for projecting the first content 11 from the external device and projecting the second content 12 from the electronic device, and based on receiving a user input through the guide UI, projecting the second content 12 based on the second position information, and transmitting a control signal for projecting the first content 11 based on the first position information to the external device.

The control method of an electronic device as in FIG. 50 may be executed in an electronic device having the configuration as in FIG. 2 or FIG. 3, and it may also be executed in electronic devices having other configurations.

Methods according to the aforementioned one or more embodiments of the disclosure may be implemented in forms of applications that may be installed on conventional electronic devices.

Also, the methods according to the aforementioned one or more embodiments of the disclosure may be implemented just with software upgrade, or hardware upgrade of conventional electronic devices.

In addition, the aforementioned one or more embodiments of the disclosure may be performed through an embedded server provided on an electronic device, or an external server of at least one of an electronic device or a display device.

According to an embodiment of the disclosure, the aforementioned one or more embodiments may be implemented as software including instructions stored in machine-readable storage media, which may be read by machines (e.g.: computers). The machines refer to devices that call instructions stored in a storage medium, and can operate according to the called instructions, and the devices may include an electronic device according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ indicates that a storage medium does not include signals, and is tangible, but does not indicate whether data is stored in the storage medium semi-permanently or temporarily.

Also, according to an embodiment of the disclosure, the methods according to the aforementioned one or more embodiments of the disclosure may be provided while being included in a computer program product. A computer program product refers to a product, and it may be traded between a seller and a buyer. A computer program product may be distributed on-line in the form of a storage medium that is readable by machines (e.g.: compact disc read only memory (CD-ROM)), or through an application store. In the case of on-line distribution, at least a portion of a computer program product may be stored in a storage medium such as the server of the manufacturer, the server of the application store, and the memory of the relay server at least temporarily, or may be generated temporarily.

In addition, each of the components according to the aforementioned one or more embodiments (e.g.: a module or a program) may consist of a singular object or a plurality of objects, and among the aforementioned corresponding sub components, some sub components may be omitted, or other sub components may be further included in the one or more embodiments. However, embodiments are not limited thereto, and for example or additionally, some components (e.g.: a module or a program) may be integrated as an object, and perform functions that were performed by each of the components before integration identically or in a similar manner. Also, operations performed by a module, a program, or other components according to the one or more embodiments may be executed sequentially, in parallel, repetitively, or heuristically. Or, at least some of the operations may be executed in a different order or omitted, or other operations may be added.

While embodiments have been described with reference to the figures, it will be understood by those of ordinary skill in the art that various changes in form and details may be made therein without departing from the spirit and scope as defined by the following claims and their equivalents.

What is claimed is:

1. An electronic device comprising:
a projector;
a communication interface configured to communicate with an external device; and
at least one processor configured to:
based on receiving a user input for projecting a first content from the electronic device and projecting a second content from the external device, obtain a difference value between a first luminance value corresponding to the first content and a second luminance value corresponding to the second content;
obtain a projection interval of the first content and the second content based on the difference value;
control the projector to project the first content based on the projection interval; and
transmit the second content and a control signal for projecting the second content to the external device through the communication interface.

2. The electronic device of claim 1, wherein the at least one processor is further configured to:
obtain information on a first position based on the first content being projected based on the projection interval; and
control the projector to project the first content based on the first position information, and
wherein the projection interval increases as the difference value increases.

3. The electronic device of claim 1, wherein the at least one processor is further configured to:
obtain first metadata corresponding to the first content and second metadata corresponding to the second content;
obtain the first luminance value based on the first metadata; and
obtain the second luminance value based on the second metadata.

4. The electronic device of claim 3, wherein the at least one processor is further configured to:
obtain the first luminance value based on an average pixel value of a plurality of frames included in the first content based on the first luminance value not being obtained based on the first metadata; and
obtain the second luminance value based on an average pixel value of a plurality of frames included in the second content based on the second luminance value not being obtained based on the second metadata.

5. The electronic device of claim 3, further comprising:
a camera,
wherein the at least one processor is further configured to:
obtain an image comprising the first content projected on a projection surface through the camera, and obtain the first luminance value based on the obtained image; and
based on the second luminance value not being obtained based on the second metadata, obtain an image comprising the second content projected on a projection surface through the camera, and obtain the second luminance value based on the obtained image.

6. The electronic device of claim 2, wherein the at least one processor is further configured to:
control the projector to project the first content on a first area corresponding to the first position information by controlling a projection angle based on the projection interval.

7. The electronic device of claim 6, further comprising:
a moving element,
wherein the at least one processor is further configured to:
based on identifying that the first content is not projected on the first area corresponding to the first position information by controlling the projection angle, control the moving element to project the first content on an area corresponding to the first position information.

8. The electronic device of claim 6, wherein the at least one processor is further configured to:
based on identifying that the first content is not projected on the first area corresponding to the first position information by controlling the projection angle, change the size of the first content; and
control the projector to project the changed first content on the first area corresponding to the first position information.

9. The electronic device of claim 1, wherein the at least one processor is further configured to:
based on the difference value being greater than or equal to a threshold luminance value, change at least one of the first luminance value or the second luminance value;
based on the first luminance value being changed, control the projector to project the first content based on the changed first luminance value; and
based on the second luminance value being changed, transmit a control signal for projecting the second content based on the changed second luminance value to the external device through the communication interface.

10. The electronic device of claim 2, wherein the at least one processor is further configured to:
obtain first power information corresponding to a battery included in the electronic device;
obtain second power information corresponding to a battery included in the external device and information on a second position based on second content being projected through the communication interface;
based on the first power information being smaller than a threshold power value, and the second power information being greater than or equal to the threshold power value, compare the first luminance value and the second luminance value;
based on the first luminance value being greater than the second luminance value, project a guide user interface (UI) to project the first content from the external device and to project the second content from the electronic device;
based on receiving a user input through the guide UI, control the projector to project the second content based on the second position information; and
transmit a control signal for projecting the first content based on the first position information to the external device through the communication interface.

11. A control method of an electronic device configured to communicate with an external device, the method comprising:
based on receiving a user input for projecting a first content from the electronic device and projecting a second content from the external device, obtaining a difference value between a first luminance value corresponding to the first content and a second luminance value corresponding to the second content;
based on the difference value, obtaining a projection interval of the first content and the second content;
projecting the first content based on the projection interval; and
transmitting the second content and a control signal for projecting the second content to the external device.

12. The control method of claim 11, further comprising:
obtaining information on a first position based on the first content being projected and information on a second position based on the second content being projected based on the projection interval,
wherein the projecting the first content comprises projecting the first content based on the first position information, and
wherein the projection interval increases as the difference value increases.

13. The control method of claim 11, further comprising:
obtaining first metadata corresponding to the first content and second metadata corresponding to the second content;
obtaining the first luminance value based on the first metadata; and
obtaining the second luminance value based on the second metadata.

14. The control method of claim 13, wherein the obtaining the first luminance value comprises:
based on the first luminance value not being obtained based on the first metadata, obtaining the first luminance value based on an average pixel value of a plurality of frames included in the first content, and
wherein the obtaining the second luminance value comprises:
based on the second luminance value not being obtained based on the second metadata, obtaining the second luminance value based on an average pixel value of a plurality of frames included in the second content.

15. The control method of claim 13, wherein the obtaining the first luminance value comprises:
based on the first luminance value not being obtained based on the first metadata, obtaining an image comprising the first content projected on a projection surface, and obtaining the first luminance value based on the obtained image, and
wherein the obtaining the second luminance value comprises:
based on the second luminance value not being obtained based on the second metadata, obtaining an image comprising the second content projected on a projection surface, and obtaining the second luminance value based on the obtained image.

16. The control method of claim 12, further comprising:
projecting the first content on a first area corresponding to the first position information by controlling a projection angle based on the projection interval.

17. The control method of claim 16, further comprising:
based on identifying that the first content is not projected on the first area corresponding to the first position information by controlling the projection angle, controlling a moving element to project the first content on an area corresponding to the first position information.

18. The control method of claim 16, further comprising:
based on identifying that the first content is not projected on the first area corresponding to the first position information by controlling the projection angle, changing the size of the first content; and
projecting the changed first content on the first area corresponding to the first position information.

19. The control method of claim 11, further comprising:
based on the difference value being greater than or equal to a threshold luminance value, changing at least one of the first luminance value or the second luminance value;
based on the first luminance value being changed, projecting the first content based on the changed first luminance value; and
based on the second luminance value being changed, transmitting a control signal for projecting the second content based on the changed second luminance value to the external device through the communication interface.

20. The control method of claim 12, further comprising:
obtaining first power information corresponding to a battery included in the electronic device;
obtaining second power information corresponding to a battery included in the external device and information on a second position based on second content being projected through the communication interface;
based on the first power information being smaller than a threshold power value, and the second power information being greater than or equal to the threshold power value, comparing the first luminance value and the second luminance value;
based on the first luminance value being greater than the second luminance value, projecting a guide user interface (UI) to project the first content from the external device and to project the second content from the electronic device;
based on receiving a user input through the guide UI, projecting the second content based on the second position information; and
transmitting a control signal for projecting the first content based on the first position information to the external device through the communication interface.
